(19) United States
(12) Patent Application Publication
(10) Pub. No.: US 2021/0245980 A1
(43) Pub. Date: Aug. 12, 2021

(54) DOCUMENT TRANSPORT PATH WITHOUT IDLER ROLLERS

(71) Applicant: Crane Payment Innovations, Inc., Malvern, PA (US)

(72) Inventors: David Charles DEAVILLE, West Chester, PA (US); Matthew SELNICK, Ambler, PA (US); Gareth Edward TUMBLETY, Ambler, PA (US); Robert James BLYTHIN, Ardmore, PA (US); Dmytro REPETYUK, Collegeville, PA (US)

(21) Appl. No.: 17/250,817

(22) PCT Filed: Dec. 3, 2019
(86) PCT No.: PCT/US2019/064266

§ 371 Date: Mar. 5, 2021

Related U.S. Application Data
(60) Provisional application No. 62/774,803, filed on Dec. 3, 2018.
(60) Provisional application No. 62/925,149, filed on Oct. 23, 2019.

(51) Int. Cl. B65H 5/06; B65H 5/02; B65H 7/06; G07D 11/13; G07D 11/237

(52) U.S. Cl. CPC B65H 5/06; B65H 5/02; B65H 2701/1912; G07D 11/13; G07D 11/237; B65H 7/06

(57) ABSTRACT

A banknote recycler (100) including an externally accessible banknote transport path comprises a spine module (112) operable to support and couple with one or more other modules, an accepting module (106) operable to couple to the spine module (112) and to receive and transport banknotes through a portion of the banknote recycler (100), a sensing module (104) operable to recognize banknotes received in the banknote recycler (100), a recycling module (108) operable to receive banknotes from, and dispense banknotes to, one or more other modules in the banknote recycler (100), and a cashbox module (110) operable to store banknotes received from one or more other modules in the banknote recycler (100), wherein one or more of the accepting module (106), the sensing module (104), the recycling module (108), and the cashbox module (110) include at least one openable panel (410) providing access to a banknote transport path.

### CROSS-REFERENCE TO RELATED APPLICATIONS

This application is a 371 National Stage of International Application No. PCT/US2019/064266, filed Dec. 3, 2019, which claims the benefit of Provisional Application No. 62/774,803, filed Dec. 3, 2018, and Provisional Application No. 62/925,149, filed Oct. 23, 2019, the disclosures of which are herein incorporated by reference in their entirety.

### TECHNICAL FIELD

This disclosure relates generally to automated payment systems. More specifically, this disclosure relates to a banknote acceptor with an externally accessible banknote transport path and a document transport system using driving parts such as belts or rollers on one side of the document transport system configured for use within the banknote recycler or other systems.

### BACKGROUND

In banknote acceptors, the banknote transport path is a critical area that can have very tight tolerances, while also being prone to many variables and locations for a banknote to jam. When a jam occurs in existing banknote acceptors, there are often many doors, latches, and steps required to gain access to the location of the jammed note, and there are no points of visibility from the exterior of the unit to be able to see where the jam is located. The only way for the operator/servicer to find the jam is to get a notification or code from their external device communication system, or to search for the jam through all of the available access points. Additionally, these existing devices are not designed with the operator's processes or time in mind, which has led to devices that are not clearly marked, indicated, or intuitive when having to go through the task of resolving a jam or servicing a unit's banknote transport path.

Document transport systems often include a driving roller or belt on one side of a document transport path and a passive or active roller or belt on the other side of the document transport path. These types of document transport systems can be used in a variety of ways, such as in document acceptors, recyclers, monetary banknote and note handling systems.

### SUMMARY

This disclosure is directed to an externally accessible banknote transport path.

In one aspect, a banknote acceptor includes an externally accessible banknote transport path. The banknote acceptor further includes a spine module operable to support and couple with one or more other modules. The banknote acceptor further includes an accepting module operable to couple to the spine module and to receive and transport banknotes through a portion of the banknote acceptor. The banknote acceptor further includes a sensing module operable to recognize banknotes received in the banknote acceptor. The banknote recycler further includes a cashbox module operable to store banknotes received from one or more other modules in the banknote acceptor. One or more of the accepting module, the sensing module, and the cashbox module include at least one openable panel providing access to a banknote transport path.

In one aspect, a banknote recycler includes an externally accessible banknote transport path. The banknote recycler further includes a spine module operable to support and couple with one or more other modules. The banknote recycler further includes an accepting module operable to couple to the spine module and to receive and transport banknotes through a portion of the banknote recycler. The banknote recycler further includes a sensing module operable to recognize banknotes received in the banknote recycler. The banknote recycler further includes a recycling module operable to receive banknotes from, and dispense banknotes to, one or more other modules in the banknote recycler. The banknote recycler further includes a cashbox module operable to store banknotes received from one or more other modules in the banknote recycler. One or more of the accepting module, the sensing module, the recycling module, and the cashbox module include at least one openable panel providing access to a banknote transport path.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication or interaction between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), electrically erasable programmable read only memory (EEPROM/E2PROM), random access memory (RAM), ferroelectric RAM (FRAM), a hard disk drive, a compact disc (CD), a digital video disc (DVD), or any other type of volatile/non-volatile/memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIGS. 1A-1D illustrate an example banknote recycler with a payment bezel according to various embodiments of this disclosure;

FIGS. 2A-2C illustrate an example banknote recycler without a payment bezel according to various embodiments of this disclosure;

FIGS. 3A-3D illustrate an example spine module according to various embodiments of this disclosure;

FIGS. 4A-4D illustrate an example recycling module in a closed configuration according to various embodiments of this disclosure;

FIGS. 5A-5D illustrate an example recycling module in an open configuration according to various embodiments of this disclosure;

FIGS. 6A-6D illustrate an example recycling module with a capacitive sensor and in an open configuration according to various embodiments of this disclosure;

FIG. 7 illustrates an example capacitive sensor according to various embodiments of this disclosure;

FIG. 8 illustrates another example capacitive sensor according to various embodiments of this disclosure;

FIG. 9 illustrates an example capacitive sensing system in accordance with various embodiments of this disclosure;

FIGS. 10A-10D illustrate an example sensing module in a closed configuration according to various embodiments of this disclosure;

FIGS. 11A-11D illustrate an example sensing module in an open configuration according to various embodiments of this disclosure;

FIG. 12 illustrates a perspective view of a cashbox module in accordance with various embodiments of this disclosure;

FIGS. 13A-13C illustrate various views of an accepting module in accordance with various embodiments of this disclosure;

FIG. 14 illustrates a perspective view of a banknote recycler in accordance with various embodiments of this disclosure;

FIG. 15 illustrates an example document transport issue detection process in accordance with various embodiments of this disclosure;

FIGS. 16A-16E illustrate various views of a banknote recycler in accordance with various embodiments of this disclosure;

FIGS. 17A-17E illustrate schematic views of document acceptor systems according to various embodiments of this disclosure;

FIGS. 18A-18J illustrate schematic views of the document transport system in accordance with various embodiments of this disclosure;

FIGS. 19A-19C illustrate various views of pinch points in accordance with various embodiments of this disclosure;

FIGS. 20A-20F illustrate various views of a document transport system according to various embodiments of this disclosure;

FIGS. 21A-21D illustrate various views of pinch points in accordance with various embodiments of this disclosure;

FIGS. 22A-22F illustrate views of an example document accepting apparatus in accordance with various embodiments of this disclosure;

FIGS. 23A-23J illustrate various views of a document transport system turnaround module according to various embodiments of this disclosure;

FIGS. 24A-24G illustrate various views of the document transport module including an active side and a passive side according to various embodiments of this disclosure;

FIGS. 25A and 25B illustrate perspective views of an example document acceptor module in accordance with various embodiments of this disclosure;

FIG. 26 illustrates an example document transport process in accordance with various embodiments of this disclosure;

FIGS. 27A and 27B illustrate an example banknote recycler according to various embodiments of this disclosure;

FIGS. 28A and 28B illustrate an example transport path including capacitive plates in accordance with various embodiments of this disclosure;

FIGS. 29A and 29B illustrate an example transport path including capacitive plates in accordance with various embodiments of this disclosure;

FIGS. 30A and 30B illustrate an example transport path including capacitive plates in accordance with various embodiments of this disclosure;

FIGS. 31A-31D illustrate an example recycling module in a closed configuration according to various embodiments of this disclosure;

FIGS. 32A-32D illustrate an example recycling module in an open configuration according to various embodiments of this disclosure; and

FIGS. 33A and 33B illustrate example electronic devices in accordance with various embodiments of this disclosure.

### DETAILED DESCRIPTION

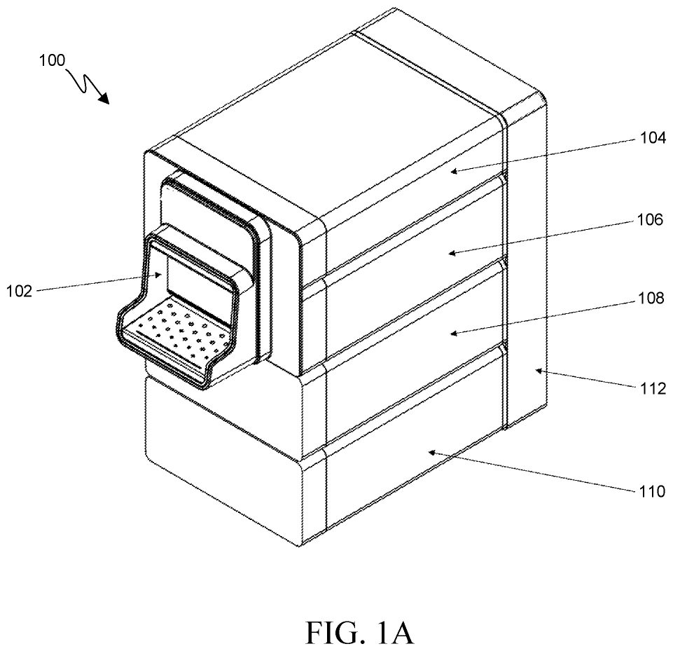

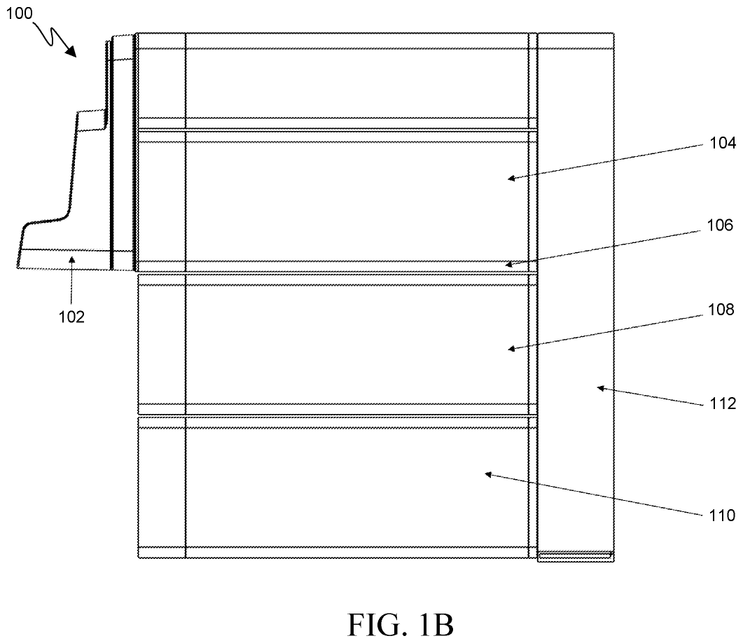

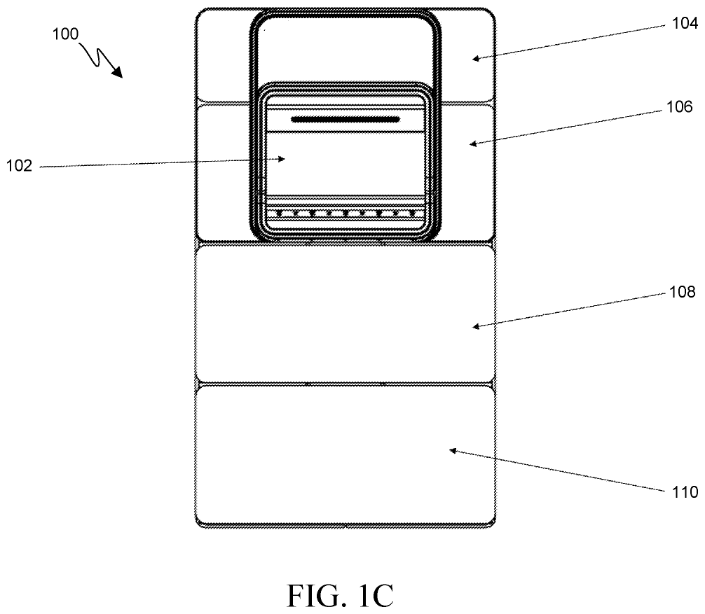

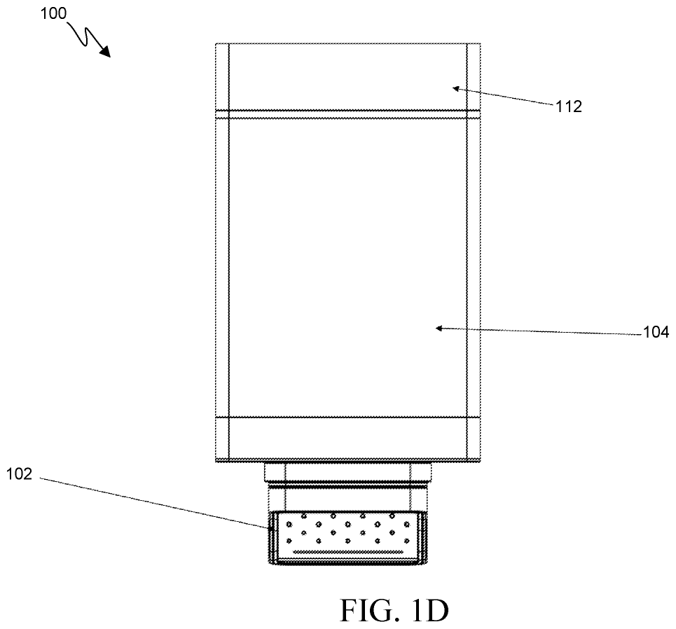

FIGS. 1A through 33B, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged device or system.

As used throughout this specification, the terms currency denomination, denomination of currency, valuable document, currency bill, bill, banknote, note, bank check, paper money, paper currency, ticket, coupon, and cash may be used interchangeably herein to refer to a type of a negotiable instrument or any other writing that evidences a right to the payment of a monetary obligation, typically issued by a central banking authority.

Various embodiments of this disclosure provide a banknote acceptor or recycler with an externally accessible banknote transport path. The externally accessible banknote transport path denotes the main areas or segments of the path along which a banknote travels within the banknote acceptor or recycler (that a note might jam in) will be accessible to the operator. In various embodiments of this disclosure, the banknote acceptor or recycler can include, at certain areas of the banknote transport path, a see-through or clear material to allow an operator to find the jammed note. In some embodiments of this disclosure, the banknote acceptor or recycler can use other external indicators, such as labels, light-emitting diodes (LEDs) lights, digital projections, or noises to guide the operator to the specific location of the jammed bill. The banknote transport path is typically comprised of a significant number of components, several of which are external housings.

The various embodiments of this disclosure provide time savings for a user or operator for clearing jams in the device, less frustration with using the unit in both its inoperable and operable states, and a reduction in service calls or broken components. The various embodiments of this disclosure also provide a banknote acceptor or recycler having an design that is more understandable and relatable to the operator, consumer, and original equipment manufacturer (OEM), regardless of their knowledge of operation, which is helpful to the OEM's service network as well as the end customer or retailer and the retailer's employees. In various embodiments of this disclosure, the banknote transport path access can be integrated into the security system of the device, so that it is not possible to interfere with the banknote transport path while the device is in use, but would not be blocked from being accessed by a separate locking mechanism and key.

By providing accessibility from the outside of the unit to each main section of the banknote transport path, the process for an operator to clear jams and get the device and larger system back up and running is simplified and reduced. In various embodiments of this disclosure, the combination of sensors, access doors/windows, and locking mechanisms will communicate with the controlling electronics of the system, and tie together to have a knowledge and record of jam location, time of clearance, and when indicators such as LEDs, notifications, or other indicators are to be activated. In some embodiments, the access points can be integrated and compensated into the moldings and housings of the banknote acceptor or recycler, within and in addition to the required geometry for the banknote transport path to function.

In various embodiments of this disclosure, when a jam is taking place, the banknote acceptor or recycler will indicate where the jam is occurring within the banknote acceptor or recycler using integrated mechanisms and sensors, and send a notification to connected controlling software and to an operator. The operator can then access the area of the device through the access door, and upon jam removal by hand, close the access door, and the system's sensors can then send another notification that the jam has been cleared, and present options for solving the imbalance of the transaction or to proceed back to normal device function. This communication prevents audit issues and attempts to prevent as many human errors as possible. In existing solutions, it can take multiple steps and multiple levers, latches, and movements to access certain parts of the banknote transport path, with no clear indication of the order in which to do them, or where the jam is located. Additionally, in existing solutions, since some accessible doors can be located on the backside of the unit, this can cause problems in reaching the area of the jam, and often the area is not well lit. In various embodiments of this disclosure, the banknote transport path is more accessible by virtue of the banknote transport path being located along the most accessible and visible panels of separate modules of the banknote acceptor or recycler, meaning along the top and sides rather than back side, and that the path is followed from module to module.

Various embodiments of this disclosure recognize and take into account that current systems for document transport system where a document is held by pinch points created between either two rollers or a roller and belt or between two belts and then moved in an intended direction. This is generally accomplished by having a driving side in a document transport path and a passive side. The active side of the document transport path comprises driving rollers and or driving belts, and the passive side document transport path comprises driven or idle rollers and or driving belts. In many document transport systems driving and driven rollers and belts may be interchanged to not have a distinct driving or driven side.

FIGS. 1A-1D illustrate an example banknote recycler 100 with a payment bezel 102 according to various embodiments of this disclosure. FIG. 1A illustrates a perspective view of the banknote recycler 100 with the payment bezel 102, FIG. 1B illustrates a side view of the banknote recycler 100 with the payment bezel 102, FIG. 1C illustrates a front view of the banknote recycler 100 with the payment bezel 102, and FIG. 1D illustrates a top view of the banknote recycler 100 with the payment bezel 102. Banknote recyclers and payment bezels can come in a wide variety of configurations, and FIGS. 1A-1D do not limit the scope of this disclosure to any particular implementation of a banknote recycler or payment bezel.

The banknote recycler 100 includes a sensing module 104, an accepting module 106, a recycling module 108, a cashbox module 110, and a spine module 112. Each of the sensing module 104, the accepting module 106, the recycling module 108, and the cashbox module 110 can be modular components of the banknote recycler 100, such that each of these components can be removed from the banknote recycler for maintenance, jam correction, or other operations. The spine module 112 can include components operable to support each of the sensing module 104, the accepting module 106, the recycling module 108, and the cashbox module 110. The modules can be arranged in the order from top to bottom of the sensing module 104, the accepting module 106, the recycling module 108, and the cashbox module 110, with the spine module 112 disposed as a back portion of the banknote recycler 100.

The payment bezel 102 can be mounted to a front portion of the banknote recycler 100. For example, the payment bezel 102 can be mounted in front of the sensing module 104 and the accepting module 106, such that banknotes introduced into the banknote recycler 100 via the payment bezel 102 enter the accepting module 106. The accepting module 106 can include internal transport components and/or driving members to transport the banknote, such as wheels or rollers, belts, or other transport components to transport the banknote through an interior of the accepting module 106. The banknote can then be transferred via internal transport components to the sensing module 104. Once the banknote is transferred to the sensing module 104, imaging sensors or other components in the sensing module 104 can view or otherwise detect banknotes traveling through the interior of the sensing module 104.

If the banknote is accepted, the banknote can then be transported back out of the sensing module 104 to another module of the banknote recycler 100, such as the recycling module 108 or the cashbox module 110. If the banknote is rejected, the sensing module 104 can transport the banknote back to the accepting module 106 to dispense the banknote from the payment bezel 102. In some embodiments, the rejected banknote can be first transferred to the recycling module 108 or the cashbox module 110 before being dispensed. In some embodiments, the sensing module 104 can detect banknotes as the banknotes travel through the accepting module 106, such as if the accepting module 106 includes an opening in a top portion of the accepting module 106 that allows imaging sensors or other components in the sensing module 104 to view or otherwise detect banknotes traveling through the interior of the accepting module 106. In some embodiments, the accepting module 106 can pass banknotes to the sensing module 104, and the sensing module 104 can detect the banknotes and pass the banknotes back to the accepting module 106. Based on the detected denomination of the banknote by the sensing module 104, the banknote can be stored in an appropriate module of the banknote recycler 100 according to the detected denomination. The banknote detection components in the sensing module 104 can be physically or communicatively coupled to a controller or processor and memory for controlling transport of the banknote based on the detection of the banknote, and for storing banknote characteristics of the detected banknote, such as serial numbers, denomination, or other characteristics, so that the banknote recycler 100 can track the banknote in the banknote recycler 100 and keep an accurate accounting of the banknotes stored in the banknote recycler 100. The sensing module 104 could be replaced with another sensing module that can comprise a different set of sensors to accommodate different sets of security feature requirements. In addition, the sensing module 104 can also be removed for maintenance and replaced with another sensing module 104. The recycling module 108 can be removed for maintenance and replaced with another recycling module 108. The cashbox module 110 can be removed and replaced with another cashbox module 110 when the cashbox module is either full, or is when the cashbox is otherwise to be emptied.

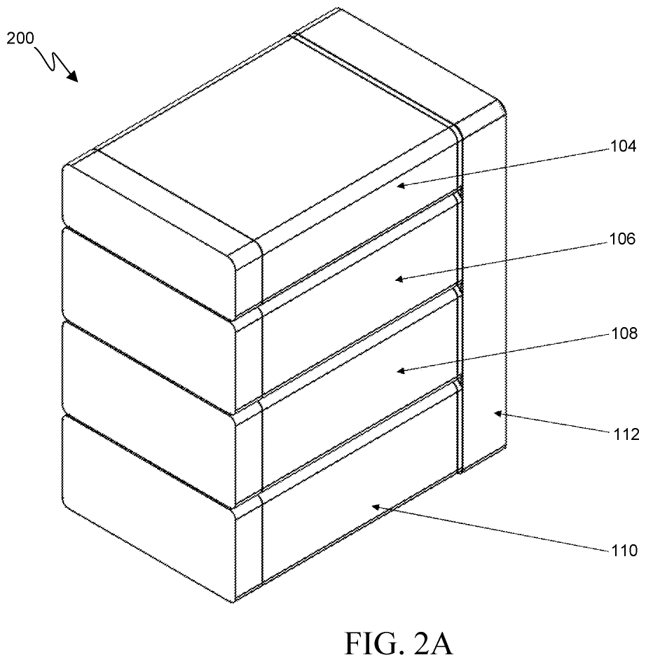

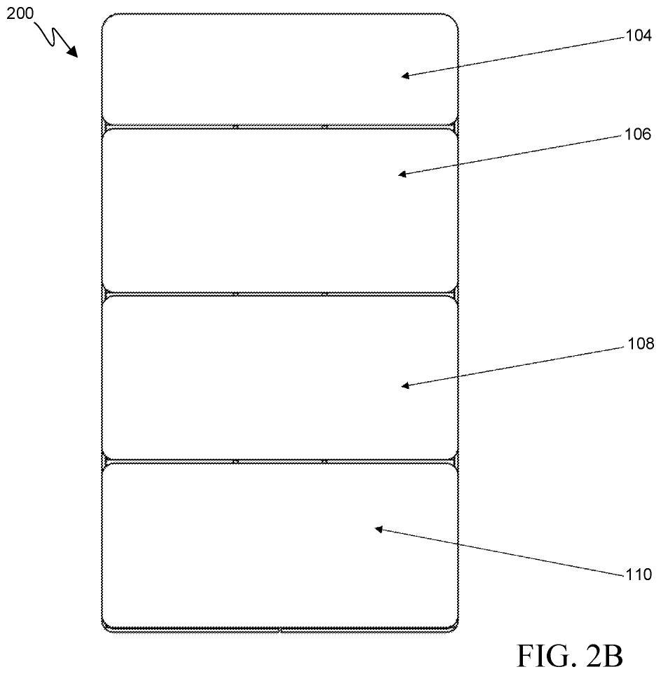

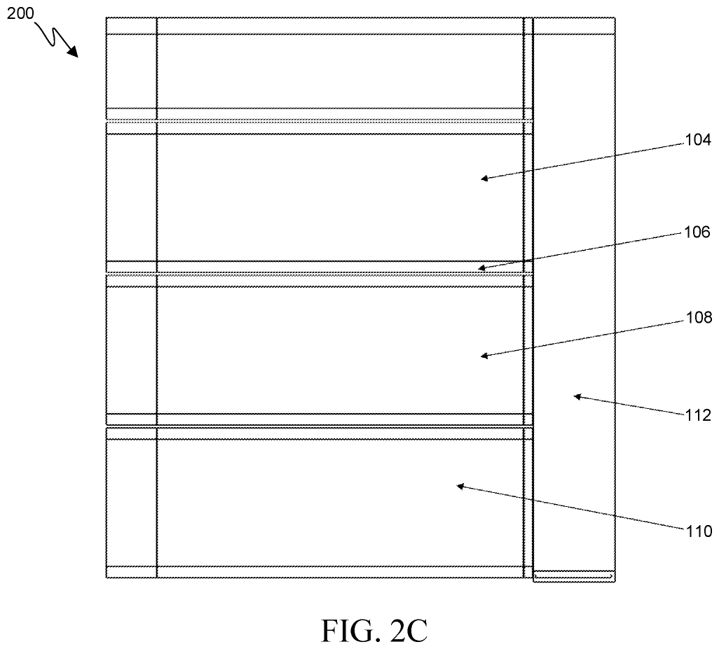

FIGS. 2A-2C illustrate an example banknote recycler 200 without a payment bezel according to various embodiments of this disclosure. FIG. 2A illustrates a perspective view of the banknote recycler 200, FIG. 2B illustrates a front view of the banknote recycler 200, and FIG. 2C illustrates a side view of the banknote recycler 200. Banknote recyclers can come in a wide variety of configurations, and FIGS. 2A-2C do not limit the scope of this disclosure to any particular implementation of a banknote recycler. In some embodiments, the banknote recycler 200 can be the banknote recycler 100.

The banknote recycler 200 is illustrated without a payment bezel. The banknote recycler 200 again includes a sensing module 104, an accepting module 106, a recycling module 108, a cashbox module 110, and a spine module 112. In some embodiments, FIGS. 2A-2C are provided to show the overall configuration of each of the sensing module 104, the accepting module 106, the recycling module 108, and the cashbox module 110. In some embodiments, the payment bezel 102 can be removed from the banknote recycler 200 when not in use. In some embodiments, other banknote input and/or output devices can be included to introduce banknotes into the banknote recycler 200 or dispense banknotes from the banknote recycler 200.

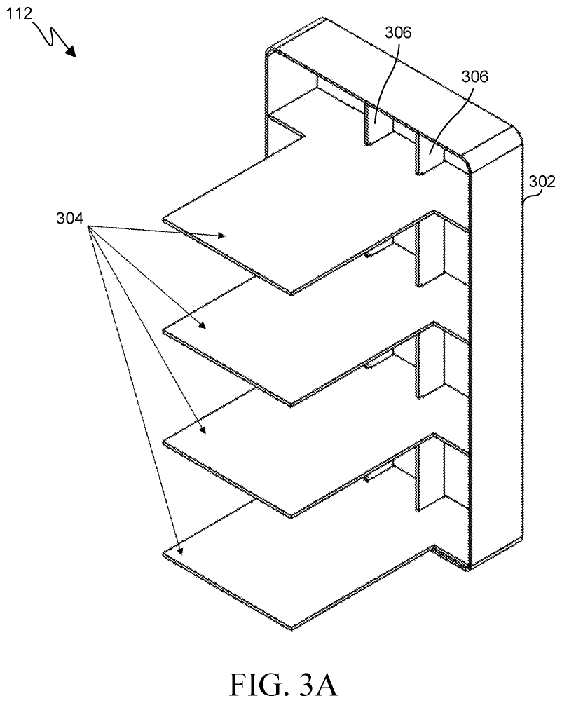

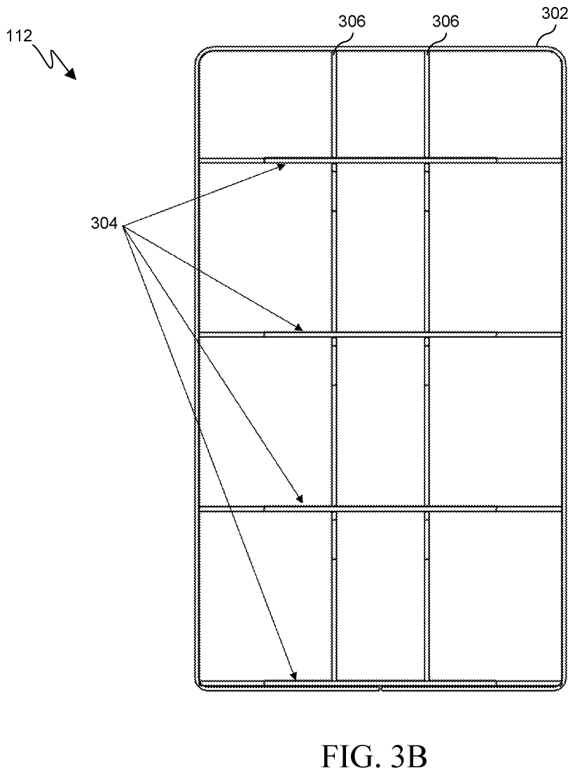

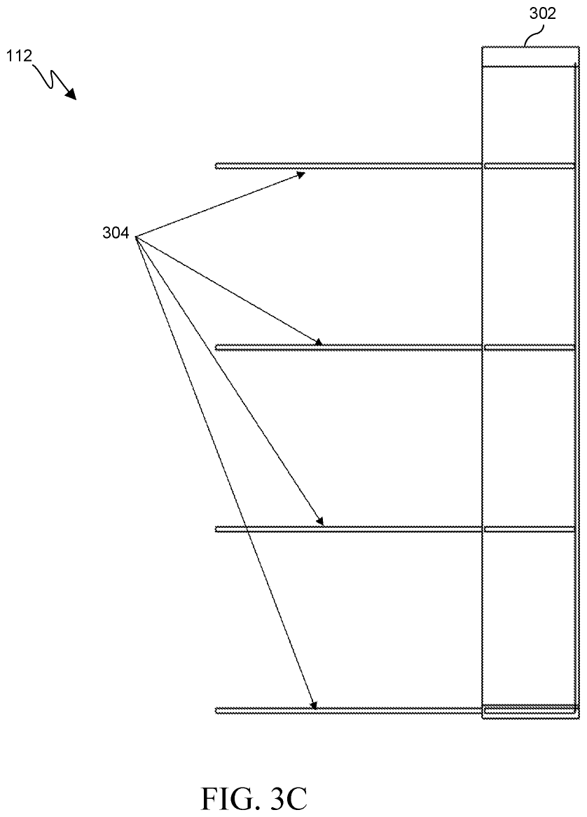

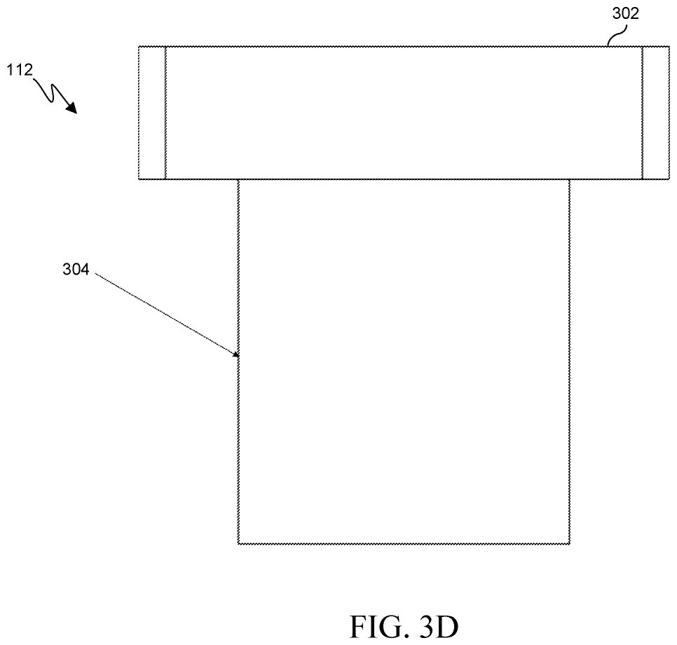

FIGS. 3A-3D illustrate an example spine module 112 according to various embodiments of this disclosure. FIG. 3A illustrates a perspective view of the spine module 112, FIG. 3B illustrates a front view of the spine module 112, FIG. 3C illustrates a side view of the spine module 112, and FIG. 3D illustrates a top view of the spine module 112. The spine module can come in a wide variety of configurations, and FIGS. 3A-3D do not limit the scope of this disclosure to any particular implementation of a spine module. In some embodiments, the spine module 112 can be included in the banknote recycler 100 or the banknote recycler 200.

The spine module 112 includes a frame 302 making up a back portion of the spine module 112. The frame 302 includes a plurality of support surfaces 304, or shelves, extending horizontally from a center portion of the frame 302 of the spine module 112. Each of the support surfaces 304 are arranged such that each support surface 304 can support a module of the banknote recycler. For example, the support surfaces 304 can be arranged above and below each other so that modules such as the sensing module 104, the accepting module 106, the recycling module 108, and the cashbox module 110 can be installed on the spine module 112. In some embodiments, the modules can be placed on top of the support surfaces 304. In some embodiments, the support surfaces 304 can be inserted into the modules, such as via a slot in a portion of the module.

In some embodiments, once the modules are being supported by the support surfaces 304, additional fixation devices such as bolts, screws, brackets, or other devices can be used to more securely fix the modules to the spine module 112. In some embodiments, the frame 302 of the spine module 112 can include beams or panels 306 extending from an interior bottom surface to an interior top surface of the frame 302. The beams 306 provide additional structural integrity to the frame 302 such that the frame 302 is capable of carrying the weight of the plurality of modules installable on the spine module 112. It will be understood that the spine module 112 allows for various modules of differing combinations to be installed. For example, multiple recycling modules 108 could be installed onto the spine module 112. In some embodiments, a cashbox module 110, or any of the other modules, may not be installed on the spine module 112. It will also be understood that the spine module 112 can be of various sizes and include any number of support surfaces 304, depending on the number of modules to be accommodated.

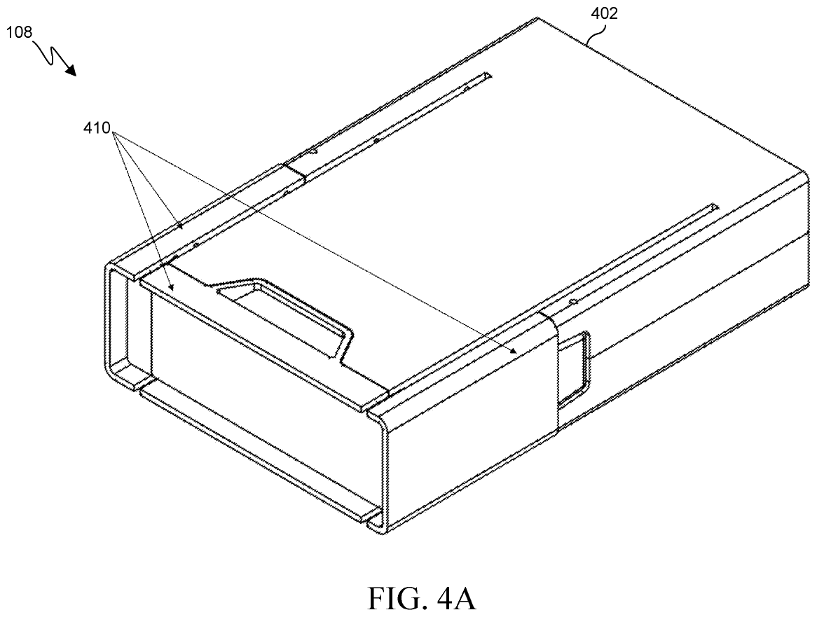

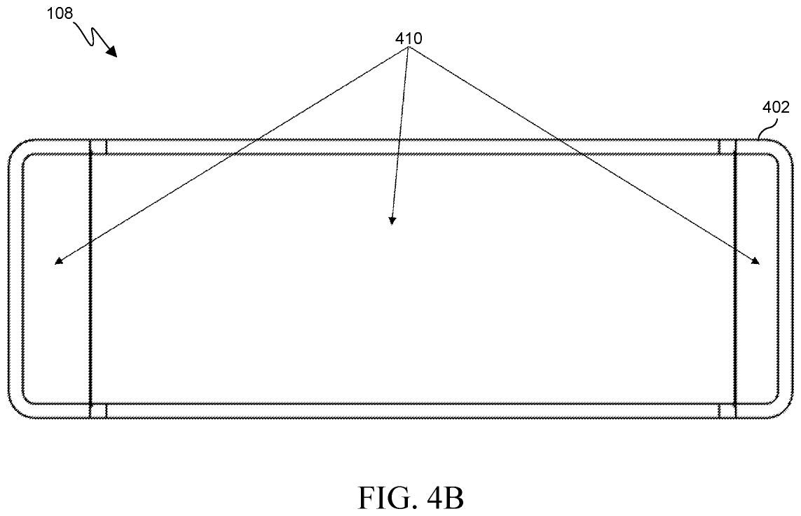

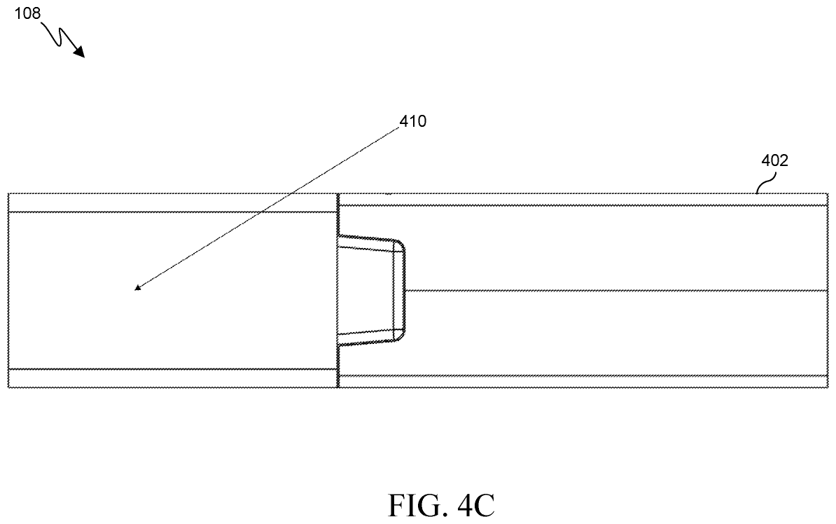

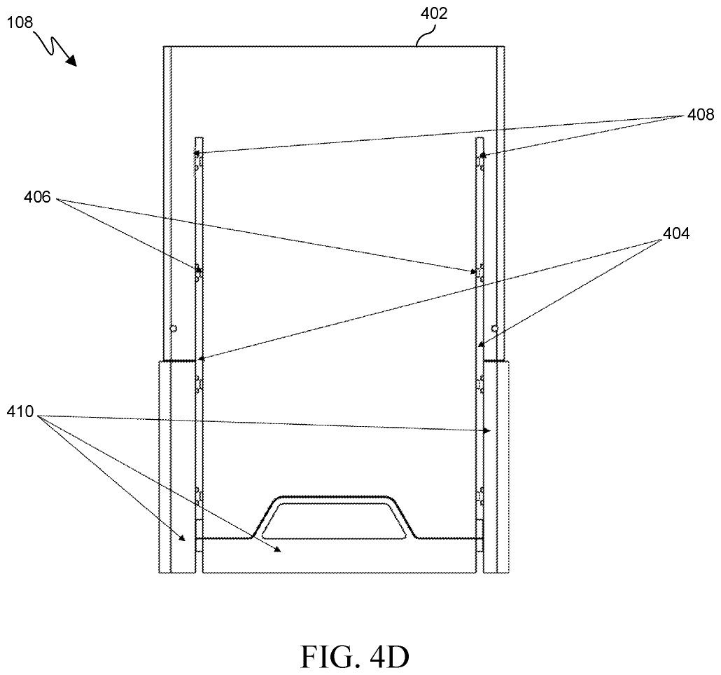

FIGS. 4A-4D illustrate an example recycling module 108 in a closed configuration according to various embodiments of this disclosure. FIG. 4A illustrates a perspective view of the recycling module 108 in the closed configuration, FIG. 4B illustrates a front view of the recycling module 108 in the closed configuration, FIG. 4C illustrates a side view of the recycling module 108 in the closed configuration, and FIG. 4D illustrates a top view of the recycling module 108 in the closed configuration. The recycling module can come in a wide variety of configurations, and FIGS. 4A-4D do not limit the scope of this disclosure to any particular implementation of a recycling module. In some embodiments, the recycling module 108 can be included in the banknote recycler 100 or the banknote recycler 200, such as being installed on a support surface 304 of the spine module 112.

While in the closed configuration, the recycling module 108 can be installed onto the spine module 112 and operated in conjunction with the banknote recycler to receive and dispense banknotes. The recycling module 108 includes a body 402 having an interior portion. The interior portion includes banknote transport components to move banknotes through a banknote transport path 404 such as a plurality of active rollers 406 and passive rails 408. The active rollers 406 are driven by at least an actuator. One or more passive rails 408 can be placed opposite an active roller 406 in the recycling module 108. The active rollers 406 are operable to transport banknotes along the banknote transport path 404 within the recycling module 108. The active rollers 406 drive banknotes inside the banknote transport path 404, where banknotes are directly or indirectly pressed between the active rollers 406 and the passive rails 408. The recycling module 108 also includes one or more openable panels 410 that allow for an operator to inspect inside portions of the recycling module 108, such as in the event of a banknote jam. For example, the recycling module 108 can include a first openable panel 410 on a front portion of the recycling module that can be hingedly connected such that the operator can view inside the recycling module 108 and reach into the recycling module 108 if needed to correct issues within the recycling module 108.

The recycling module can also include one or more openable panels 410 on a side exterior surface. Each openable side panel 410 can be hingedly coupled to a side of the recycling module 108 such that the side panel 410 opens away from the side of the recycling module 108 and extends in a direction perpendicular to the banknote transport path 404 when fully opened. Opening the one or more side panels 410 grants access to at least some of the active rollers 406 and passive rails 408, such that, if a banknote is jammed at one of the active rollers 406 and/or passive rails 408, the jam can be corrected. In some embodiments, the recycling module 108 can include transparent windows, such as transparent glass or plastic portions, that are disposed at one or more of the openable panels 410, or elsewhere on various surfaces of the recycling module 108, such as a top surface overlooking the banknote transport path 404, to allow an operator or user to view banknotes either traveling through the banknote transport path 404, or jammed banknotes. For example, if one of the side openable panels 410 includes a transparent surface, and a banknote becomes jammed in the area behind the openable panel 410, an operator or user would be able to see the location of the jam, open the side panel 410, and correct the jam. In some embodiments, the recycling module 108 can include window-like features, such as slits or windows or slots, that are disposed at one or more of the openable panels 410, or elsewhere on various surfaces of the recycling module 108, such as a top surface overlooking the banknote transport path 404, to allow an operator or user to view banknotes either traveling through the banknote transport path 404, or jammed banknotes. For example, if one of the side openable panels 410 includes a window-like feature, and a banknote becomes jammed in the area behind the openable panel 410, an operator or user would be able to see the location of the jam, push the note through the windows like feature on the side panel 410, and correct the jam. If the jam requires opening of the side panel 410 to correct the jam, an operator or user would be able to see the location of the jam, open the side panel 410, and correct the jam.

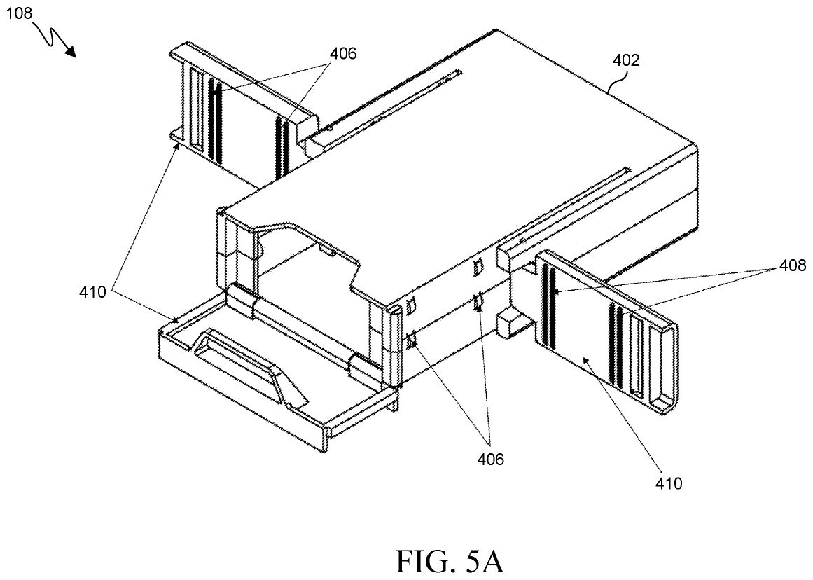

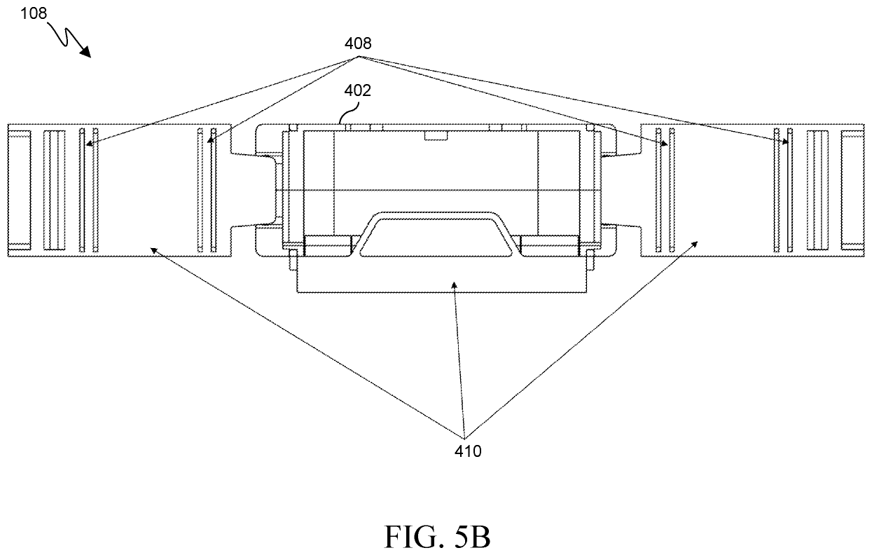

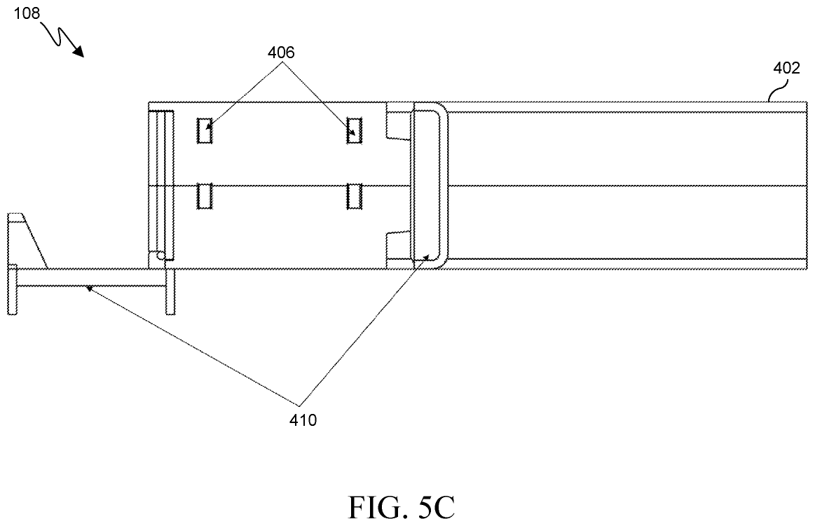

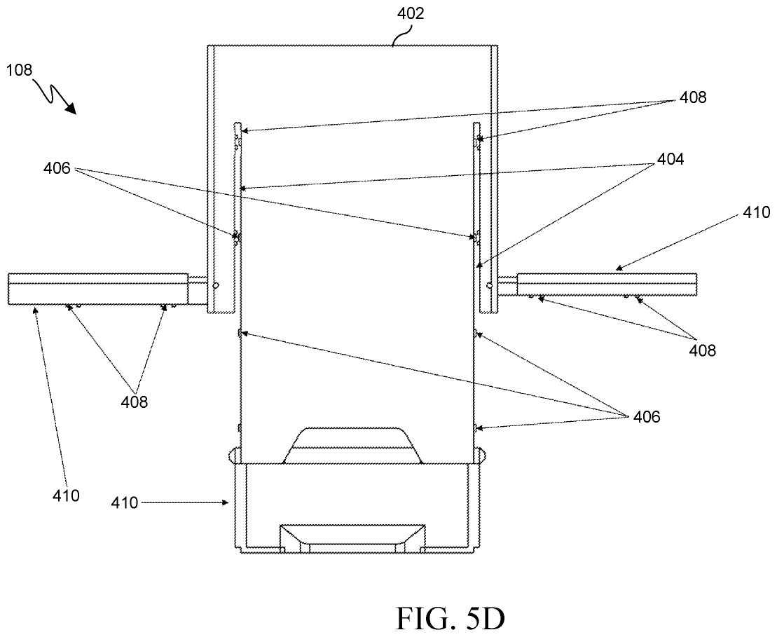

FIGS. 5A-5D illustrate an example recycling module 108 in an open configuration according to various embodiments of this disclosure. FIG. 5A illustrates a perspective view of the recycling module 108 in the open configuration, FIG. 5B illustrates a front view of the recycling module 108 in the open configuration, FIG. 5C illustrates a side view of the recycling module 108 in the open configuration, and FIG. 5D illustrates a top view of the recycling module 108 in the open configuration. The recycling module can come in a wide variety of configurations, and FIGS. 5A-5D do not limit the scope of this disclosure to any particular implementation of a recycling module.

While in the open configuration, interior portions including the banknote transport path 404, the active rollers 406, the passive rails 408, and other components of the recycling module 108 can be inspected. The recycling module 108 can include an openable panel 410 on a front portion of the recycling module 108 that can be hingedly connected such that the operator can view inside the recycling module 108 and reach into the recycling module 108 if needed to correct issues within the recycling module 108.

The recycling module 108 can also include one or more openable panels 410 on a side exterior surface. Each openable side panel 410 can be hingedly coupled to a side of the recycling module such that the side panel 410 opens away from the side of the recycling module 108 and extends in a direction perpendicular to the banknote transport path 404 when fully opened. Opening the one or more side panels 410 grants access to at least some of the active rollers 406 and passive rails 408, such that, if a banknote is jammed at one of the active rollers 406 and/or passive rails 408, the jam can be corrected. In some embodiments, the recycling module can include transparent windows, such as transparent glass or plastic portions, that are disposed at one or more of the openable panels 410, or elsewhere on various surfaces of the recycling module 108, such as a top surface overlooking the banknote transport path 404, to allow an operator or user to view banknotes either traveling through the banknote transport path 404, or jammed banknotes. For example, if one of the side openable panels 410 includes a transparent surface, and a banknote becomes jammed in the area behind the openable panel 410, an operator or user would be able to see the location of the jam, open the side panel 410, and correct the jam.

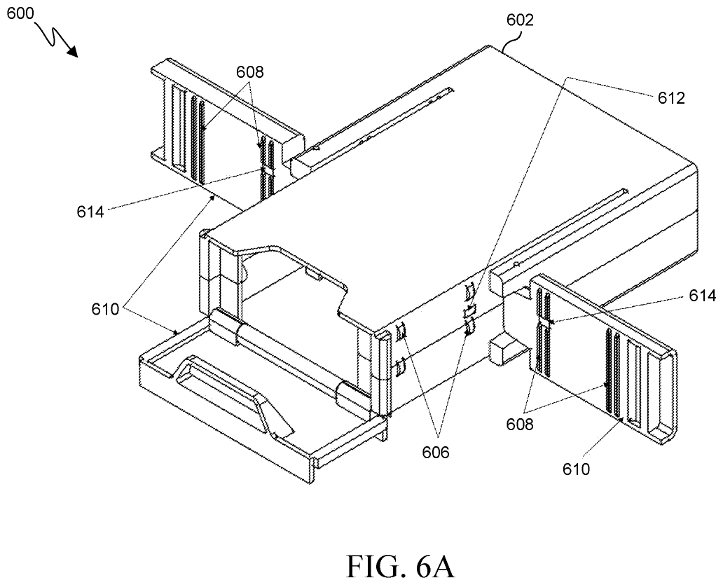

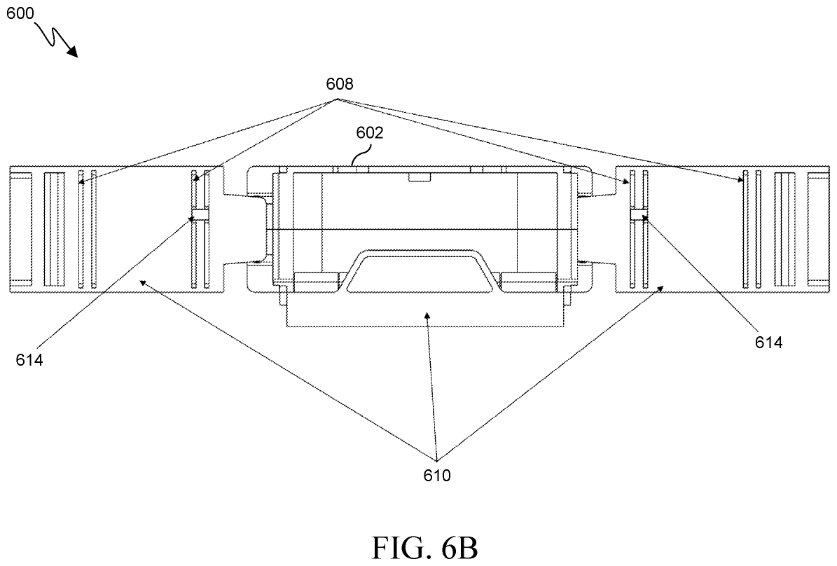

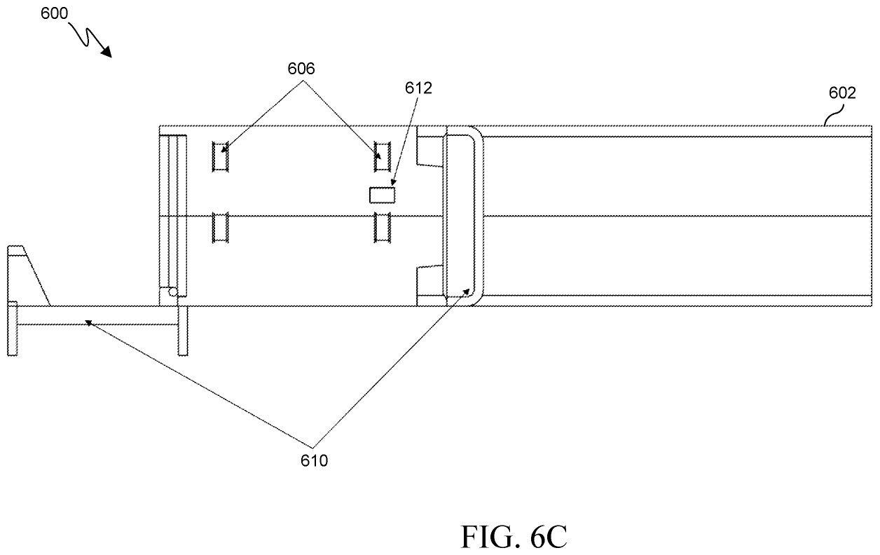

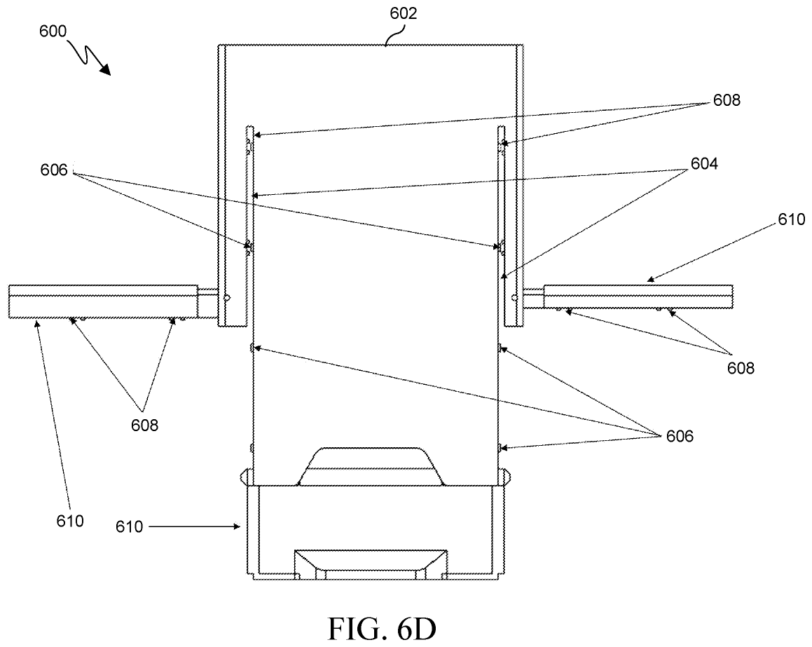

FIGS. 6A-6D illustrate an example recycling module 600 with a capacitive sensor and in an open configuration according to various embodiments of this disclosure. FIG. 6A illustrates a perspective view of the recycling module 600 with the capacitive sensor and in the open configuration, FIG. 6B illustrates a front view of the recycling module 600 with the capacitive sensor and in the open configuration, FIG. 6C illustrates a side view of the recycling module 600 with the capacitive sensor and in the open configuration, and FIG. 6D illustrates a top view of the recycling module 600 with the capacitive sensor and in the open configuration. The recycling module 600 and capacitive sensor can come in a wide variety of configurations, and FIGS. 6A-6D do not limit the scope of this disclosure to any particular implementation of a recycling module or capacitive sensor.

As illustrated in FIGS. 6A-6D, the recycling module 600 includes a body 602 including one or more capacitive sensors installed therein. In some embodiments, each capacitive sensor includes an active or receiving electrode 612 and passive or inducing electrode 614. In some embodiments, the capacitive sensor is a dielectric input/tracking sensor. In some embodiments, the passive or inducing electrode 614 does not include active electronic components. Existing banknote sensors often use optical sensors that detect light or capture images of banknotes. In some situations, problems arise when a banknote or some part of the banknote is too transparent and is not able to stop light effectively. Some banknote types also can have a plastic base and large transparent security parts that can cause detection issues. Optical sensors also may not detect when multiple banknotes are transported at the same time, such as a double stacked banknote.

While in the open configuration, interior portions including a banknote transport path 604, active rollers 606, passive rails 608, and other components of the recycling module 600 can be inspected. The recycling module 600 can include an openable panel 610 on a front portion of the recycling module 600 that can be hingedly connected such that the operator can view inside the recycling module 600 and reach into the recycling module 600 if needed to correct issues within the recycling module 600. The recycling module 600 can also include one or more openable panels 610 on a side exterior surface. Each openable side panel 610 can be hingedly coupled to a side of the recycling module 600 such that the side panel 610 opens away from the side of the recycling module 600 and extends in a direction perpendicular to the banknote transport path 604 when fully opened. Opening the one or more side panels 610 grants access to at least some of the active rollers 606 and passive rails 608, such that, if a banknote is jammed at one of the active rollers 606 and/or passive rails 608, the jam can be corrected. In some embodiments, the recycling module 600 can include transparent windows, such as transparent glass or plastic portions, that are disposed at one or more of the openable panels 610, or elsewhere on various surfaces of the recycling module 600, such as a top surface overlooking the banknote transport path 604, to allow an operator or user to view banknotes either traveling through the banknote transport path 604, or jammed banknotes.

As shown in FIGS. 6A-6D, opening one or more of the openable panels 610 also reveals the location of at least one of the capacitive sensors. In some embodiments, the passive electrodes 614 are disposed on an inside surface of the openable panels 610. When the openable panels 610 are closed, the active electrodes 612 and the passive electrodes 614 are disposed adjacent one another. The capacitive sensor can detect the presence of banknotes in the recycling module 600 by detecting small variations of capacitance in order to detect the presence of a banknote. In some embodiments, the capacitive sensor can also be used to evaluate the thickness of banknotes, such as detecting multiple banknotes stacked together, which have a larger thickness than a single banknote, which provides a different capacitance than a single banknote. In some embodiments, the capacitive sensor may be calibrated prior to initial use. It will be understood that one or more capacitive sensors could also be included in other modules, such as the sensing module 104, the accepting module 106, or the cashbox module 110.

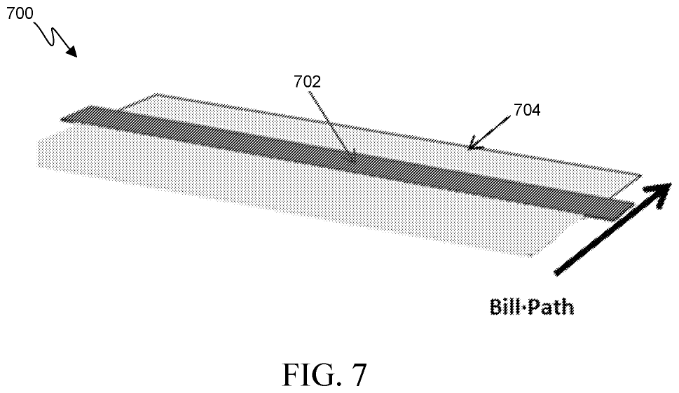

FIG. 7 illustrates an example capacitive sensor 700 according to various embodiments of this disclosure. The capacitive sensor 700 can come in a wide variety of configurations, and FIG. 7 does not limit the scope of this disclosure to any particular implementation of a capacitive sensor.

The capacitive sensor 700 can be used in a banknote recycler, such as shown in FIGS. 6A-6D. The capacitive sensor 700 includes at least one electrode 702. In some embodiments, the at least one electrode 702 of the capacitive sensor 700 is fed with high frequency voltage and placed near the bill path so that electrical parameters of the electrode varies when a banknote 704 approaches and/or passes by the electrode 702. In some embodiments, a processor or controller can be communicatively connected to the electrode 702 to detect the variances in capacitance of the banknote 704 as the banknote 704 approaches and/or passes the electrode 702 and determine based on the capacitance various properties of the banknote such as the presence of the banknote 704, banknote thickness, banknote size or dimensions, banknote width, position of edges of banknotes, or other properties.

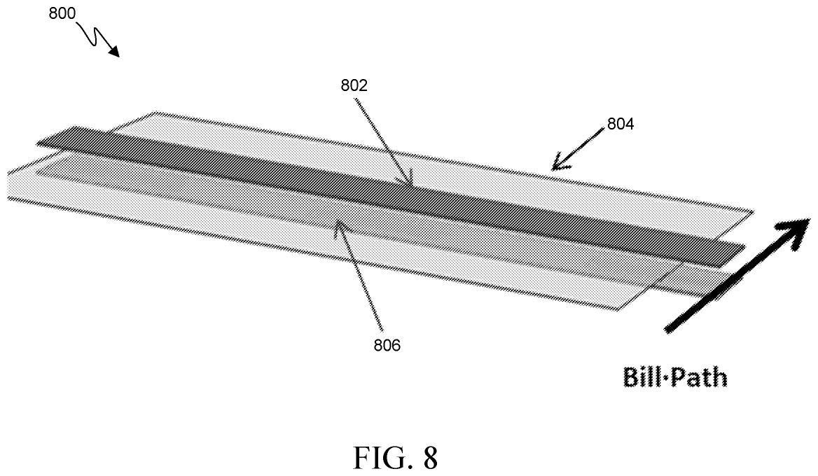

FIG. 8 illustrates another example capacitive sensor 800 according to various embodiments of this disclosure. The capacitive sensor 800 can come in a wide variety of configurations, and FIG. 8 does not limit the scope of this disclosure to any particular implementation of a capacitive sensor.

The capacitive sensor 800 can be used in a banknote recycler, such as shown in FIGS. 6A-6D. In some embodiments, the capacitive sensor 800 can include an active or receiving electrode 802 and a passive or inducing electrode 806. In some embodiments, the passive or inducing electrode 806 is not electrically connected to any part of the acceptor. In some embodiments, the passive or inducing electrode 806 can be driven with voltage and be placed in an area of the banknote transport path that is at an offset to the active or receiving electrode 802. In some embodiments, the passive or inducing electrode 806 can be disposed on the other side of the active or receiving electrode 802, in an area further within the banknote transport path.

In some embodiments, the passive or inducing electrode 806, or inducing electrode, induces voltage on the active or sensing electrode 802. If a bill is present, the voltages can have some initial values. After the bill enters, the initial values change based on the change of capacitance between the passive or inducing electrode 806 and the active or receiving electrode 802, caused by the banknote being between the passive or inducing electrode 806 and the active or receiving electrode 802. In some embodiments, a processor or controller can be communicatively connected to the active or receiving electrode 802 and/or the passive or inducing electrode 806 to detect the variances in capacitance of the banknote 804 as the banknote 804 approaches and/or passes the active or receiving electrode 802 and/or the passive or inducing electrode 806, and determine based on the capacitance various properties of the banknote such as the presence of the banknote 804, banknote thickness, banknote size or dimensions, banknote width, position of edges of banknotes, or other properties. In some embodiments, the active or receiving electrodes 802 determine presence or absence of a banknote 804 by change in electric field surrounding the active or receiving electrodes 802.

When the capacitive sensor 800 is included in a banknote recycler, such as in a banknote recycling module such as that illustrated in FIGS. 6A-6D, if a banknote jams within the banknote transport path, the capacitive sensor 800 can be used to detect the location of the banknote within the banknote transport path. For example, if a capacitive sensor 800 is placed within a openable side panel, such as side panel 610, and a banknote jam occurs at an active roller or passive rail within that side panel 610, a processor of the banknote recycler can determine that the banknote is currently located at the location of the side panel, and issue a signal indicating the location. For example, a light indicator on the side panel can light up to indicate that the jam is within the openable side panel, allowing an operator to open that side panel displaying the light indicator, and correct the jam. In some embodiments, the processor can issue a signal to display on a display screen viewable to the operator indicating the location of the jam, such as a text indicator, a graphical indicator such as a 2D or 3D image of the banknote recycler with an area of the banknote recycler containing the jam indicated, such as lighting up, highlighting, pointing to, etc., that area of the banknote recycler, or other indicators.

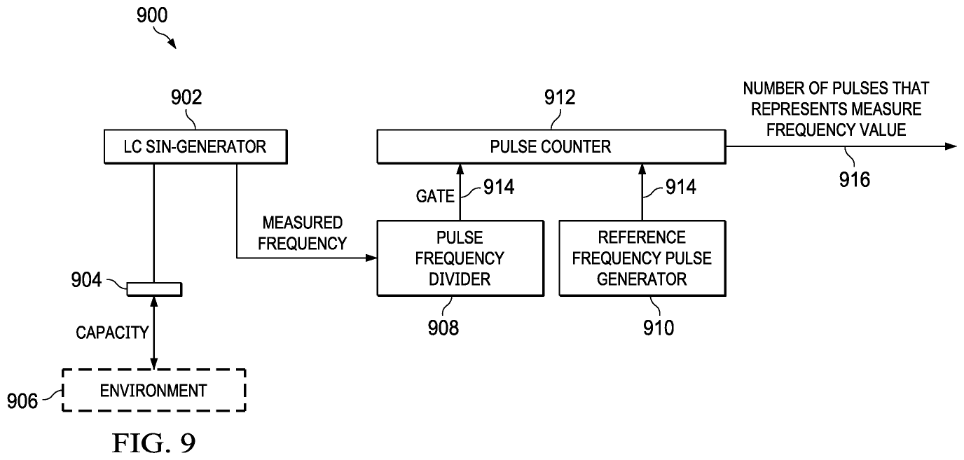

FIG. 9 illustrates an example capacitive sensing system 900 in accordance with various embodiments of this disclosure. Capacitive sensing systems can come in a wide variety of configurations, and FIG. 9 does not limit the scope of this disclosure to any particular implementation of a capacitive sensing system.

The capacitive sensing system 900 can be used with the capacitive sensors disclosed with respect to FIGS. 6A-6D, 7, and 8. The capacitive sensing system includes an LC sin-generator 902 that receives capacitance measurements between an electrode 904 and environment 906, a pulse frequency divider 908, a reference frequency pulse generator, 910 and a pulse counter 912. Conversion of the capacity variance into a digital reading can be performed by incorporation of the electrode 904 in the LC sin-generator 902 so that the frequency of a generated voltage varies with the capacity alteration. The frequency can be measured by one or more methods, such as by digital period measurement. The pulse frequency divider 908 receives measured frequencies from the LC sin-generator 902. The pulse frequency divider 908 and the reference frequency pulse generator 910 are connected to the pulse counter 912 via gates 914.

The reference frequency pulse generator 910 provides a reference pulse that can be compared to a pulse provided by the pulse frequency divider 908 based on the measured frequency received by the pulse frequency divider 908 from the LC sin-generator 902 that represents the capacitance sensed by the capacitive sensor or electrode 904. The pulse counter 912 counts the number of pulses and provides an output 916 of a number of pulses that represents a measured frequency value, such as outputting the measured frequency value to a processor that can trigger various operations of the banknote recycler based on the measured values for banknotes passing the capacitive sensor. In some embodiments, the components 902, 908, 910, and 912 can be separate physical devices connected to a processor, or, in some embodiments, some or all of 902, 908, 910, and 912 can be functional or logical components of a processor, such as a processor within a banknote recycler.

In other embodiments, the pulse frequency divider 908 provides a gate pulse that can be filled by reference pulses provided by the reference pulse generator 910. The number of pulses is captured by the pulse counter 912 that represents the capacitance sensed by the capacitive sensor or electrode 904. The pulse counter 912 counts the number of pulses and provides an output 916 of a number of pulses that represents a measured frequency value, such as outputting the measured frequency value to a processor that can trigger various operations of the banknote recycler based on the measured values for banknotes passing the capacitive sensor. In some embodiments, the components 902, 908, 910, and 912 can be separate physical devices connected to a processor, or, in some embodiments, some or all of 902, 908, 910, and 912 can be functional or logical components of a processor, such as a processor within a banknote recycler.

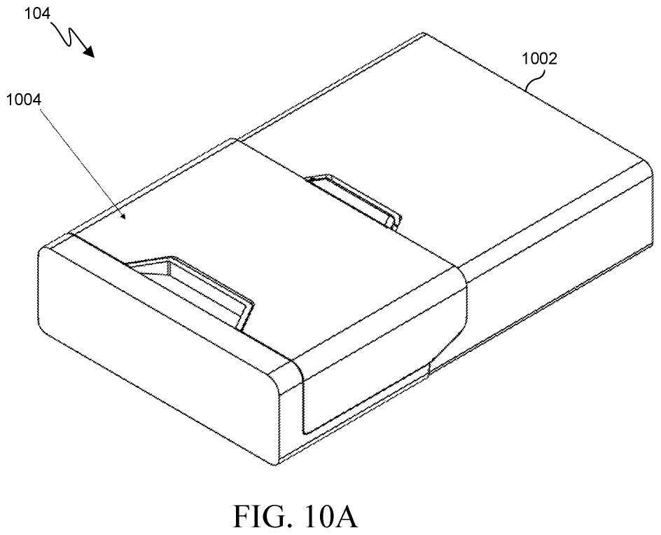

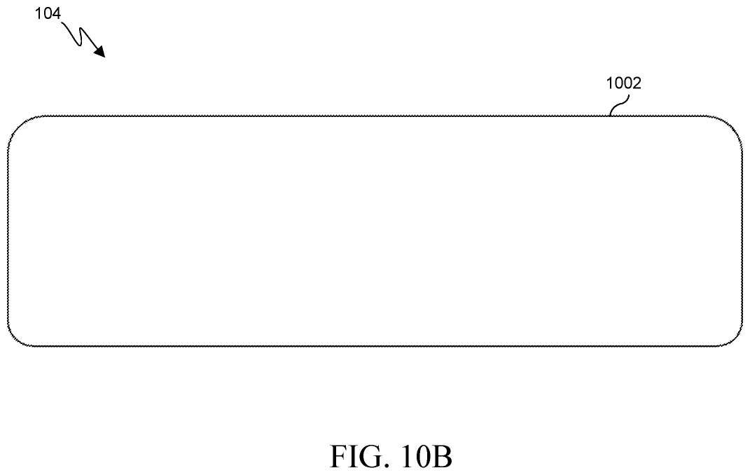

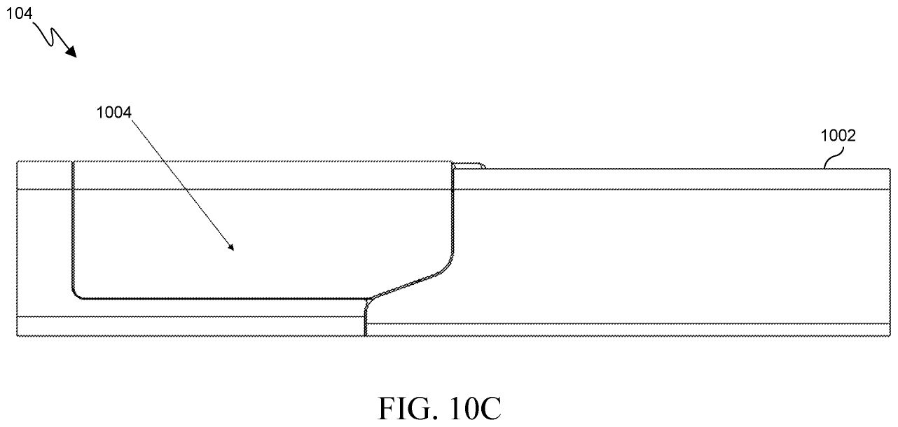

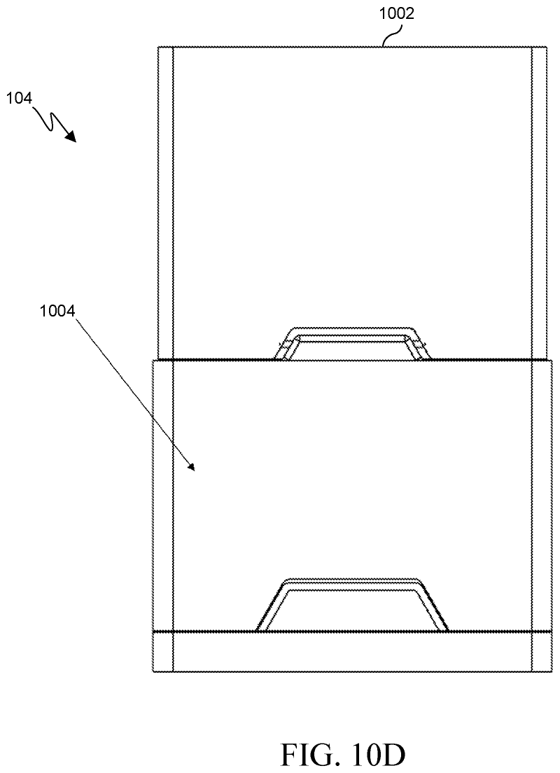

FIGS. 10A-10D illustrate an example sensing module 104 in a closed configuration according to various embodiments of this disclosure. FIG. 10A illustrates a perspective view of the sensing module 104 in the closed configuration, FIG. 10B illustrates a front view of the sensing module 104 in the closed configuration, FIG. 10C illustrates a side view of the sensing module 104 in the closed configuration, and FIG. 10D illustrates a top view of the sensing module 104 in the closed configuration. The sensing module 104 can come in a wide variety of configurations, and FIGS. 10A-10D do not limit the scope of this disclosure to any particular implementation of a sensing module.

The sensing module 104 includes a body 1002 that houses various components such as a banknote transport components and sensing components such as imaging sensors or cameras used in the detection and recognition of banknotes. While in the closed configuration, the sensing module 104 can be installed onto the spine module 112 of a banknote recycler such as banknote recyclers 100 and 200. The sensing module 104 can be operated in conjunction with the banknote recycler to detect and/or recognize banknotes and banknote characteristics. In some embodiments, the sensing module 104 includes within an interior portion of the body 1002 of the sensing module a plurality of active rollers and passive rails. One or more passive rails can be placed opposite an active roller in the sensing module. The active rollers are operable to transport banknotes along a banknote transport path within the sensing module 104. The sensing module 104 also includes one or more openable panels 1004 that allow for an operator to inspect inside portions of the sensing module 104, such as in the event of a banknote jam.

For example, the sensing module 104 can include an openable panel 1004 on a top portion of the sensing module that can be hingedly connected such that the operator can view inside the sensing module 104 and reach into the sensing module 104 if needed to correct issues within the sensing module 104. Opening the panel 1004 grants access to at least some of the active rollers and passive rails, such that, if a banknote is jammed at one of the active rollers and/or passive rails, the jam can be corrected. In some embodiments, the sensing module 104 can include transparent windows, such as transparent glass or plastic portions disposed at the openable panels 1004, or elsewhere on various surfaces of the sensing module 104, such as a top surface overlooking the banknote transport path, to allow an operator or user to view banknotes either traveling through the banknote transport path, or jammed banknotes.

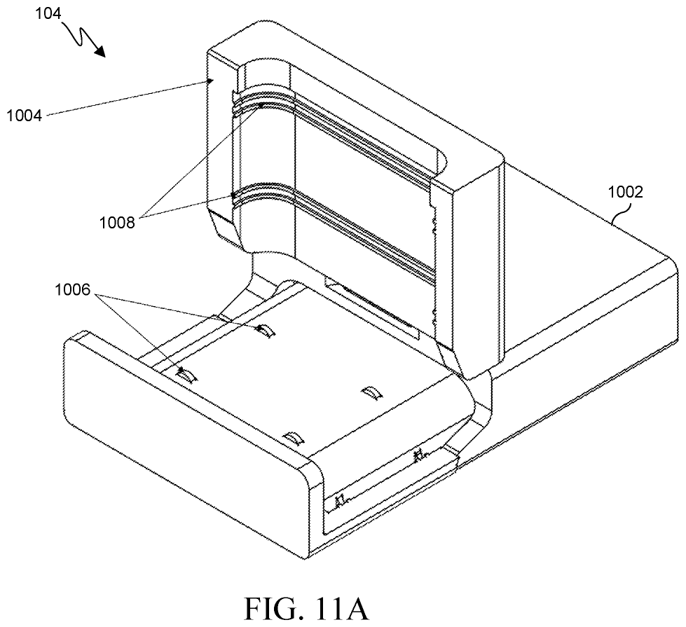

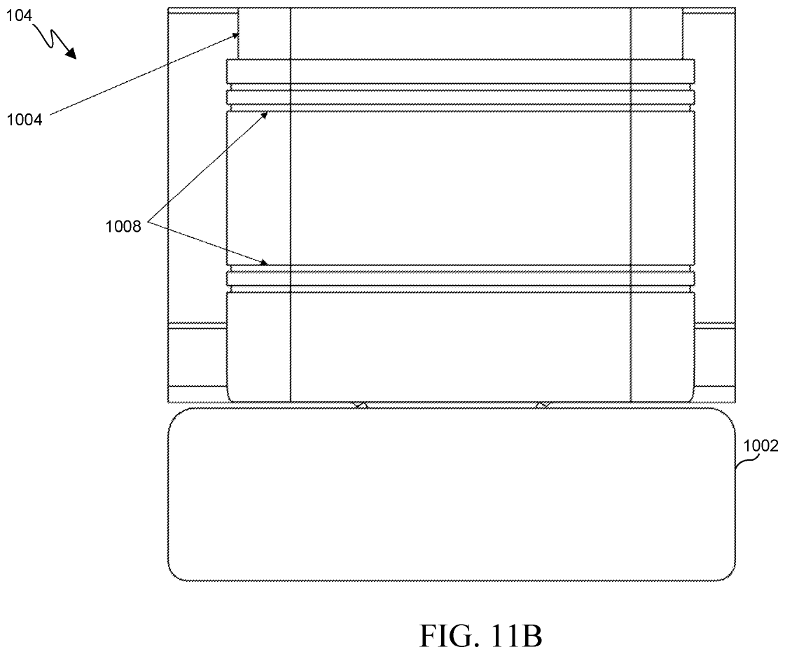

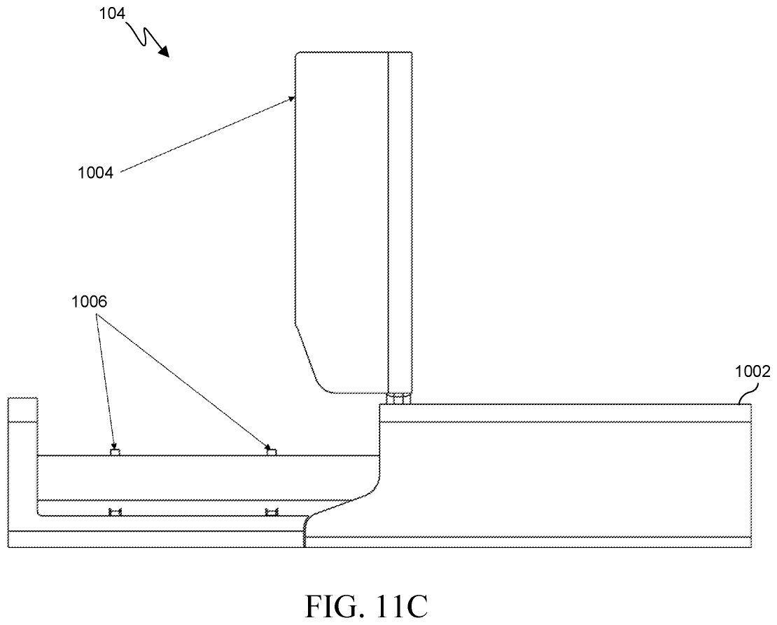

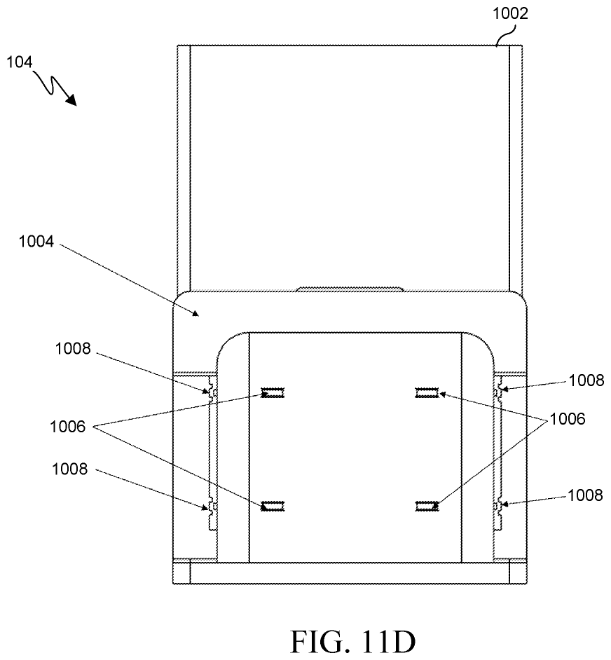

FIGS. 11A-11D illustrate an example sensing module 104 in an open configuration according to various embodiments of this disclosure. FIG. 11A illustrates a perspective view of the sensing module 104 in the open configuration, FIG. 11B illustrates a front view of the sensing module 104 in the open configuration, FIG. 11C illustrates a side view of the sensing module 104 in the open configuration, and FIG. 11D illustrates a top view of the sensing module 104 in the open configuration. The sensing module 104 can come in a wide variety of configurations, and FIGS. 11A-11D do not limit the scope of this disclosure to any particular implementation of a sensing module.

While in the open configuration, an operator can inspect inside portions of the sensing module 104, such as in the event of a banknote jam. For example, the sensing module 104 can include the openable panel 1004 on a top portion of the sensing module 104 that can be hingedly connected such that the operator can view inside the sensing module 104 and reach into the sensing module if needed to correct issues within the sensing module 104. Opening the panel 1004 grants access to at least some of active rollers 1006 and passive rails 1008, such that, if a banknote is jammed at one of the active rollers 1006 and/or passive rails 1008, the jam can be corrected. In some embodiments, the sensing module 104 can include transparent windows, such as transparent glass or plastic portions, that are disposed at one or more of the openable panels, or elsewhere on various surfaces of the sensing module 104, such as a top surface overlooking the banknote transport path on the openable panel 1004 of the top portion, to allow an operator or user to view banknotes either traveling through the banknote transport path, or jammed banknotes. In some embodiments, the sensing module 104 can include a banknote transport path that is oriented in a different direction than that of the accepting module 106, as shown in FIGS. 11A-11D, such that banknotes can be passed from the accepting module 106 to the sensing module 104 for banknote recognition, and then passed back to the accepting module 106 for further processing through the banknote recycler.

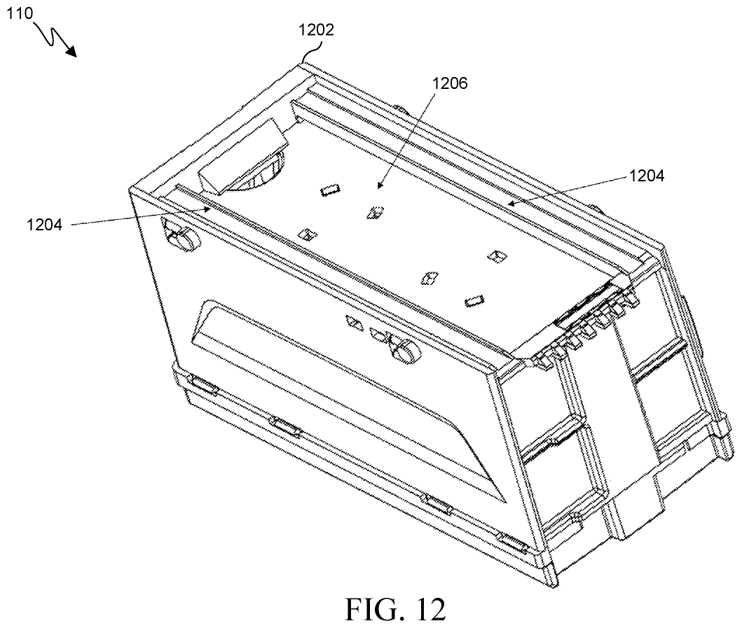

FIG. 12 illustrates a perspective view of a cashbox module 110 in accordance with various embodiments of this disclosure. Cashbox modules can come in a wide variety of configurations, and FIG. 12 does not limit the scope of this disclosure to any particular implementation of a cashbox module.

The cashbox module 110 includes a housing or body 1202 including an internal storage area for storing banknotes received into the banknote recycler via an accepting module, such as accepting module 106. In some embodiments, banknotes can be received in the cashbox module 110 by being transported by one or more belts or active rollers that interact with one or more passive rails 1204 of the cashbox. The passive rails 1204 can be disposed near a pressure plate 1206. In some embodiments, banknotes are moved into the cashbox module 110 by the belts or active rollers and dropped on the pressure plate 1206. The pressure plate 1206 can be moved down as banknotes are received on the pressure plate 1206 to allow for more banknotes to be stacked on the pressure plate 1206. As banknotes are received on the pressure plate 1206, the pressure plate 1206 moves down into the interior storage area of the body 1202 of the cashbox module 110 such that the banknotes reside within the interior storage area on the pressure plate 1206. In some embodiments, the pressure plate 1206 is coupled to springs within the interior of the cashbox module 110 that press the pressure plate 1206 towards a top of the cashbox module 110. In some embodiments, a pushing plate can be used to push the pressure plate 1206 against the springs down into the cashbox module 110.

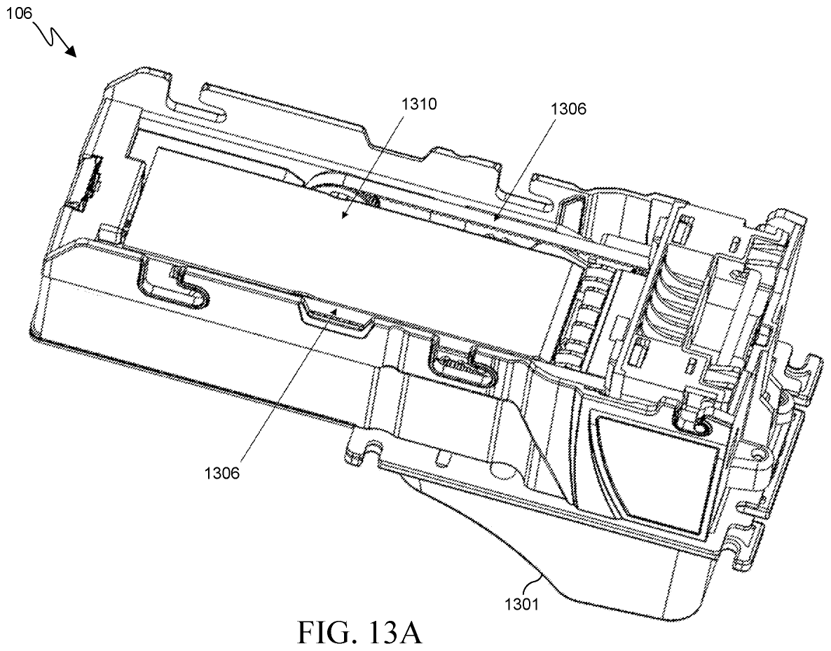

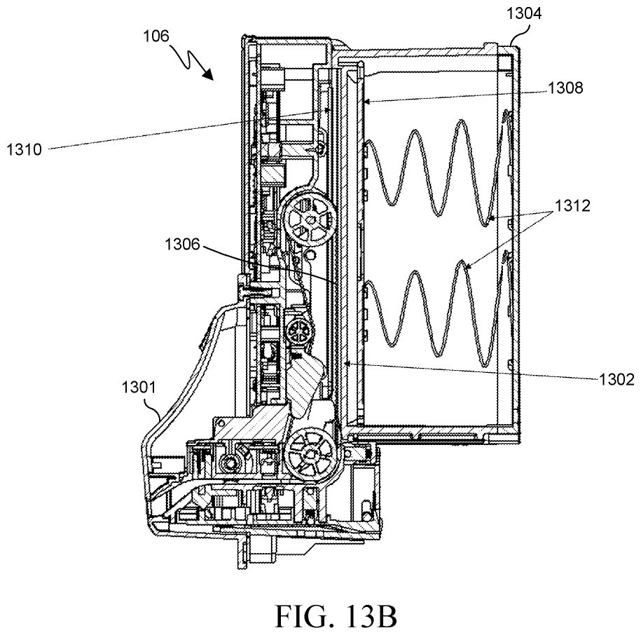

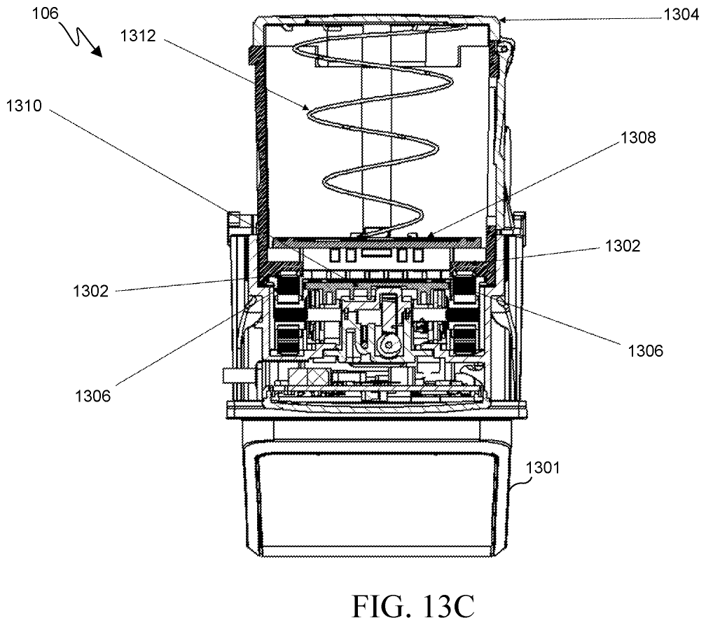

FIGS. 13A-13C illustrate various views of an accepting module 106 in accordance with various embodiments of this disclosure. FIG. 13A illustrates a perspective view of the accepting module 106. FIG. 13B illustrates a side view of the accepting module 106. FIG. 13C illustrates a top view of the accepting module 106. The accepting module 106 can come in a wide variety of configurations, and FIGS. 13A-13C do not limit the scope of this disclosure to any particular implementation of a banknote accepting module.

The accepting module 106 can, in some embodiments, be coupled to a payment bezel, such as payment bezel 102, such that banknotes received by the payment bezel are passed to an interior portion of the accepting module 106. Transport mechanisms within the accepting module such as wheels, rollers, belts, or other transport mechanisms transport the banknote through the accepting module 106 to a cashbox 1304. In some embodiments, passive rails 1302 on the cashbox 1304 interact with belts 1306 of the accepting module 106 to guide banknotes into the cashbox 1304 and onto a pressure plate 1308. The accepting module 106 can also include a pressing plate 1310 that is disposed on a first side of a banknote stack, wherein the banknote stack is positioned between the pressing plate 1310 and the pressure plate 1308 on a second side of the banknote stack.

The pressure plate 1308 can be coupled to springs 1312 operable to allow the pressing plate 1310 to press into the pressure plate 1308, causing the pressure plate 1308 to be pressed against the springs 1312 As banknotes are receiving into the accepting module 106, the belts 1306 pull the banknotes along the passive rails 1302 into position between the pressure plate 1308 and the pressing plate 1310. In some embodiments, the pressing plate 1310 can then press the banknote onto the banknote stack in the cashbox 1304 while also pressing the pressure plate 1308 further into the cashbox 1304 to so that the larger banknote stack fits within the cashbox 1304.

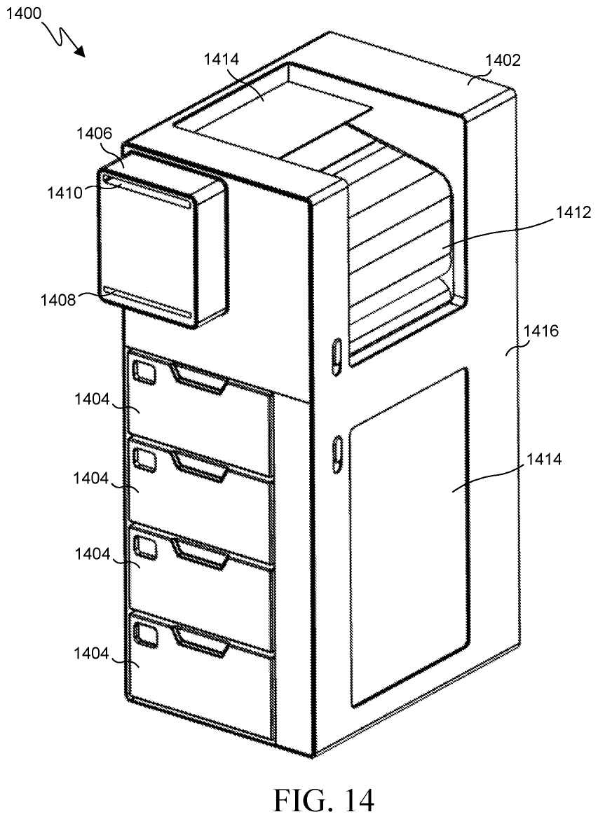

FIG. 14 illustrates a perspective view of the banknote recycler 1400 in accordance with various embodiments of this disclosure. Banknote recyclers can come in a wide variety of configurations, and FIG. 14 does not limit the scope of this disclosure to any particular implementation of a banknote recycler.

As shown in FIG. 14, the banknote recyclers of this disclosure can come in various configurations. For example, FIG. 14 shows a banknote recycler 1400 that includes a body 1402 configured to contain a plurality of modules 1404 installed in a front portion of the banknote recycler 1400 below a payment bezel 1406 and an initial banknote acceptance area. The payment bezel 1406 includes a banknote inlet 1408 configured to receive banknotes into the banknote recycler 1400, and a banknote outlet 1410 configured to dispense banknotes to a user. As banknotes are received into the payment bezel 1406, in some embodiments, the banknotes can be sensed for authenticity and recognized for data or record keeping purposes. The banknotes can then be transported to one of the modules 1404, such as banknote recycling modules or storage modules. The modules 1404 can be opened or removed from the banknotes recycler 1400 to provide access to an operator to interior portions of the modules 1404, such as when correcting a jam. In some embodiments, each one of the modules 1404 includes a handle portion that can be used by an operator to pull a module 1404 out of the banknote recycler 1400.

In some embodiments, a banknote transport path 1412 is disposed between the payment bezel 1406 and the modules 1404. The banknote recycler 1400 also includes transparent surfaces 1414 on one or more sides of the banknote recycler 1400. In some embodiments, the transparent surfaces 1414 allow a user or an operator to view a banknote as the banknote enters the banknote recycler 1400, and can view the banknotes as the banknotes travels along the banknote transport path 1412 from the payment bezel 1406 to the modules 1404. If an issue occurs such as a jam, the user or operator can see the issue through the transparent surfaces 1414, and can open a door 1416 to access the interior of the banknote recycler 1400 to correct the issue.

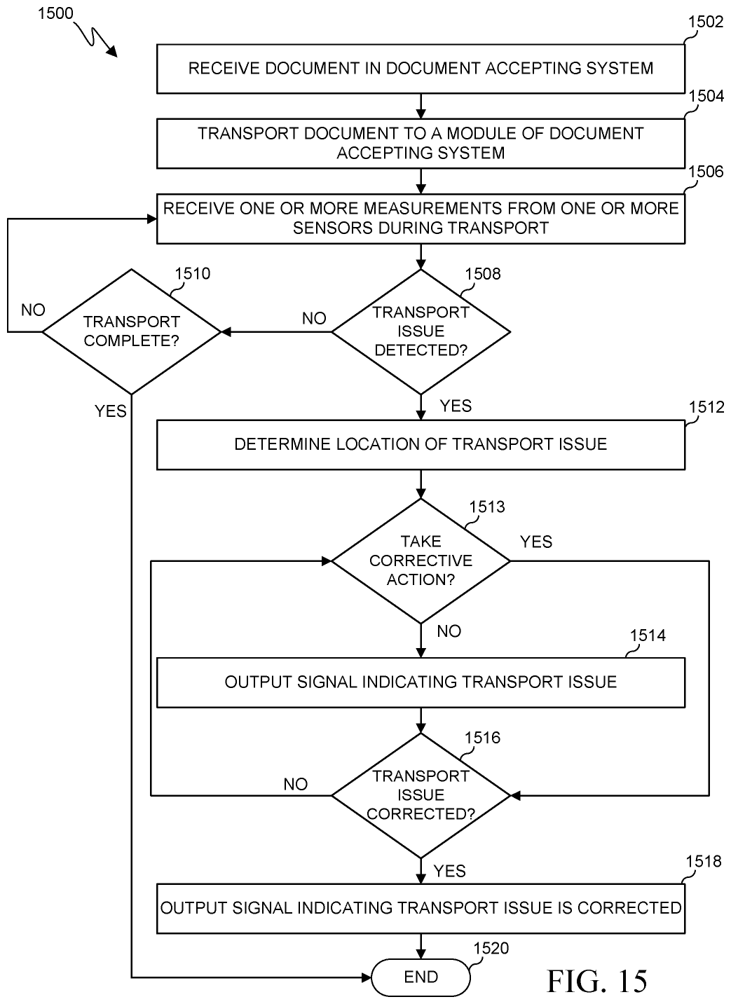

FIG. 15 illustrates an example document transport issue detection process 1500 in accordance with various embodiments of this disclosure. FIG. 15 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 1500 is described with respect to a processor and/or a document accepting or processing system, such as such as the document acceptor 1700 or the acceptor-dispenser system 1705, or the banknote recyclers 100, 200, 1600, or other apparatuses of this disclosure. However, the process 1500 can be used with any other suitable device(s) and in any suitable system.

At block 1502, a document accepting system receives a document input into the document accepting system. At block 1504, the document is transported to a module of the document accepting system, such as a sensing module, an accepting module, a recycling module, or a storage module, such as described in the various embodiments of this disclosure. At block 1506, the processor receives one or more measurements from one or more sensors during transport of the document, such as the capacitive sensor 700 or 800, and based on detected capacitance, described in the various embodiments of this disclosure. At decision block 1508, the processor determines, based on the received measurements, if a transport issue is detected, such as a document jam. If no transport issue is detected, at decision block 1510, the processor determines if transport of the document is complete, such as if the document has reached a destination such as a storage module in the document accepting system. If, at decision block 1510, the processor determines that transport is complete, the process 1500 ends at block 1520. If, at decision block 1510, the processor determines that transport is not complete, the process 1500 moves back to block 1506 so that the processor continue receiving measurements to monitor the transport of the document through the document accepting system.

If, at decision block 1508, the processor determines that a transport issue is detected based on the received measurements, the process moves to block 1512. At block 1512, the processor determines the location of the transport issue. For example, if the document accepting system includes more than one sensor, and the issue is detected at one of the sensors, the processor can determine that the sensor providing the measurements indicating the transport issue corresponds to the location of the transport issue. As described with respect to the various embodiments of this disclosure, a sensor can be disposed in an openable panel of a module of the payment accepting system, and the openable panel can be opened to inspect the inside of the module and the transport path for any issues. At decision block 1513, the processor determines if corrective action can be taken. For example, in the situation of a jam within the payment accepting system, the processor can attempt to alleviate the jam be reversing the driving members to retreat the document back a distance within the transport path, and then drive the driving members forward again to attempt to continue moving the document through the transport path past the location of the previous jam. If corrective action is taken at decision block 1513, the process 1500 then moves to decision block 1516. At decision block 1516, the processor determines if the transport issue is corrected. If not, the process 1500 loops back to decision block 1513 until the transport issue is corrected. In some embodiments, the processor can cease operations of the document accepting system until the transport issue is corrected. In some embodiments, the document accepting system can continue operating even during a transport issue, such as by continuing to operate other modules in which a transport issue is not detected.

If at decision block 1513 the processor determines not to take corrective action, or after a certain number of attempts to take corrective action have failed, the process 1500 moves to block 1514. At block 1514, the processor outputs a signal indicating the transport issue, and can also indicate the location of the transport issue. For example, in some embodiments, the signal can display a warning message on a display screen of the document accepting system, or a remote display screen communicatively connected to the document accepting system and/or the processor. In some embodiments, the signal can trigger an audible alert that a user or operator can respond to. In some embodiments, an indicator light can be activated based on the signal, such as an indicator light on a module or an openable panel of a module that corresponds to the location of the transport issue, alerting a user or operator to the location of the transport issue.

The process moves from block 1514 to decision block 1516. At block 1516, the processor determines if the transport issue is correct. If not, the process 1500 loops back to decision block 1513. In some embodiments, the process 1500 can loop back from decision block 1516 to block 1514, such as if it was previously determined at block 1513 that the payment accepting system is not to take corrective action. If, at decision block 1516, the processor determines the transport issue is corrected, the process 1500 moves to block 1518. At block 1518, the processor outputs a signal indicating the transport issue is corrected. The signal can trigger operations of some or all of the document accepting system to resume, can trigger an indicator light to deactivate or display a different color, can trigger a message to a display screen that the issue is resolved or indicating normal operation status, or can trigger other events. The process 1500 ends at block 1520.

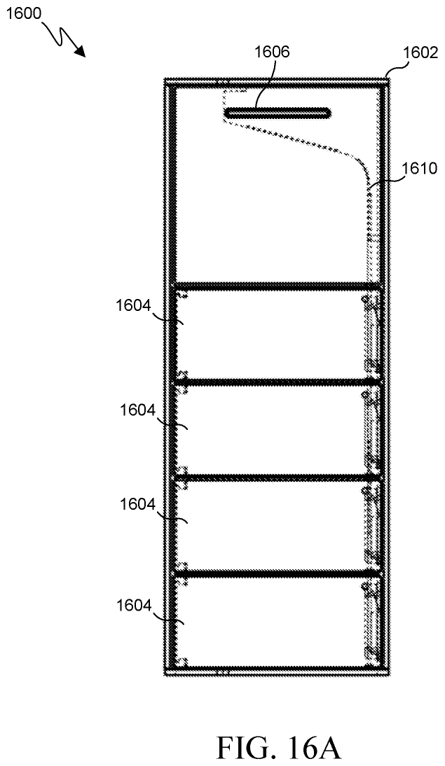

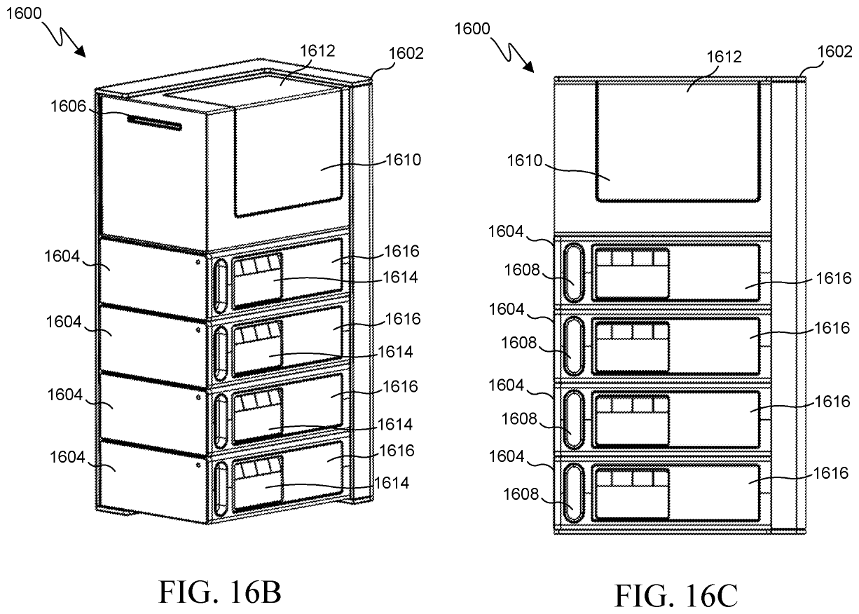

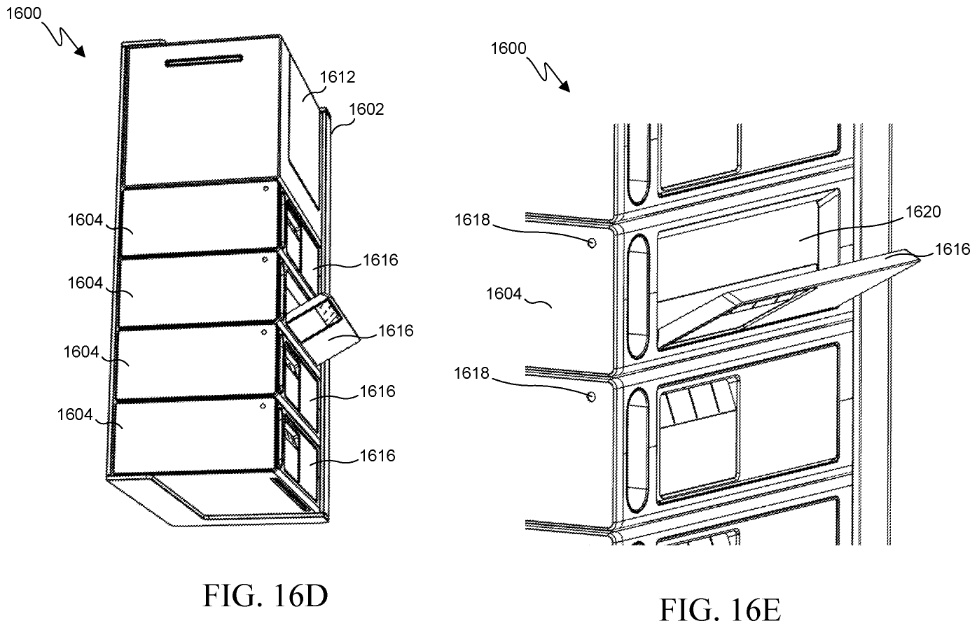

FIGS. 16A-16E illustrate various views of a banknote recycler 1600 in accordance with various embodiments of this disclosure. FIG. 16A illustrates a front view of the banknote recycler 1600. FIG. 16B illustrates a perspective view of the banknote recycler 1600. FIG. 16C illustrates a side view of the banknote recycler 1600. FIG. 16D illustrates a perspective view of the banknote recycler 1600 with a module in an open state. FIG. 16E illustrates an enlarged view of the banknote recycler 1600 with a module in an open state. Banknote recyclers can come in a wide variety of configurations, and FIGS. 16A-16E do not limit the scope of this disclosure to any particular implementation of a banknote recycler.

As shown in FIGS. 16A-16E, the banknote recyclers of this disclosure can come in various configurations. For example, FIGS. 16A-16E show a banknote recycler 1600 that includes a body 1602 configured to contain a plurality of modules 1604 installed in a side portion of the banknote recycler 1600 below an initial banknote acceptance area. The banknote recycler includes a banknote opening 1606 configured to receive banknotes into the banknote recycler 1600, and dispense banknotes to users. As banknotes are received into the opening 1606, in some embodiments, the banknotes can be sensed for authenticity and recognized for data or record keeping purposes. The banknotes can then be transported to one of the modules 1604, such as banknote recycling modules or storage modules. The modules 1604 can be opened or removed from the banknotes recycler 1600 to provide access to an operator to interior portions of the modules 1604, such as when correcting a jam. In some embodiments, each one of the modules 1604 includes a handle portion 1608 that can be used by an operator to pull a module 1604 out of the banknote recycler 1600.

In some embodiments, a banknote transport path 1610 is disposed between the payment opening 1606 and the modules 1604. Each of the modules can be connected to the path, and include internal components for transporting and storing banknotes, such as a pushing plate and pressure plate system, such as described with respect to FIGS. 13A-13C. The banknote recycler 1600 also includes transparent surfaces 1612 on one or more sides of the banknote recycler 1600. In some embodiments, the transparent surfaces 1612 allow a user or an operator to view a banknote as the banknote enters the banknote recycler 1600, and can view the banknotes as the banknotes travels along the banknote transport path 1610 from the opening 1606 to the modules 1604. If an issue occurs such as a jam, the user or operator can see the issue through the transparent surfaces 1612, and can open a door to access the interior of the banknote recycler 1600 to correct the issue. Each of the modules 1604 can also include transparent surfaces 1614 disposed on a side of the each module 1604, such as near the handle portion 1608, that allows an operator to view inside each module 1604 to visually detect issues such as jams within each module 1604. Each module 1604 also includes a door 1616 that can be opened to access an interior of each module 1604 to correct issues such as jams.

As shown in FIGS. 16A-16E, in some embodiments, modules such as storage modules can include indicator lights 1618 to indicate an issue, such as a jam, in one of the modules 1604. For example, as shown in FIG. 16E, an indicator light 1618 disposed on a front surface of the modules 1604 can display a color, such as red, when an issue such as a jam is detected in the module. In this way, when an indicator light 1618 on one of the modules 1604 is red, an issue would be indicated to the user or operator, and the user or operator could then visually inspect the module via the transparent surface 1614 to see a banknote 1620 jammed within the module 1604, and then open the openable panel or door 1616 on the module 1604 to fix the issue within the module 1604.

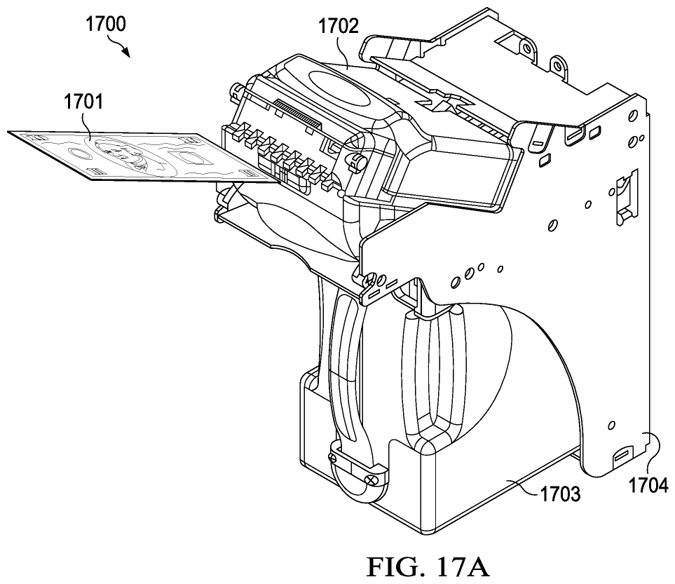

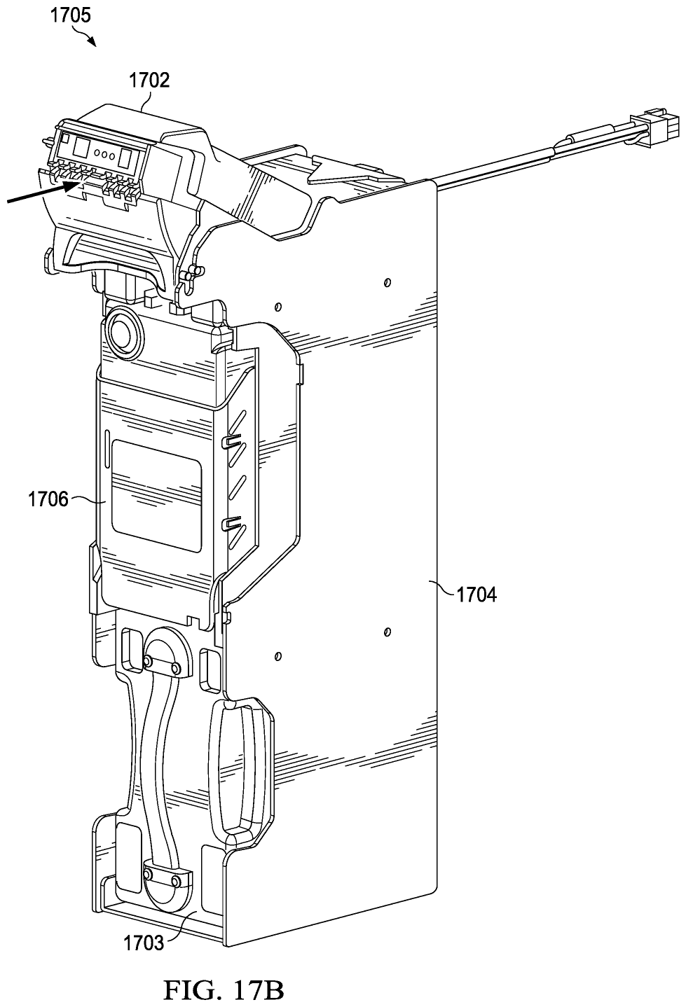

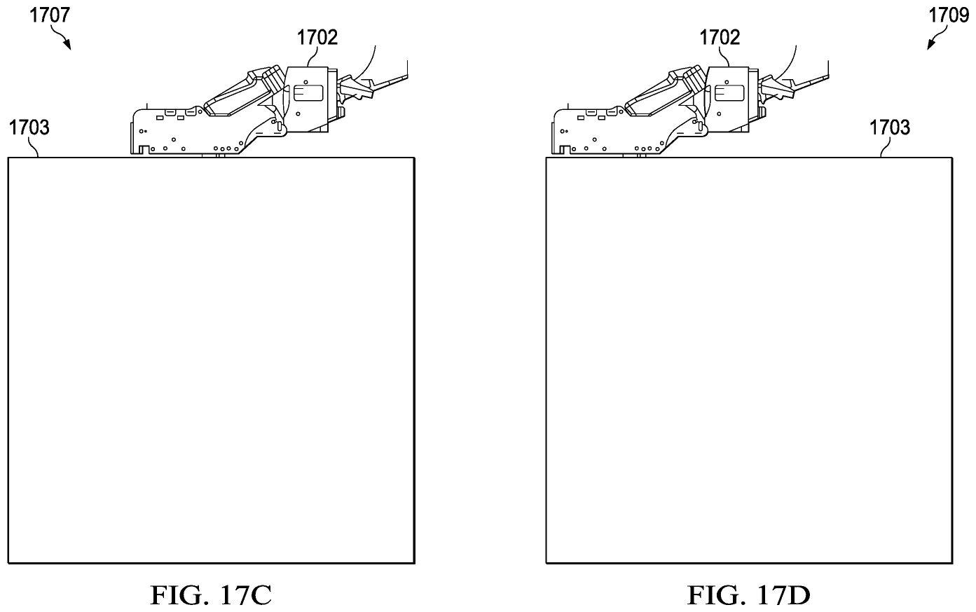

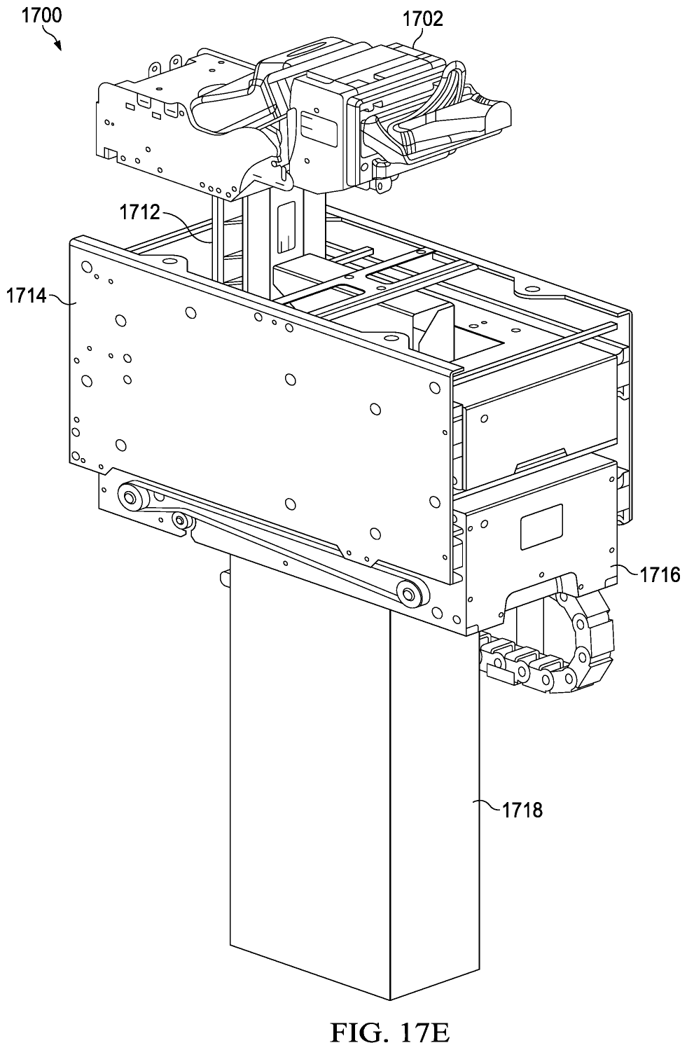

FIGS. 17A-17E illustrate schematic views of document acceptor systems according to various embodiments of this disclosure.

FIG. 17A shows a document acceptor 1700 configured to verify the authenticity of an inserted document. Document acceptors come in a wide variety of configurations, and FIG. 17A does not limit the scope of this disclosure to any particular implementation of a document acceptor. The document acceptor 1700 includes a banknote validator or acceptor head 1702, an internal document transport system, a removable document storage unit 1703, and a chassis 1704. Inserted documents 1701 are authenticated in acceptor head 1702 head using various sensors. Once the document 1701 is deemed authentic and deemed acceptable the document is transported further into the document acceptor 1700 using the document transport system into the removable document storage unit 1703. In some embodiments, the acceptor head 1702 is removably coupled to the chassis 1704. In one or more embodiments, the removable document storage unit 1703 can be a note stack recycler. In some implementations, removable document storage unit 1703 includes a transportation device for document 1701 to and/or from the removable document storage unit 1703. In some embodiments, the document acceptor 1700 may not include a stacker.

Acceptor head 1702 includes a number of features to accommodate the systems disclosed herein. A front of the acceptor head 1702 can have positioned thereon a bezel connector, a PCB mounted switch and LEDs, a mini USB connector which creates more space for an internal edge sensor and a multimedia interface (MMI). The acceptor head 1702 can also include a cover with a latch positioned on a top portion of the acceptor head 1702 to cover one or more detection surfaces.

Although FIGS. 17A illustrates one example of a document acceptor 1700, various changes may be made to FIG. 17A. For example, the document acceptor 1700 could be used in automatic ticket seller machines, automated payment systems, customer assist payment systems, automatic teller machines, vending machines and other kiosks. Also, there could be more than one removable document storage box 1703 as well as a temporary storage unit, such as a note recycler. In some embodiments, the document acceptor 1700 can include removable modules in addition to or replacing the acceptor head 1702 and/or the removable document storage unit 1703, such as a removable sensing module, accepting module, recycling module, or cashbox module such as described with respect to FIGS. 1A-16E herein.

FIG. 17B illustrates a document acceptor-dispenser system 1705 according to various embodiments of this disclosure. Acceptor-dispenser systems can come in a wide variety of configurations, and FIG. 17B does not limit the scope of this disclosure to any particular implementation of an acceptor-dispenser system. In addition to an acceptor head 1702, a chassis 1704, a document transport system, and a removable document storage box 1703 as shown with respect to the document acceptor 1700 of FIG. 17A, the document acceptor-dispenser system 1705 illustrated in FIG. 17B comprises an acceptor-dispenser module 1706 that allows the document acceptor-dispenser system 1705 to provide documents back to the customer. An example could be, in an automated payment system where a customer presents a high denomination banknote to purchase goods or services that are valued more than the value of purchased goods or services, and the unit provides lower denomination banknotes to provide change to the customer to assist in completing the transaction, the acceptor-dispenser module 1706 may act as an escrow unit that holds accepted document until the transaction is completed.

Although FIG. 17B illustrates one example of an acceptor-dispenser system 1705, various changes may be made to FIG. 17B. For example, the acceptor-dispenser system 1705 could be used in automatic ticket seller machines, automatic teller machines, vending machines and other kiosks. Also, there could be more than one removable storage unit 1703. In some embodiments, the acceptor-dispenser system 1705 can include removable modules in addition to or replacing the acceptor head 1702 and/or the removable document storage unit 1703, such as a removable sensing module, accepting module, recycling module, or cashbox module such as described with respect to FIGS. 1A-16E herein.

FIGS. 17C and 17D illustrate embodiments of lock-safe system 1707 and 1709, respectively, according to various embodiments of this disclosure. The document acceptors illustrated in FIGS. 17A and 1B could be installed in a lock-safe application where the removable cash storage unit 1703 is concealed into a safe. For example, FIGS. 17C and 17D illustrate the various positions of a acceptor head 1702 in various lock-safe environments coupled to a safe 1710. FIG. 17E further illustrates a currency handling apparatus 1711 including a document acceptor unit 1702 coupled to a document transport system 1712 that transports documents to a lock-safe unit 1714. The lock-safe unit 1714 can include a removable storage module 1716, and can also include a bag 1718, or other storage object, coupled to the removable storage module for storing documents within the bag 1718.

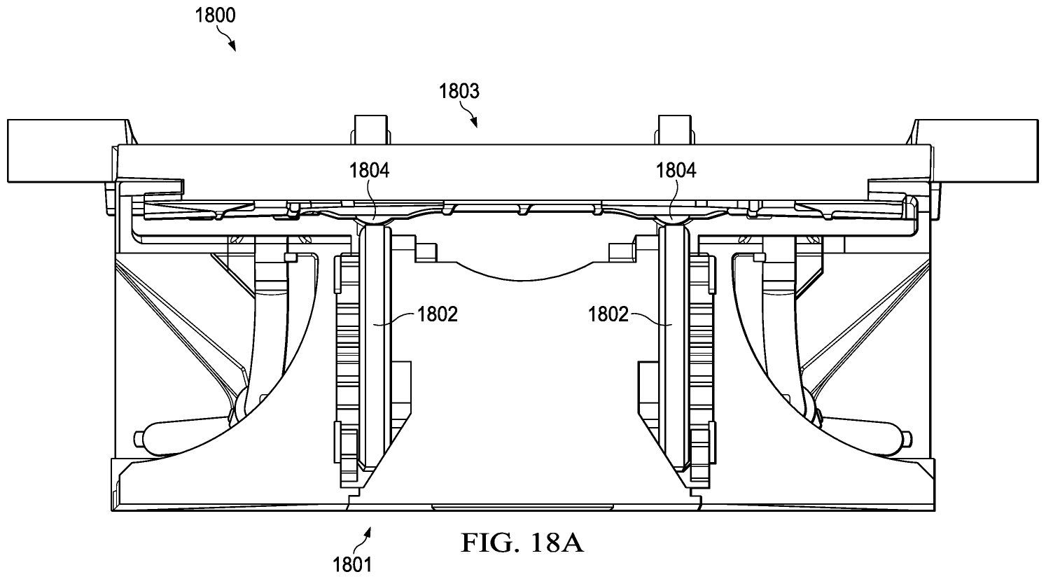

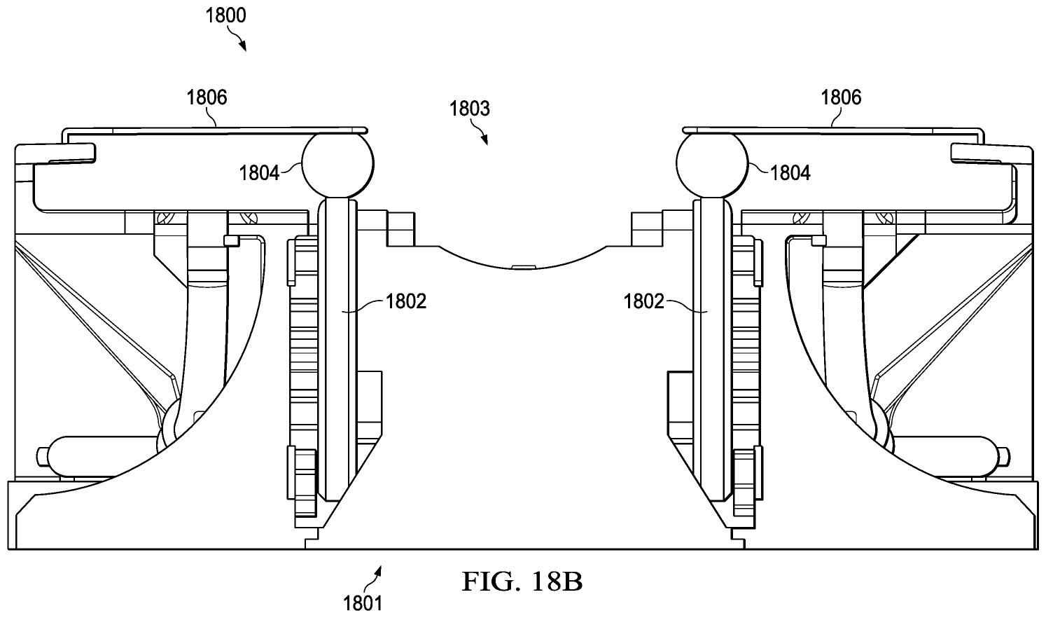

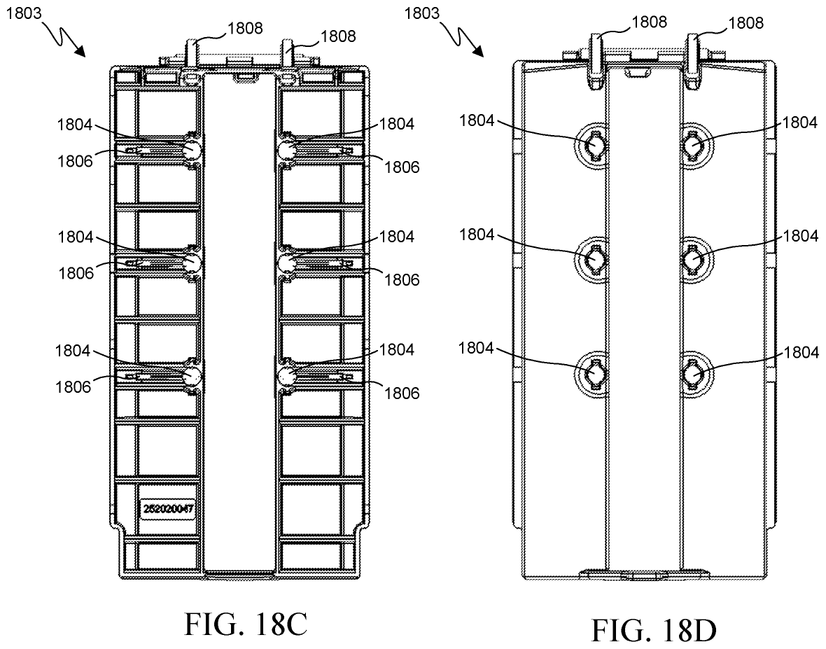

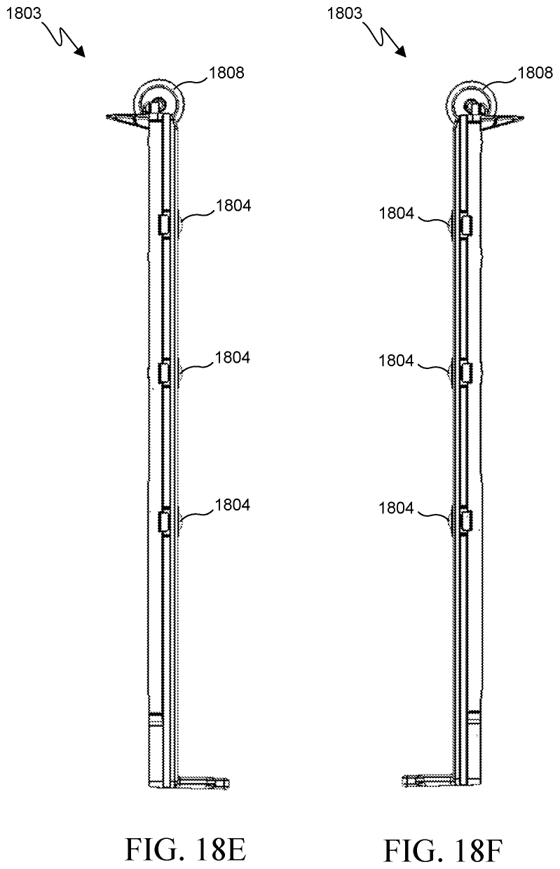

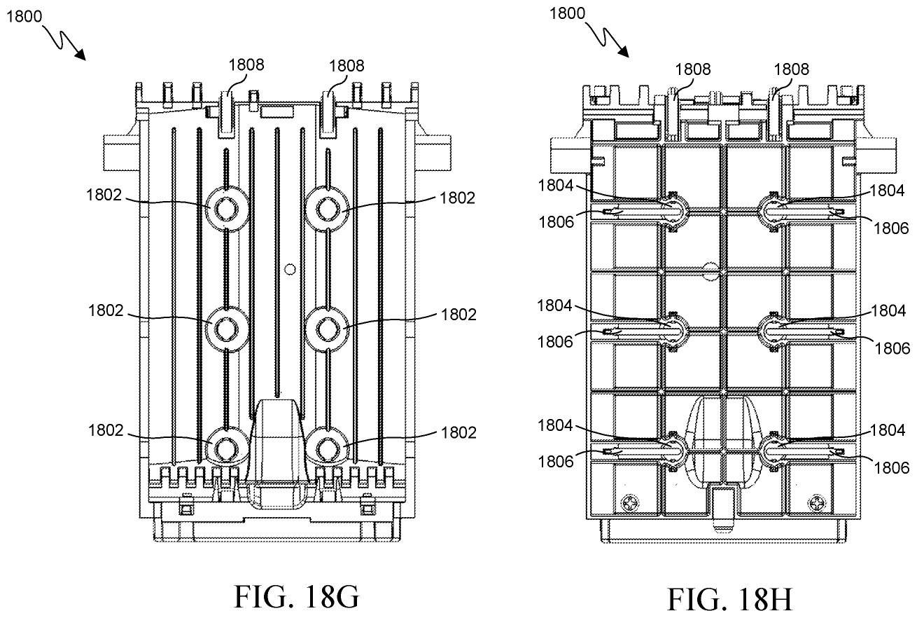

FIGS. 18A-18J illustrate schematic views of the document transport system 1800 in accordance with various embodiments of this disclosure. The document transport system 1800 can be used in a document acceptor units, such as the document acceptor 1700 or the acceptor-dispenser system 1705, or the banknote recyclers 100, 200, 1600, or other apparatuses of this disclosure. FIGS. 18A and 18B illustrate cross-section views of the document transport system 1800. FIGS. 18A and 18B illustrate a driving side frame 1801 of the document transport system 1800 and a driven side frame 1803 of the document transport system. During transport, a document is held between pinch points or pinch surfaces created between driving members, such as driving rollers or belts 1802, and driven rollers or belts 1804. The held document is then pushed forward or backward through a banknote transport path depending upon rotation or movement of driving rollers or belts 1802.

FIG. 18C illustrates a back view of a drive or passive side frame 1803 of the document transport system 1800, FIG. 18D illustrates a front view of the passive side frame 1803 of the document transport system 1800, FIG. 18E illustrates a side view of the passive side frame 1803 of the document transport system 1800, and FIG. 18F illustrates another side view of the passive side frame 1803 of the document transport system 1800. FIGS. 18C-F show driven or idle rollers 1804 held in place inside the passive side frame 1803 of the document transport system 1800 using elastic members or springs 1806 to keep the idle rollers 1804 in place and in constant pressure against the driving rollers or belts 1802. The idle rollers can assist in maintaining pressure on the document as it travels through the document transport system 1800. The passive side frame 1803 of the document transport system 1800 can also include initial transport rollers 1808 that receive a banknote provided into the banknote transport path created between the active side frame 1801 and the passive side frame 1803 of the document transport system 1800. In some embodiments, there can be both active and passive initial transport rollers 1808.

FIG. 18G illustrates a back view of the document transport system 1800 showing the position of the active rollers 1802 opposite the passive rollers 1804. FIG. 18H illustrates a front view of the document transport system 1800 showing the position of the passive rollers 1804 and springs 1806 opposite the active rollers 1802. FIG. 18I illustrates a cross-section view of the document transport system 1800 showing an example pinch point between opposite active rollers 1802 and passive rollers 1804. FIG. 18J illustrates a cross-section view of the document transport system 1800 showing an example pinch points between opposite active rollers 1802 and passive rollers 1804. It will be understood that the document transport system 1800 can be any length and include any number of active rollers 1802 or passive rollers 1804. The document transport system 1800 can also include turns or other angles in the document path to transport documents to various locations within an apparatus.

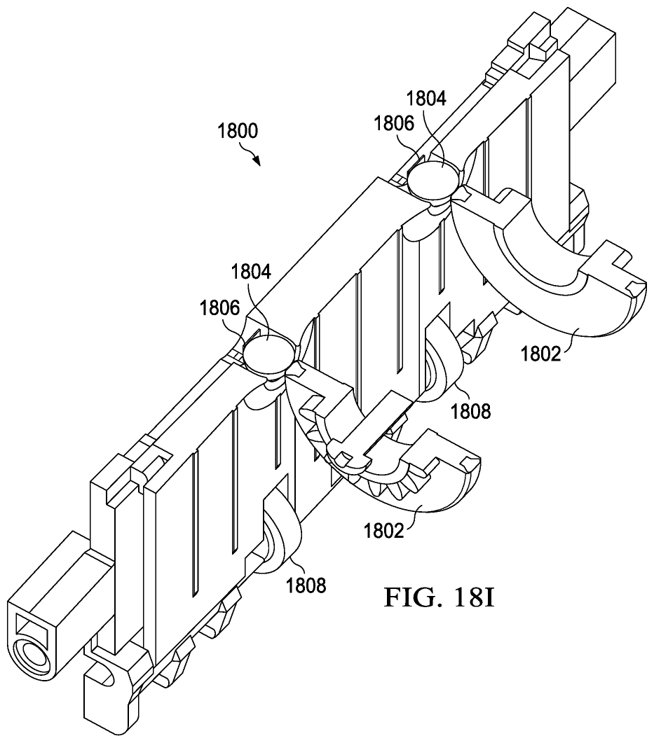

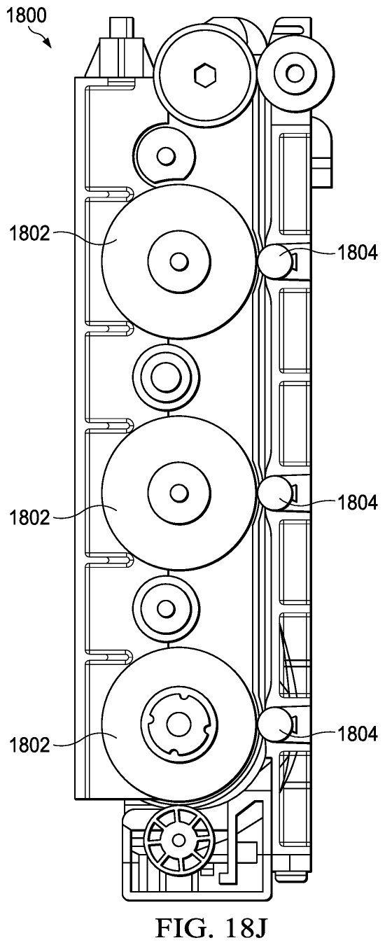

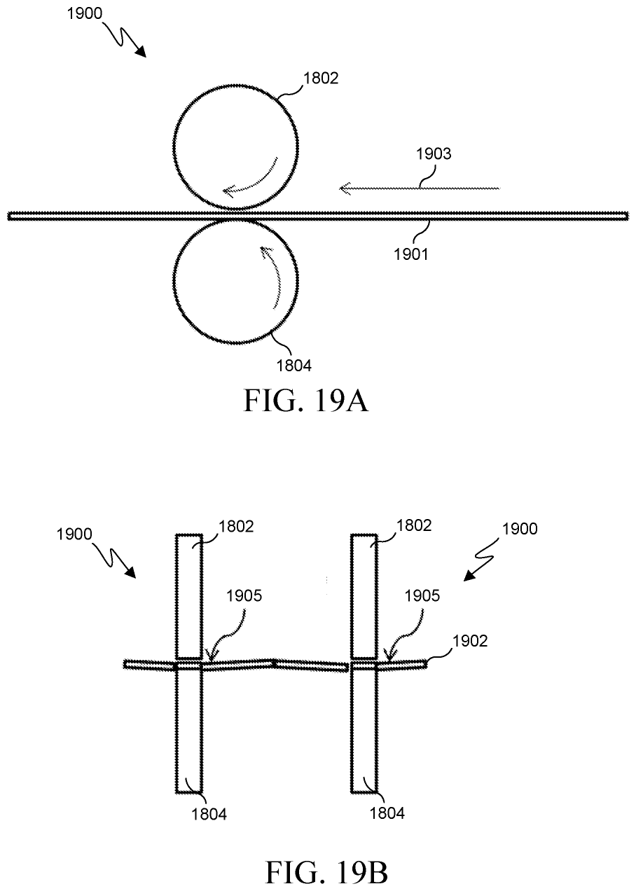

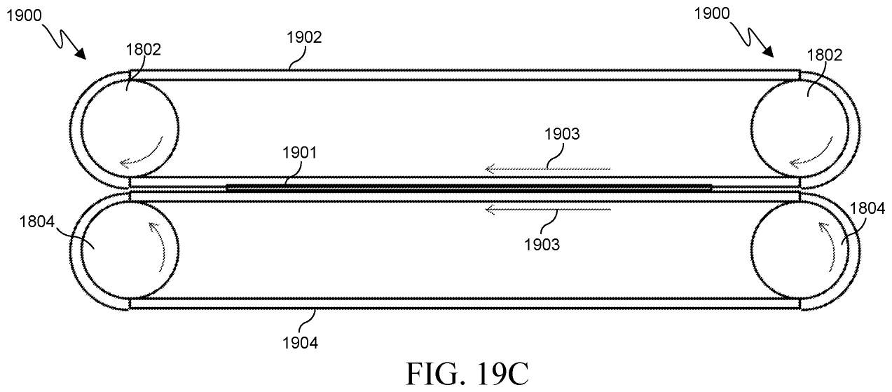

FIGS. 19A-19C illustrate various views of pinch points 1900 in accordance with various embodiments of this disclosure. The pinch points 1900 can be between active rollers 1802 and passive rollers 1804, such as active rollers 1802 and passive rollers 1804 included in the document transport system 1800 of FIGS. 18A-18J. FIG. 19A illustrates a side view of a pinch point 1900. An active roller 1802 and a passive roller 1804 are disposed opposite each other and receive a document 1901 as the document 1901 travels in a transport direction 1903. When the document 1901 comes into contact with the active roller 1802 and the passive roller 1804 at the pinch point 1900, the document 1901 is pulled further in the transport direction 1903 by the rotation of the active roller 1802 and the passive roller 1804. Generally, in absence of a document, the active and passive rollers or belts contact each other. The active roller 1802 can be driven and rotated by a motor or other driving apparatus, while the passive roller 1804 rotates due to the driving of the active roller 1802 and/or the movement of the document 1901 through the pinch point 1900.

FIG. 19B illustrates a front view of the pinch point 1900. As the document 1901 is pressed between the active roller 1802 and the passive roll 1804, deformations 1905 can form in the document 1901. A document pinched between active rollers 1802 and passive rollers 1804 is deformed due to pressure exerted by two rollers and is then pushed in the desired direction, such as the transport direction 1903, by controlling the movement of driving rollers 1802. FIG. 19C illustrates a side view of pinch points 1900 in an embodiment in which a document transport system, such as document transport system 1800, includes at least one active belt 1902 and at least one passive belt 1904. In some embodiments in which belts are not used, the document 1901 can be passed between pinch points of the active rollers 1802 and the passive rollers 1804. In some embodiments such as illustrated in FIG. 19C, an active belt 1902 wrapped around two or more active rollers 1802 and a passive belt 1904 wrapped around two or more passive rollers 1804 can be used to press the document 1901 between the active belt 1902 and the passive belt 1904 even when the document 1901 is between pinch points 1900. For example, as shown in FIG. 19C, if a document 1901 is shorter than a distance between a first pinch point and a second pinch point, the active belt 1902 and the passive belt 1904 maintain contact with the document 1901 to transfer the document between pinch points and further in the transport direction 1903. Use of belts such as active belt 1902 and passive belt 1904 allow for the transport of differently-sized documents, and/or allows for pinch points to be spaced farther apart than if no belts were used.

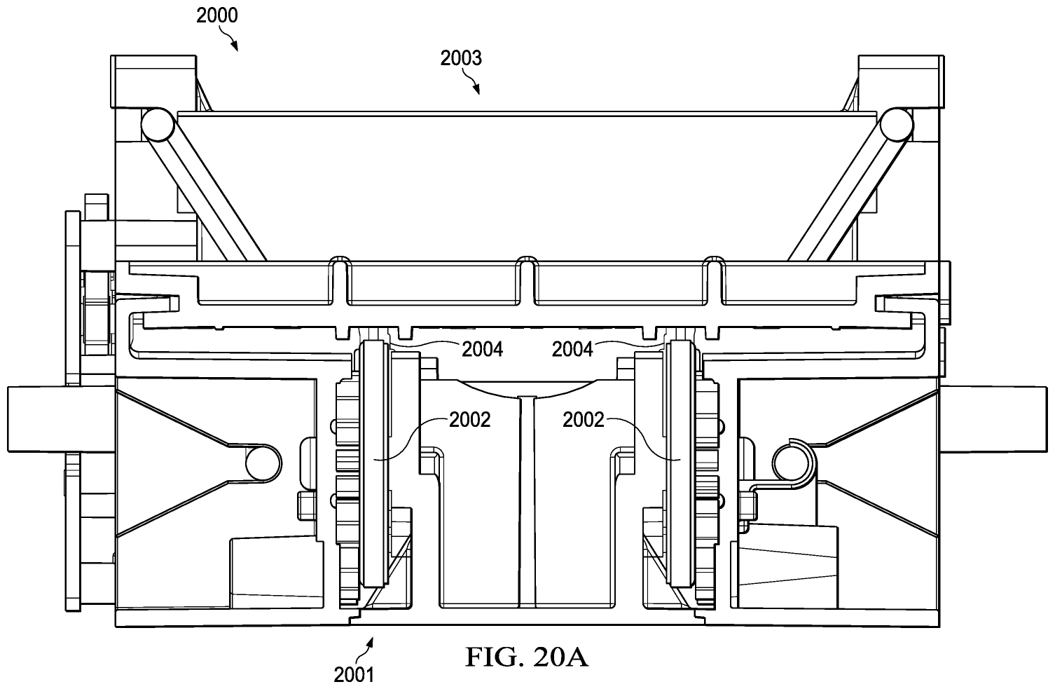

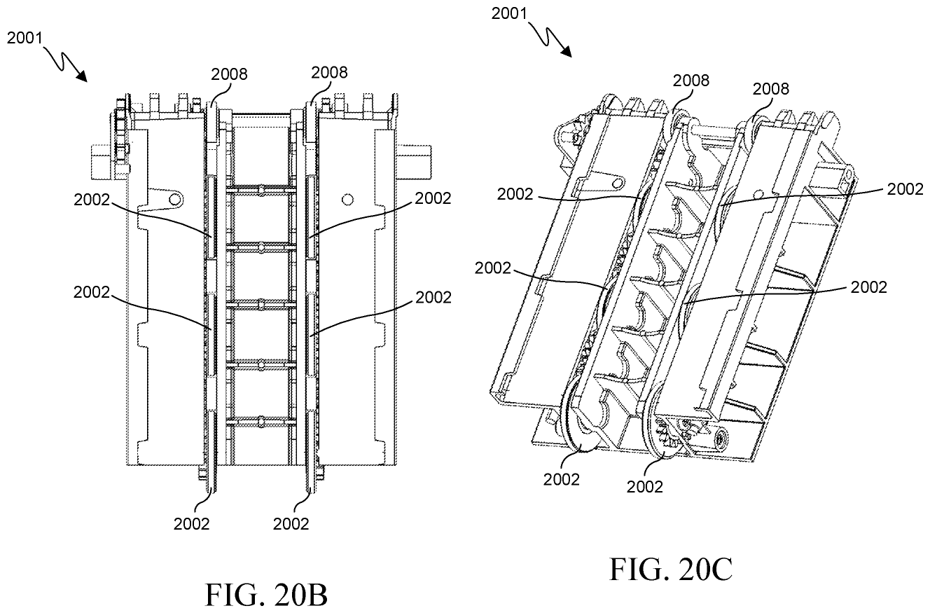

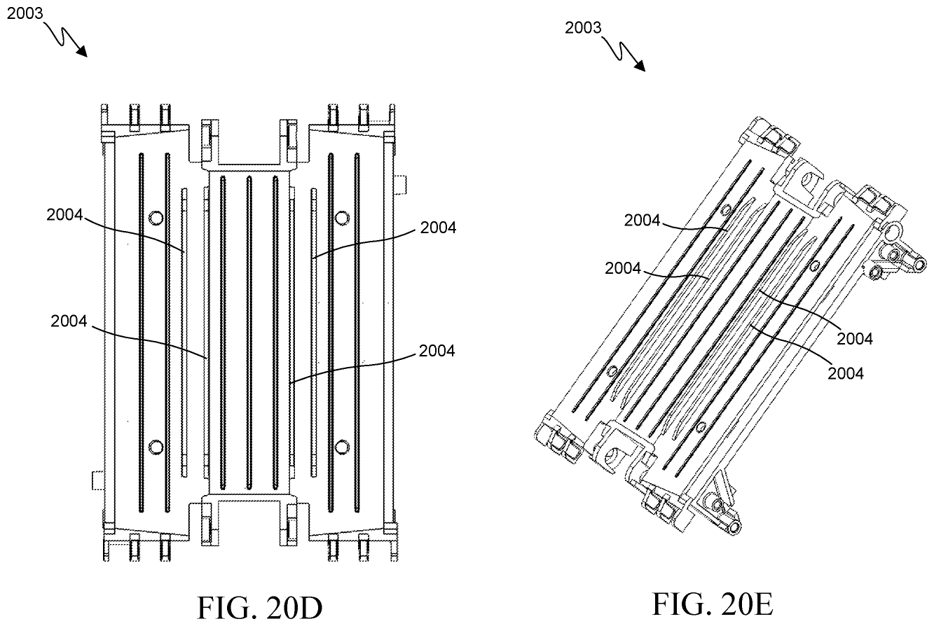

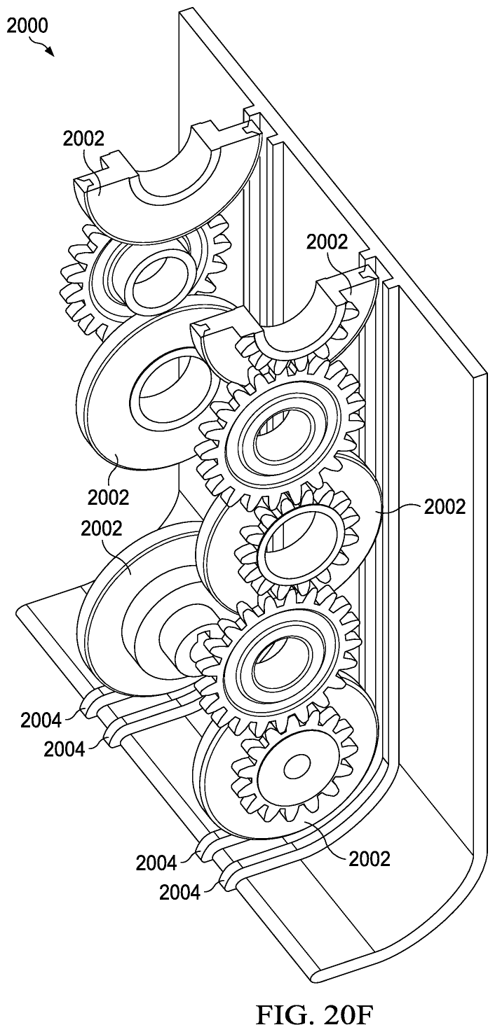

FIGS. 20A-20F illustrate various views of a document transport system 2000 according to various embodiments of this disclosure. FIG. 20A illustrates a cross-section view of the document transport system. FIG. 20A illustrates a driving or active side 2001 comprising driving belts and/or driving rollers 2002 and a driven or passive side 2003 including at least one rail or raised surface 2004. In some embodiments, a raised surface can refer to any type of raised surface, such as a roller, such as passive rollers 1804, a rail extending a distance above a surface of a document transportation path, or other raised surfaces. Documents can be held between pinch points or pinch surfaces created between driving members, such as driving rollers and/or belts 2002, and the at least one raised surface 2004. The held document is pushed forward or backward depending upon rotation or movement of the driving rollers and/or belts 2002. The document slides along the raised surfaces 2004, which can be static polished rails on the passive side 2003 of the document transport system 2000.

FIG. 20B illustrates a front view of the active side 2001 of the document transport system 2000 and FIG. 20C illustrates a perspective view of the active side 2001 of the document transport system 2000. As shown in FIGS. 20B and 20C, driving rollers 2002 are disposed on the active side 2001, which makes up one side of a document transport path. The driving rollers 2002 are disposed opposite the raised surfaces 2004 of the passive side 2003 of the document transport system 2000. FIG. 20D illustrates a front view of the passive side 2003 of the document transport system 2000 and FIG. 20E illustrates a perspective view of the passive side 2003 of the document transport system 2000. As shown in FIGS. 20D and 20E, raised surface 2004 are disposed on the passive side 2003, which makes up one side of a document transport path. The raised surfaces 2004 are disposed opposite the driving rollers 2002 of the active side 2001 of the document transport system 2000.

As shown in FIGS. 20B-20E, the document transport system 2000 does not use passive rollers or elastic members or springs, such as the passive rollers 1804 and springs 1806 illustrated with respect to FIGS. 18A-18J. Elimination of passive rollers and springs from the passive side of the document transport system 2000 reduces the complexity and number of parts of the document transport system 2000, reduces drive motor power used and/or increases speed, eliminates quality issues from pinch force variation as well and eliminates field failures due to chemical environmental incompatibility with low durometer nip roller materials. In addition, removal of springs and passive rollers reduces unit to unit variation due to spring variance and dirt accumulation on rollers.

FIG. 20F illustrates a cross-sections view of the document transport system 2000. As shown in FIG. 20F, the driving rollers 2002 create pinch points with the raised surfaces 2004 at various intervals along a document path in the document transport system 2000. The pinch points press a document as it travels through the document transport system 2000 and rotation of the driving rollers 2002 pull the document along the document path to transport the document to various locations, such as a storage module in a document recycler or storage apparatus, such as the document acceptor 1700 or the acceptor-dispenser system 1705, or the banknote recyclers 100, 200, 1600, or other apparatuses of this disclosure. It will be understood that the document transport system 2000 can be any length and include any number of active rollers 2002 or any number or length of raised surfaces 2004. The document transport system 2000 can also include turns or other angles in the document path to transport documents to various locations within an apparatus.

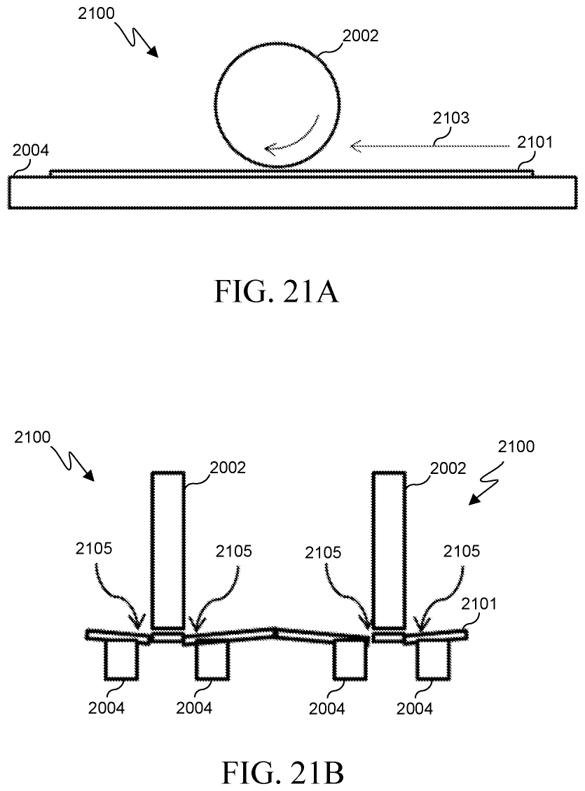

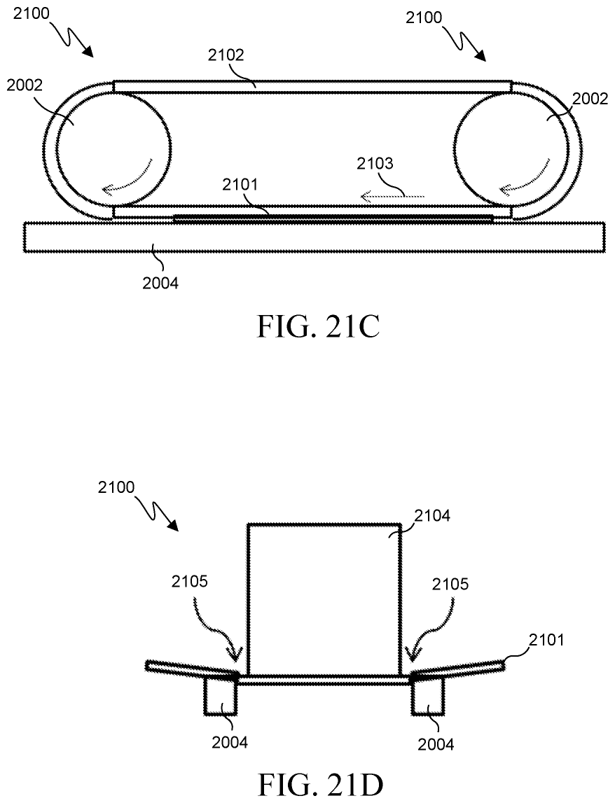

FIGS. 21A-21D illustrate various views of pinch points 2100 in accordance with various embodiments of this disclosure. The pinch points 2100 can be between driving or active rollers 2002 raised surfaces 2004, such as the active rollers 2002 and raised surfaces 2004 included in the document transport system 2000 of FIGS. 20A-20F. FIG. 21A illustrates a side view of a pinch point 2100. An active roller 2002 and at least one raised surface 2004 are disposed opposite each other and receive a document 2101 as the document 2101 travels in a transport direction 2103. When the document 2101 comes into contact with the active roller 2002 and the raised surface 2004 at the pinch point 2100, the document 2101 is pulled further in the transport direction 2103 by the rotation of the active roller 2002. The active rollers 2002 can be driven and rotated by a motor or other driving apparatus.

FIG. 21B illustrates a front view of the pinch point 2100. The document 2101 is pressed between the active roller 2002 in a center portion of the document 2101 and raised surfaces 2004 at outer portions of the document 2101. This causes deformations 2105 to form in the document 2101, such that the outer portions are angled upwards while the center portion is pressed downwards by the active roller 2002 between the raised surfaces 2004. FIG. 21C illustrates a side view of pinch points 2100 in an embodiment in which a document transport system, such as document transport system 2000, includes at least one active belt 2102. FIG. 21D illustrates a front view of a pinch points 2100 in an embodiment in which a document transport system, such as document transport system 2000, includes at least one active belt 2102.

In some embodiments in which belts are not used, the document 2101 can be passed between pinch points of the active rollers 2002 raised surfaces 2004. In some embodiments, such as illustrated in FIG. 21C, an active belt 2102 wrapped around two or more active rollers 2002 can be used to press the document 2101 between the active belt 2102 and the raised surfaces 2004. In some embodiments, the pinch points are spaced such that the document 2101 is constantly located at a pinch point at each end of the document 2101 as the document 2101 is transported through the banknote path. In some embodiments, the pinch points can be spaced such that the document 2101 is shorter than a distance between a first pinch point and a second pinch point, with the active belt 2102 and the raised surfaces 2004 maintaining contact with the document 2101 to transfer the document between pinch points and further in the transport direction 2103. As such, in some embodiments, use of belts such as active belt 2102 allow for the transport of differently-sized documents, and/or allows for pinch points to be spaced farther apart than if no belts were used.

When a document is not present the drive rollers 2002 or belt 2102 can spin freely with no contact with a raised surface 2004. This absence of contact reduces wear and friction on driving rollers 2002 or belt 2102. The various embodiments of FIGS. 18A-21D provide a slight deformation of the document to provide a contact pressure on the driven roller or belt.

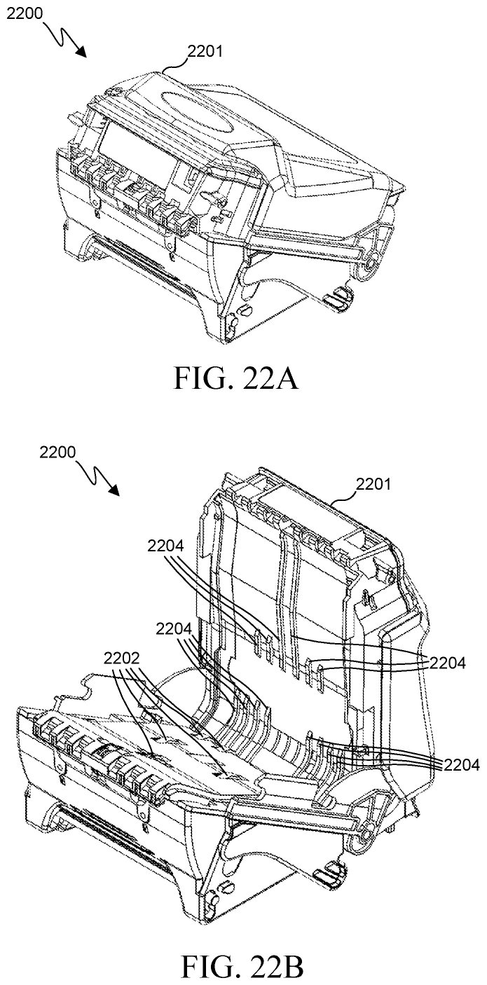

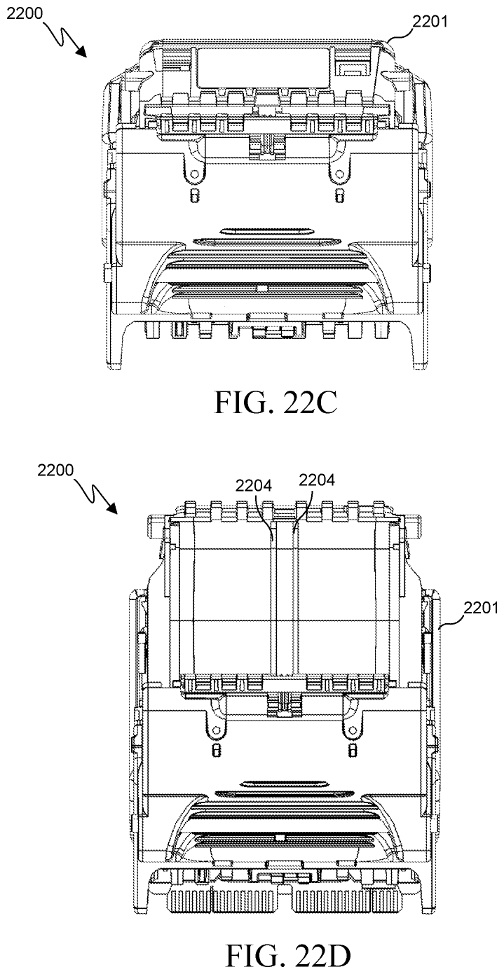

FIGS. 22A-22F illustrate views of an example document accepting apparatus 2200 in accordance with various embodiments of this disclosure. FIG. 22A illustrates a perspective view of the document accepting apparatus 2200 in a closed state. FIG. 22B illustrates a perspective view of the document accepting apparatus 2200 in an open state. FIG. 22C illustrates a front view of the document accepting apparatus 2200 in the closed state. FIG. 22D illustrates a front view of the document accepting apparatus 2200 in the open state. FIG. 22E illustrates a top view of the document accepting apparatus 2200 in the closed state. FIG. 22F illustrates a top view of the document accepting apparatus 2200 in the open state. The document accepting apparatus 2200 can be used in a document recycler or storage apparatus, such as the document acceptor 1700 or the acceptor-dispenser system 1705, or the banknote recyclers 100, 200, 1600, or other apparatuses of this disclosure. The document accepting apparatus 2200 can also include a document transport system such as the document transport system 1800 or 2000.

The document accepting apparatus 2200 includes a document acceptor head 2201. FIG. 22A shows the document acceptor head 2201 in the closed state and FIG. 22B shows the document acceptor head 2201 in the open state. As illustrated in FIG. 22B, a document transport path inside the document acceptor head 2201 can include active rollers 2202 protruding from one side, member, or component of a document transport system within the document accepting apparatus 2200. Raised surfaces 2204 can be included opposite the active rollers 2202, on the other document path member on the other side of the document transport path. In some embodiments, the document accepting apparatus 2200 can include passive rollers instead of raised surfaces. In some embodiments, belts such as active belts or passive belts can be used with active rollers or passive rollers.

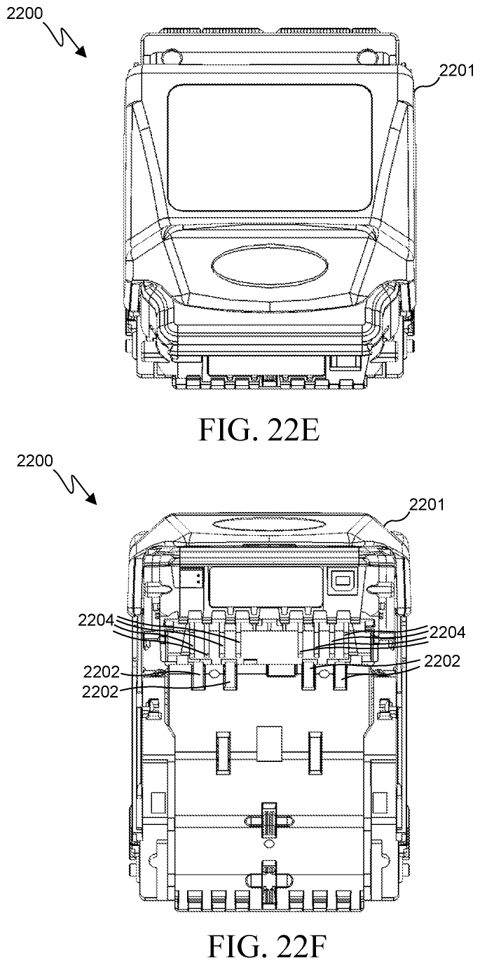

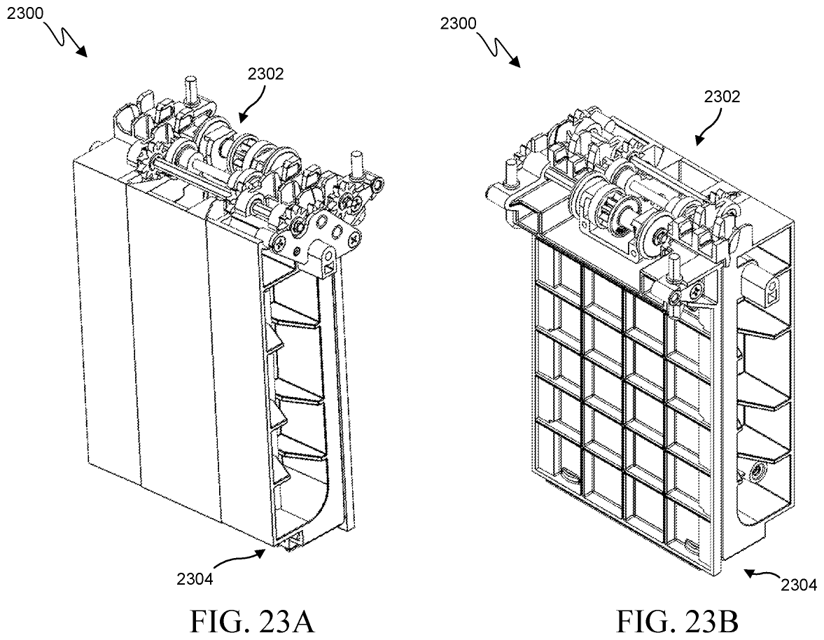

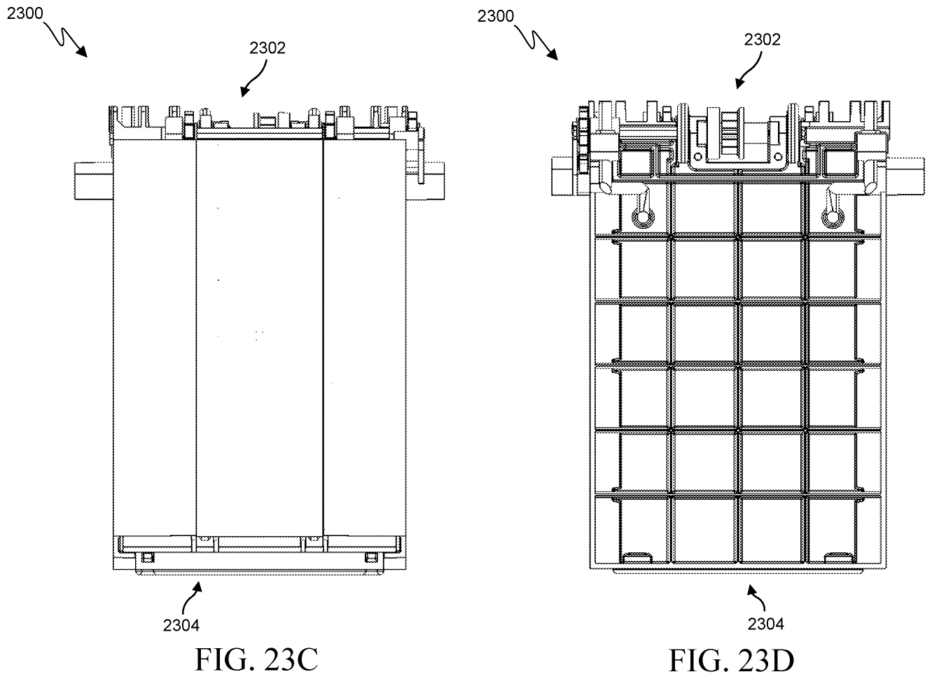

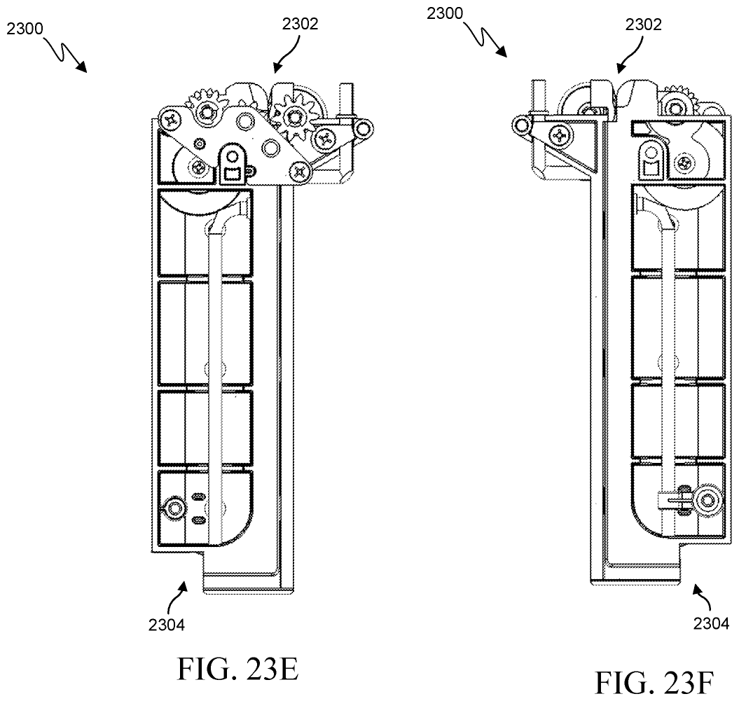

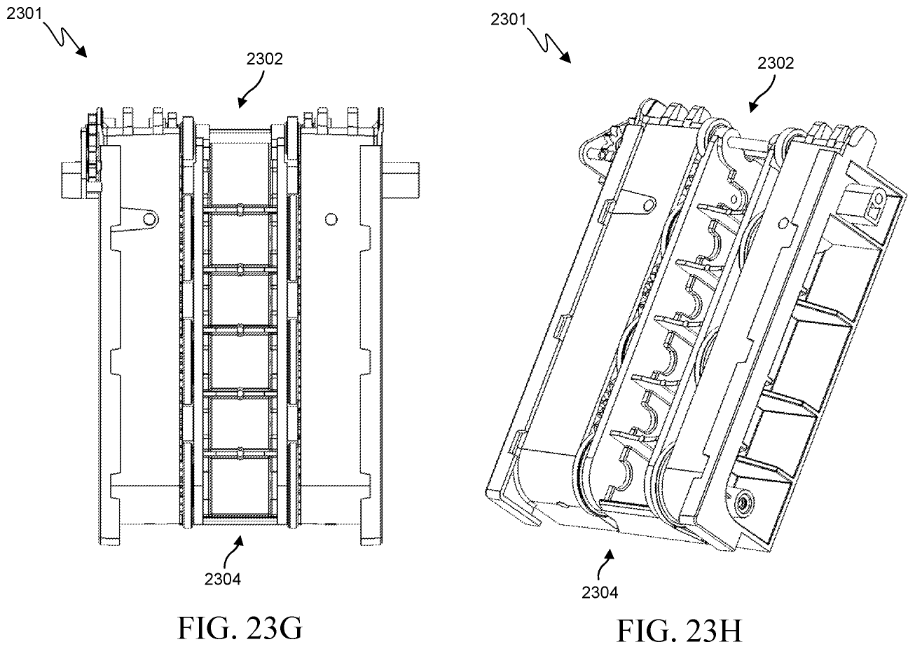

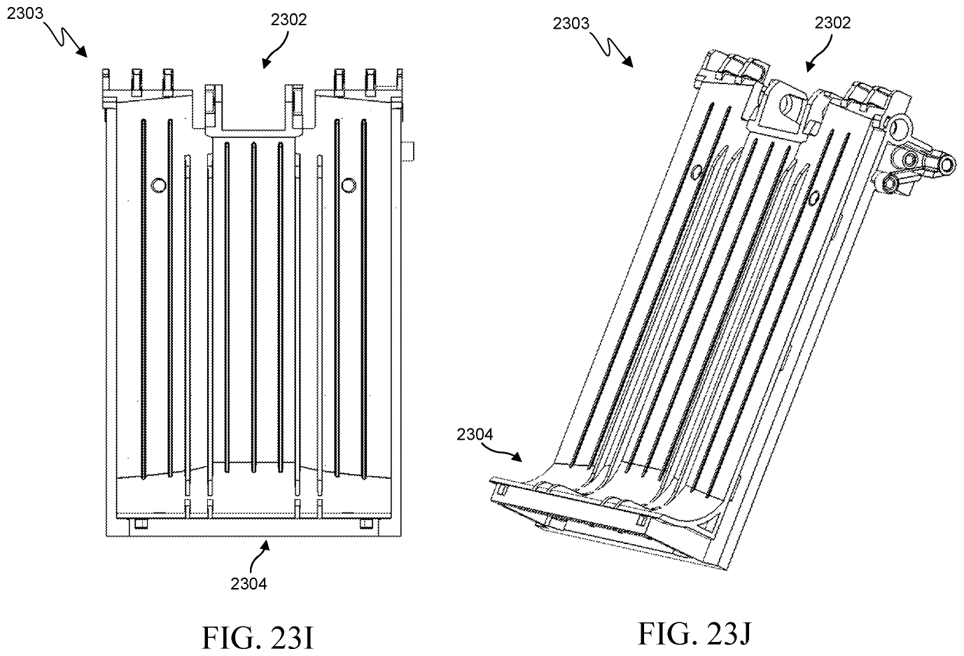

FIGS. 23A-23J illustrate various views of a document transport system turnaround module 2300 according to various embodiments of this disclosure. FIG. 23A illustrates a perspective front view of the document transport system turnaround module 2300. FIG. 23B illustrates a perspective back view of the document transport system turnaround module 2300. FIG. 23C illustrates a front view of the document transport system turnaround module 2300. FIG. 23D illustrates a front view of the document transport system turnaround module 2300. FIG. 23E and 23F illustrate side views of the document transport system turnaround module 2300. FIG. 23G illustrates a front view of a driving module 2301 of the document transport system turnaround module 2300. FIG. 23H illustrates a perspective view of the driving module 2301 of the document transport system turnaround module 2300. FIG. 23I illustrates a front view of a passive module 2303 of the document transport system turnaround module 2300. FIG. 23J illustrates a perspective view of the passive module 2303 of the document transport system turnaround module 2300. The document transport system turnaround module 2300 can be used in a document recycler or storage apparatus, such as the document acceptor 1700 or the acceptor-dispenser system 1705, or the banknote recyclers 100, 200, 1600, or other apparatuses of this disclosure. The document transport system turnaround module 2300 can also include or be included in a document transport system such as the document transport system 1800 or 2000.

As shown in FIGS. 23A-23F, the document transport system module 2300 includes a turnaround portion. Documents enter from a first end portion 2302 of the module 2300, and then after transport through the module 2300 the documents change from a vertical orientation to a horizontal orientation at a second end portion 2304. In other embodiments, the orientation of document may be changed from horizontal to vertical. The turnaround module 2300 can include rollers or belts that can be driving or active rollers or belts, such as the active or passive rollers or belts described with respect to FIGS. 18A-21D. In some embodiments, such as shown in FIGS. 23I and 23J, the module 2300 can include raised portions on which documents are pressed during transport, such as that described with respect to FIGS. 20A-21D. In such embodiments, the document is moved by driving rollers or belts pressing against a raised surface, where the raised surface acts like idler roller or belt. The document slides along the raised surface on the passive side of the transport, and the document deforms between driving rollers or belts and raised surface.

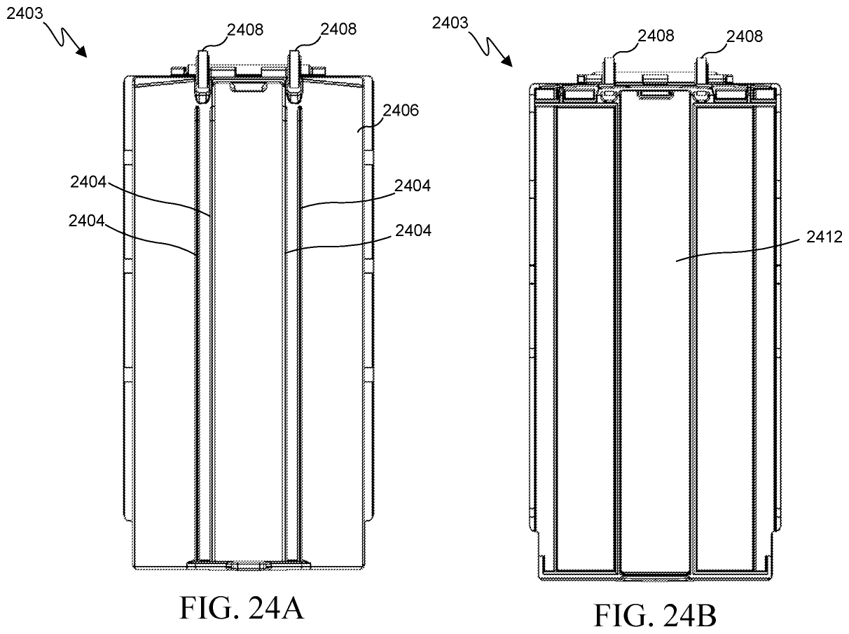

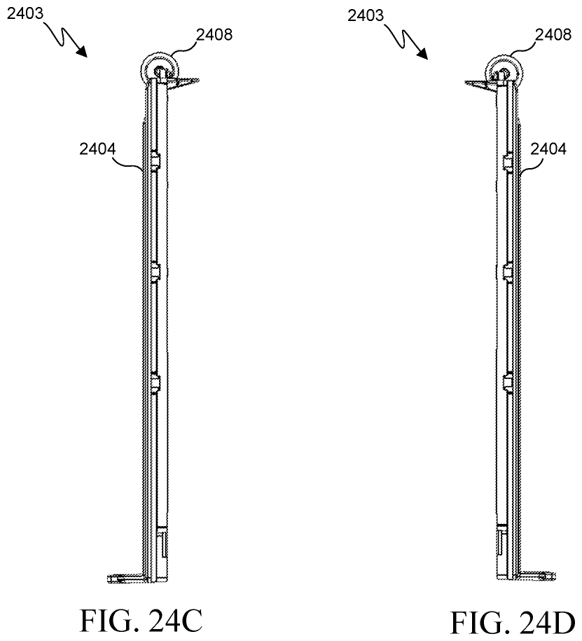

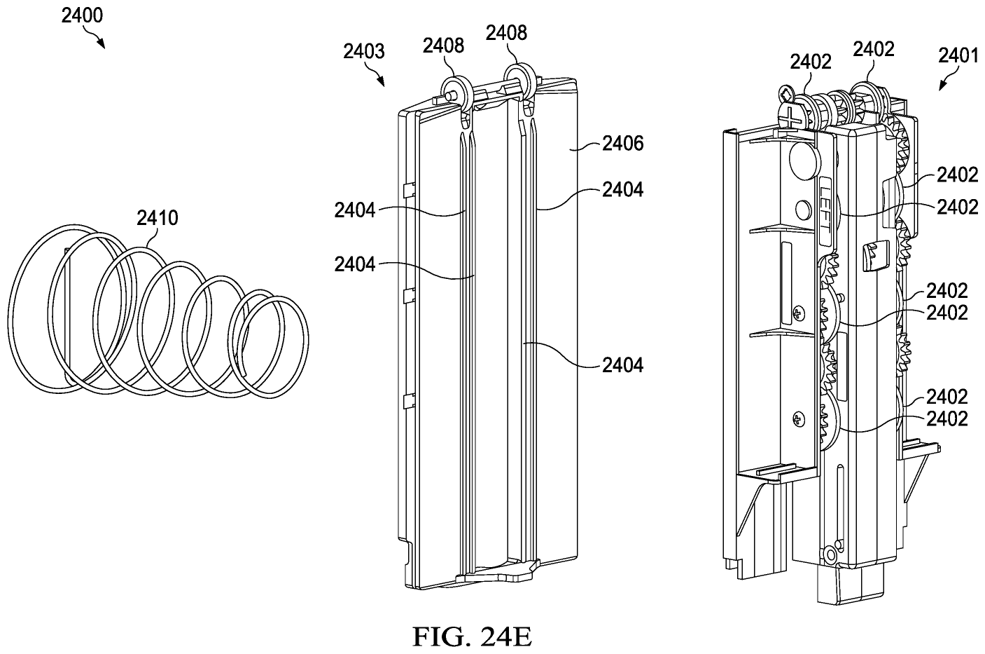

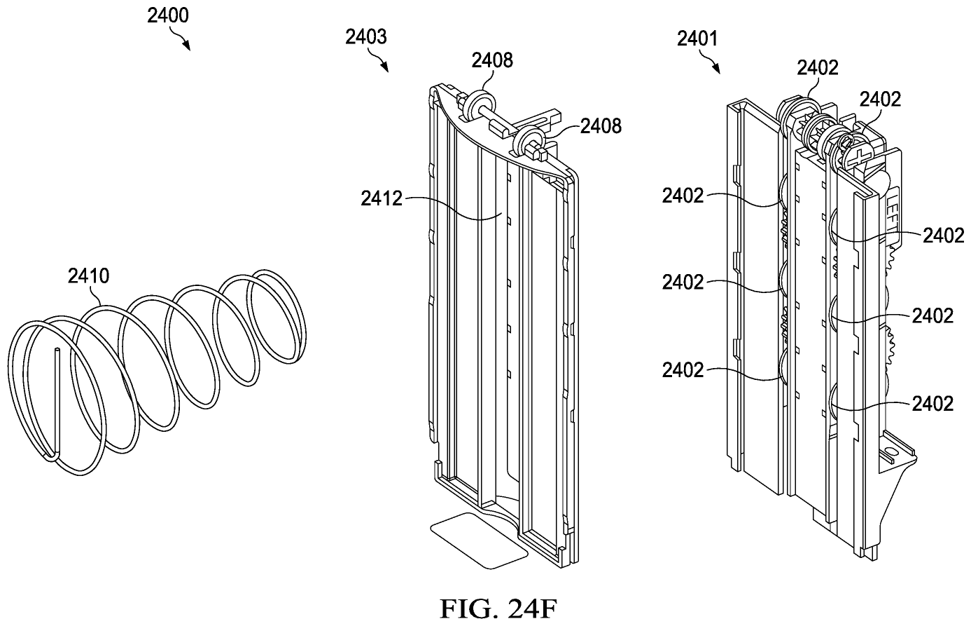

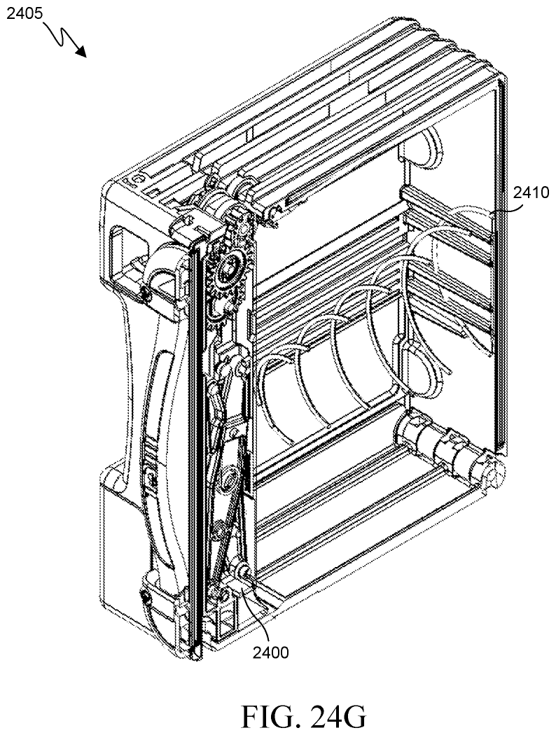

FIGS. 24A-24G illustrate various views of the document transport module 2400 including an active side 2401 and a passive side 2403 according to various embodiments of this disclosure. FIG. 24A illustrates a back view of the passive side 2403 of the document transport module 2400. FIG. 24B illustrates a front view of the passive side 2403 of the document transport module 2400. FIGS. 24C and 24D illustrate side views of the passive side 2403 of the document transport module 2400. FIGS. 24E and 24F illustrate exploded perspective views of the document transport module 2400. FIG. 24G illustrates a cross-section perspective view of a removable document storage module 2405 including the document transport module 2400. The document transport module 2400 and/or the removable document storage module 2405 can be used in a document recycler or storage apparatus, such as the document acceptor 1700 or the acceptor-dispenser system 1705, or the banknote recyclers 100, 200, 1600, or other apparatuses of this disclosure. The document transport module 2400 and/or the removable document storage module 2405 can also include other document transport systems such as the document transport system 1800 or 2000.

A back side of the passive side 2403 of the document transport module 2400 includes a surface 2406 that defines a document transport path. The surface 2406 includes raised surfaces 2404 that are used with driving rollers 2402 of the active side 2401 of the document transport module 2400 to transport documents through the document transport module 2400. The passive side 2403 can also include initial transport rollers 2408 for receiving a document into the document transport module 2400. The initial transport rollers 2408 of the passive side 2403 can also cooperate with driving rollers 2402 on the active side 2401.

As shown in FIG. 24G, the document transport module 2400 can be included within the removable document storage module 2405. The removable document storage module 2405 can be installed in a document recycler or storage apparatus, such as the document acceptor 1700 or the acceptor-dispenser system 1705, or the banknote recyclers 100, 200, 1600, or other apparatuses of this disclosure. Documents can be transferred into the removable document storage module 2405 by the document transport module 2400, and the documents can be stacked within the removable document storage module 2405. As documents are received into the removable document storage module 2405, a banknote stack can form, gradually taking up space within the removable document storage module 2405. To maintain space within the removable document storage module 2405, an elastic member 2410 such as a spring can be disposed between a back wall of the removable document storage module 2405 and an indented portion 2412 of the passive side 2403 of the document transport module 2400. As banknotes are received into the removable document storage module 2405, the elastic member 2410 is pressed toward the back wall of the removable document storage module 2405 to allow for additional room within the removable document storage module 2405 for the document stack.

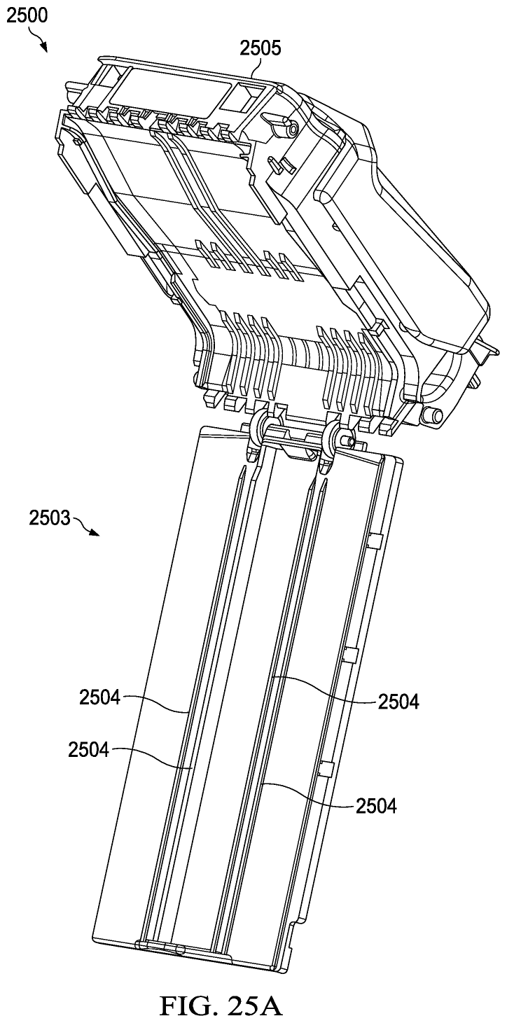

FIGS. 25A and 25B illustrate perspective views of an example document acceptor module 2500 in accordance with various embodiments of this disclosure. FIG. 25A illustrates a passive side 2503 of the document acceptor module 2500. FIG. 25B illustrates an active side 2501 of the document acceptor module 2500. The document acceptor module 2500 can be used in a document recycler or storage apparatus, such as the document acceptor 1700 or the acceptor-dispenser system 1705, or the banknote recyclers 100, 200, 1600, or other apparatuses of this disclosure.

The document acceptor module 2500 includes an acceptor head 2505 coupled to a document transport system 2507. A document entering the acceptor head 2505 may be driven inside the unit by rollers or belts where roller or belt could be a driving or active roller or belt and the document is pressed against a raised surface. The document is moved by driving rollers or belts pressing against a raised surface, where the raised surface acts like idler roller or belt. The document slides along the raised surface on the passive side of the transport, the document deforms between driving rollers or belts and raised surface. Once the document is deemed acceptable, the document is transported along the document transport path inside the document acceptor unit and may be moved from acceptor head 2505 to a transport unit. The transport unit on the passive side 2503 includes raised surfaces 2504 that cooperate with driving rollers 2502 on the active side 2501. The transport unit may further move the document to either a removable document storage unit, such as removable documents storage module 2405, or to a document turnaround unit, such as the document transport system turnaround module 2300. An elastic member 2510 can be used to press the transport unit and maintain the position of the transport unit.

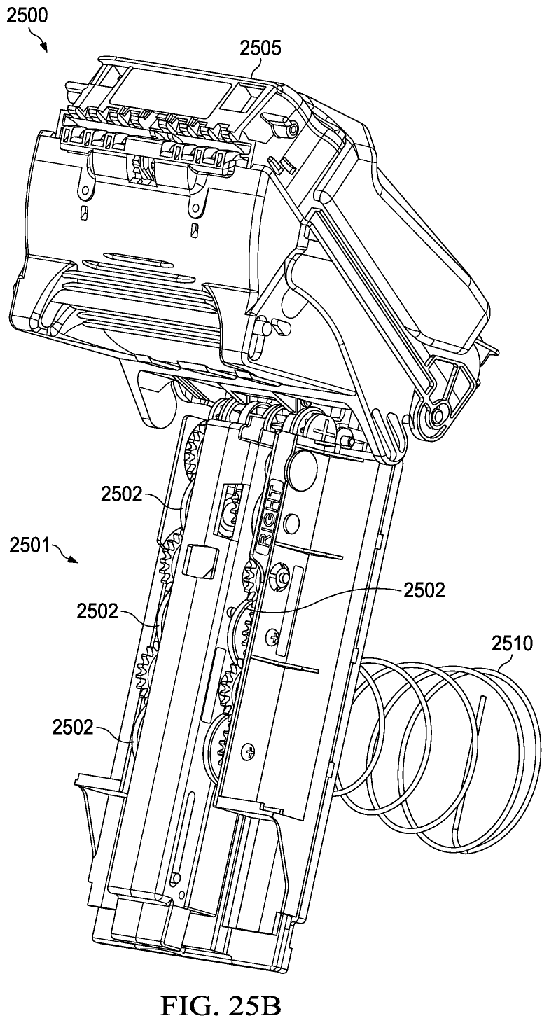

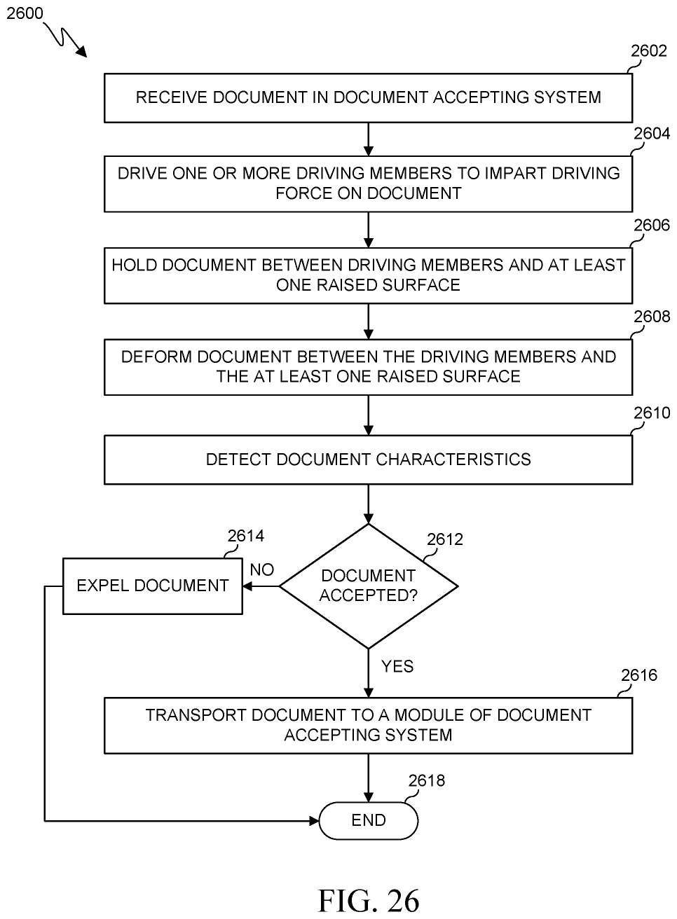

FIG. 26 illustrates an example document transport process 2600 in accordance with various embodiments of this disclosure. FIG. 26 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 2600 is described with respect to a processor and/or a document accepting or processing system, such as such as the document acceptor 1700 or the acceptor-dispenser system 1705, or the banknote recyclers 100, 200, 1600, or other apparatuses of this disclosure. However, the process 2600 can be used with any other suitable device(s) and in any suitable system.

At block 2602, a document accepting system receives a document input into the document accepting system. At block 2604, the processor drives one or more driving members to impart a driving force on the document. The driving members can be rollers, belts, or other components operable to move a document through the document accepting system, such as that described with respect to the active rollers or belts herein. At block 2606, during transport of the document, the document is held between the driving members and at least one raised surface. The at least one raised surface can be passive rollers, rails, or other raised surfaces as described herein. At block 2608, the document is deformed between the driving members and the at least one raised surface due to the pressing of the document between the driving members and at least one raised surface. At block 2610, characteristics of the document are detected, such as by a sensing module including imaging sensors, cameras, or other devices capable of detecting characteristics of the document. At decision block 2612, the processor determines if the document is acceptable, such as based on the detected document characteristics. If not, at block 2614, the document is expelled from the document accepting system, and the process 2600 ends at block 2618. If at decision block 2612, the processor determines the document is acceptable, the process 2600 moves to block 2616.

At block 2616, the document is transported through a transport path due to the driving force imparted on the document to a module of the document accepting system. For example, the document can be transported to a recycling module or a cashbox module such as those described herein. It will be understood that a similar driving force and holding of the document between the driving members and at least one raised surface may be applied at block 2616 as in blocks 2604-2608. The process ends at block 2618. At block 2614, the document to be expelled is transported through a transport path due to the driving force imparted on the document back to the user. It will be understood that a similar driving force and holding of the document between the driving members and at least one raised surface may be applied at block 2614 as in blocks 2604-2608. The process ends at block 2618.

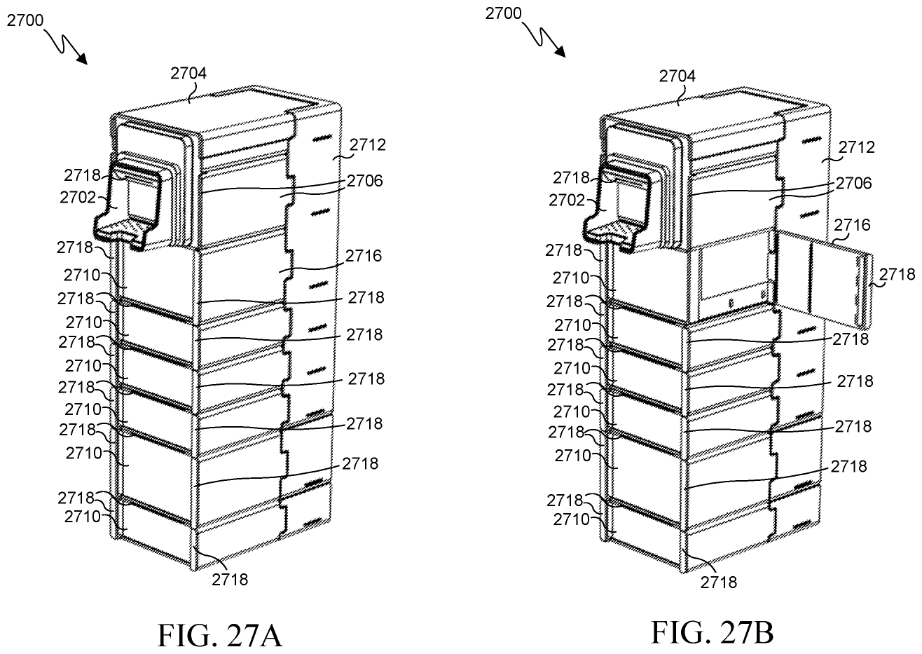

FIGS. 27A and 27B illustrate an example banknote recycler 2700 according to various embodiments of this disclosure. FIG. 27A illustrates a perspective view of the banknote recycler 2700, FIG. 27B illustrates a perspective view of the banknote recycler 2700 with a module in an open state. Banknote recyclers can come in a wide variety of configurations, and FIGS. 27A and 27B do not limit the scope of this disclosure to any particular implementation of a banknote recycler.

The banknote recycler 2700 includes a sensing module 2704, an accepting module 2706, one or more other modules 2710, such as storage modules, recycling modules, or cashbox modules, and a spine module 2712. Each of the sensing module 2704, the accepting module 2706, and the one or more other modules 2710 can be modular components of the banknote recycler 2700, such that each of these components can be removed from the banknote recycler 2700 for maintenance, jam correction, or other operations. The spine module 2712 can include components operable to support each of the sensing module 2704, the accepting module 2706, and the one or more other modules 2710. The modules can be arranged in the order from top to bottom of the sensing module 2704, the accepting module 2706, and the one or more other modules 2710, with the spine module 2712 disposed as a back portion of the banknote recycler 100.

A payment bezel 2702 can be mounted to a front portion of the banknote recycler 2700. For example, the payment bezel 2702 can be mounted in front of the sensing module 2704 and the accepting module 2706, such that banknotes introduced into the banknote recycler 2700 via the payment bezel 2702 enter the accepting module 2706. The accepting module 2706 can include internal transport components and/or driving members to transport the banknote, such as wheels or rollers, belts, or other transport components to transport the banknote through an interior of the accepting module 2706. The banknote can then be transferred via internal transport components to the sensing module 2704. Once the banknote is transferred to the sensing module 2704, imaging sensors or other components in the sensing module 2704 can view or otherwise detect banknotes traveling through the interior of the sensing module 2704.

If the banknote is accepted, the banknote can then be transported back out of the sensing module 2704 to another module of the banknote recycler 2700, such as the one or more other modules 2710. If the banknote is rejected, the sensing module 2704 can transport the banknote back to the accepting module 2706 to dispense the banknote from the payment bezel 2702. In some embodiments, the sensing module 2704 can detect banknotes as the banknotes travel through the accepting module 2706, such as if the accepting module 2706 includes an opening in a top portion of the accepting module 2706 that allows imaging sensors or other components in the sensing module 2704 to view or otherwise detect banknotes traveling through the interior of the accepting module 2706. In some embodiments, the accepting module 2706 can pass banknotes to the sensing module 2704, and the sensing module 104 can detect the banknotes and pass the banknotes back to the accepting module 2706. Based on the detected denomination of the banknote by the sensing module 2704, the banknote can be stored in an appropriate module of the banknote recycler 2700 according to the detected denomination. The banknote detection components in the sensing module 2704 can be physically or communicatively coupled to a controller or processor and memory for controlling transport of the banknote based on the detection of the banknote, and for storing banknote characteristics of the detected banknote, such as serial numbers, denomination, or other characteristics, so that the banknote recycler 2700 can track the banknote in the banknote recycler 2700 and keep an accurate accounting of the banknotes stored in the banknote recycler 2700. The sensing module 2704 could be replaced with another sensing module that can comprise a different set of sensors to accommodate different sets of security feature requirements. In addition, the sensing module 2704 can also be removed for maintenance and replaced with another sensing module 2704.

The banknote recycler 2700 also includes a plurality of light indicators 2718 at various locations on the banknote recycler 2700. For example, light indicators 2718 can be disposed on openable side panels 2716 of each of the modules. If an issue is detected at one of the modules, a light indicator 2718 can light up to indicate that the jam is within the openable side panel 2716, allowing an operator to open that side panel displaying the light indicator, and correct the jam. For example, the light indicators can display one color, such as green, or no color, when the module is operating normally, and another color, such as red, when the module is not operating normally, such as if a jam is detected in the module. In some embodiments, if a module is not operating normally, the light indicators 2718 for that module can flash or blink to indicate the existence of the issue. In some embodiments, light indicators 2718 can also be disposed on front surface of each of the modules. In some embodiments, a light indicator 2718 can also be disposed on a surface of the payment bezel 2702. In some embodiments, the light indicator 2718 on the payment bezel 2702 can indicate whether the payment bezel is currently accepting banknotes or other documents. In some embodiments, the processor can issue a signal to display on a display screen viewable to the operator indicating the location of the jam, such as a text indicator, a graphical indicator such as a 2D or 3D image of the banknote recycler with an area of the banknote recycler containing the jam indicated, such as lighting up, highlighting, pointing to, etc., that area of the banknote recycler, or other indicators. In some embodiments, an active side of the transport path includes an indicator light configured to indicate an issue in the at least one of the one or more removable modules. In some embodiments, a passive side, such as a side including one of the openable panels 2716, includes a light guide or path visible to an operator.

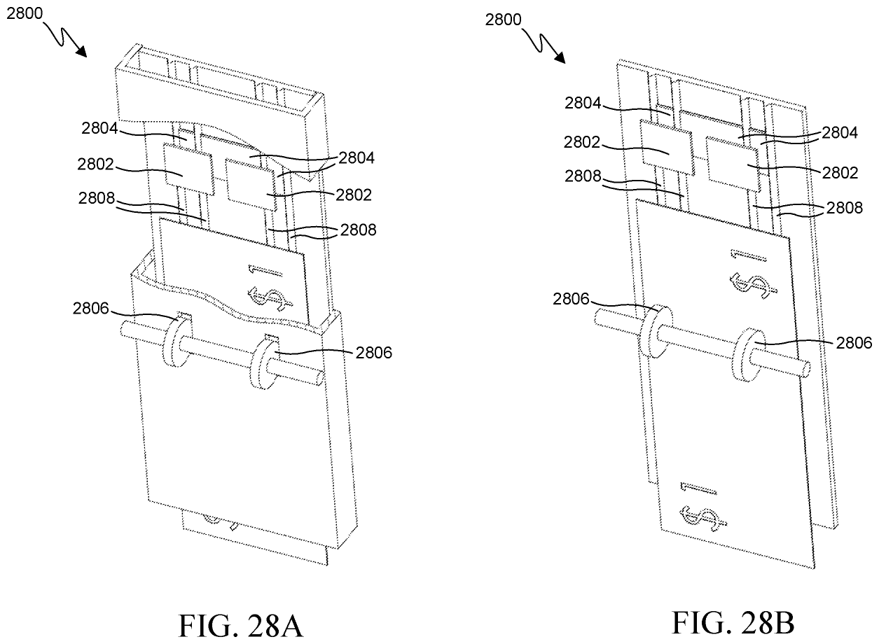

FIGS. 28A and 28B illustrate an example transport path 2800 including capacitive plates in accordance with various embodiments of this disclosure. FIG. 28A illustrates the transport path 2800 with an active side cut out. FIG. 28B illustrates the transport path 2800 with the active side removed for view ability of the transport path 2800. The transport path 2800 can come in a wide variety of configurations, and FIGS. 28A and 28B do not limit the scope of this disclosure to any particular implementation of a transport path. In some embodiments, the transport path 2800 can be included in the banknote recycler 100 or the banknote recycler 200, such as being a part of one of the replaceable modules.

The transport path 2800 includes a capacitive sensor having a plurality of active capacitive plates 2802 on an active side of the transport path 2800 and a plurality of passive capacitive plates 2804 on a passive side of the transport path 2800. In some embodiments, there may only be one capacitive plate on the active side. In some embodiments, each of the plurality of active and passive capacitive plates includes inducing electrodes, shielding and active electrodes. The plurality of passive plates 2804 act as grounded plates to provide a capacitance reference potential. In some embodiments, each of the plurality of active capacitive plates includes inducing electrodes, shielding and active electrodes. The plurality of passive plates 2804 act as grounded plates to provide a capacitance reference potential. Active rollers 2806 and passive rails 2808 transport documents to the capacitive sensor, where, when a document is present, the active capacitive plates 2802 are used to detect a change in a capacitance as the presence of the document displaces air in the transportation path. The presence or absence of banknote changes capacitance around the capacitive plate and can indicate presence or absence of the banknote.

In some embodiments, the active capacitive plates 2802 are used to detect a change in an electric field or dielectric field as the presence of the document displaces air in the transportation path. The presence or absence of banknote changes electric field or dielectric field around the capacitive plate and can indicate presence or absence of the banknote.

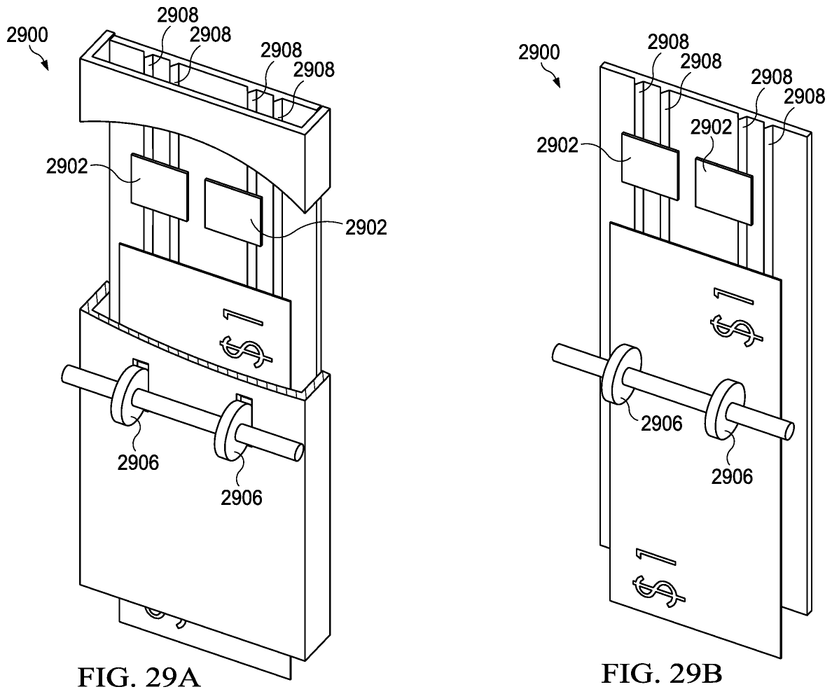

FIGS. 29A and 29B illustrate an example transport path 2900 including capacitive plates in accordance with various embodiments of this disclosure. FIG. 29A illustrates the transport path 2900 with an active side cut out. FIG. 29B illustrates the transport path 2900 with the active side removed for view ability of the transport path 2900. The transport path 2900 can come in a wide variety of configurations, and FIGS. 29A and 29B do not limit the scope of this disclosure to any particular implementation of a transport path. In some embodiments, the transport path 2900 can be included in the banknote recycler 100 or the banknote recycler 200, such as being a part of one of the replaceable modules.

The transport path 2900 includes a capacitive sensor having a plurality of active capacitive plates 2902 on an active side of the transport path 2900. In some embodiments, there may only be one capacitive plate on the active side. In some embodiments, each of the plurality of active capacitive plates 2902 includes a transmitter electrode and a receiver electrode. Active rollers 2906 and passive rails 2908 transport documents to the capacitive sensor, where, when a document is present, the active capacitive plates 2902 are used to detect a change in a capacitance as the presence of the document displaces air in the transportation path. The presence or absence of banknote changes capacitance around the capacitive plate and can indicate presence or absence of the banknote. In some embodiments, the passing document can also act as a passive capacitive plate or electrode. The banknote and two capacitive electrodes can thus create a three electrode system.

In some embodiments, the active capacitive plates 2902 are used to detect a change in an electric field or dielectric field as the presence of the document displaces air in the transportation path. The presence or absence of banknote changes electric field or dielectric field around the capacitive plate and can indicate presence or absence of the banknote.

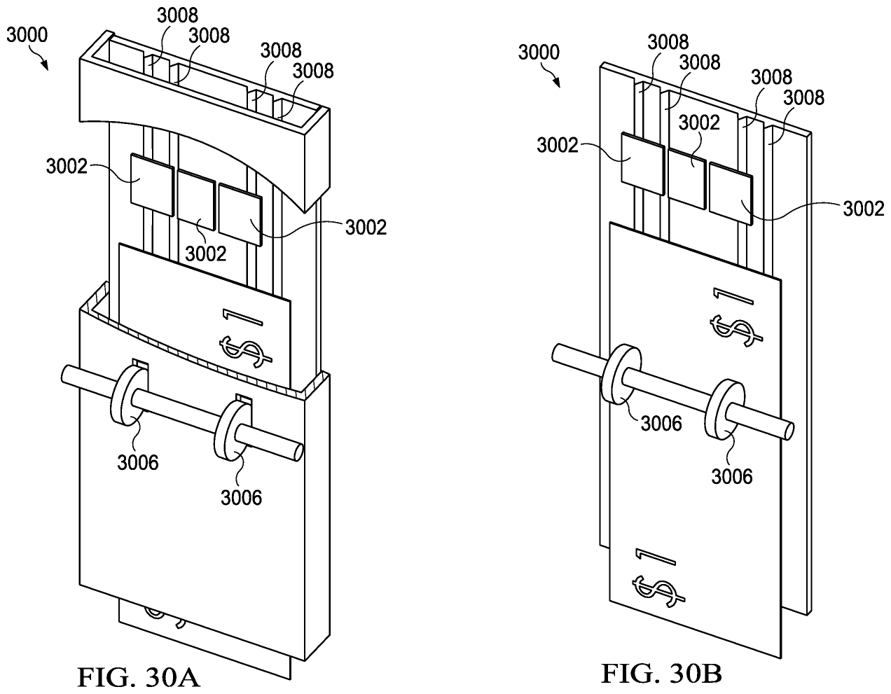

FIGS. 30A and 30B illustrate an example transport path 3000 including capacitive plates in accordance with various embodiments of this disclosure. FIG. 30A illustrates the transport path 3000 with an active side cut out. FIG. 30B illustrates the transport path 3000 with the active side removed for view ability of the transport path 3000. The transport path 3000 can come in a wide variety of configurations, and FIGS. 30A and 30B do not limit the scope of this disclosure to any particular implementation of a transport path. In some embodiments, the transport path 3000 can be included in the banknote recycler 100 or the banknote recycler 200, such as being a part of one of the replaceable modules.

The transport path 3000 includes a capacitive sensor having a plurality of active capacitive plates 3002 on an active side of the transport path 3000. In some embodiments, there may only be one capacitive plate on the active side. In some embodiments, each of the plurality of active capacitive plates 3002 includes a transmitter electrode and a receiver electrode. Active rollers 3006 and passive rails 3008 transport documents to the capacitive sensor, where, when a document is present, the active capacitive plates 3002 are used to detect a change in a capacitance as the presence of the document displaces air in the transportation path. The presence or absence of banknote changes capacitance around the capacitive plate and can indicate presence or absence of the banknote. In some embodiments, the passing document can also act as a passive capacitive plate or electrode. In some embodiments, the plurality of active capacitive plates 3002 can include three capacitive plates to cover a larger area of the transport path 3000. The banknote and three capacitive electrodes can thus create a three electrode system.

In some embodiments, the active capacitive plates 3002 are used to detect a change in an electric field or dielectric field as the presence of the document displaces air in the transportation path. The presence or absence of banknote changes electric field or dielectric field around the capacitive plate and can indicate presence or absence of the banknote.

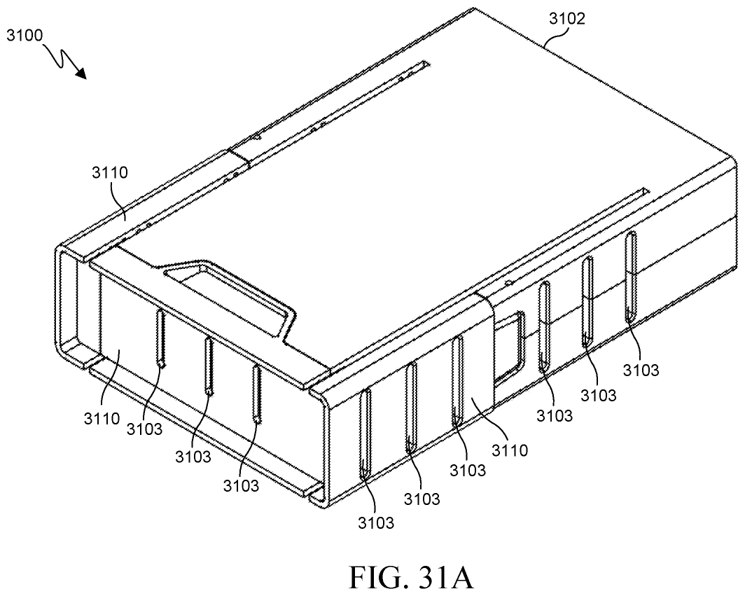

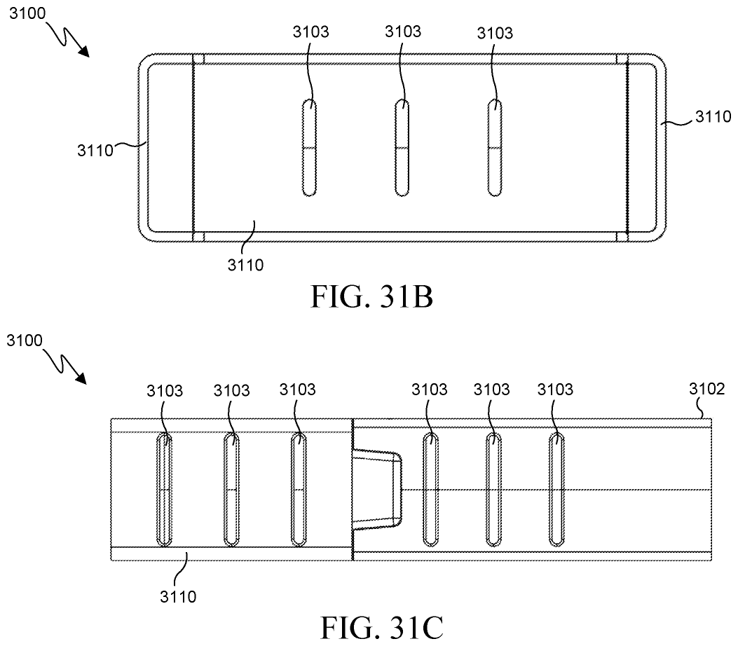

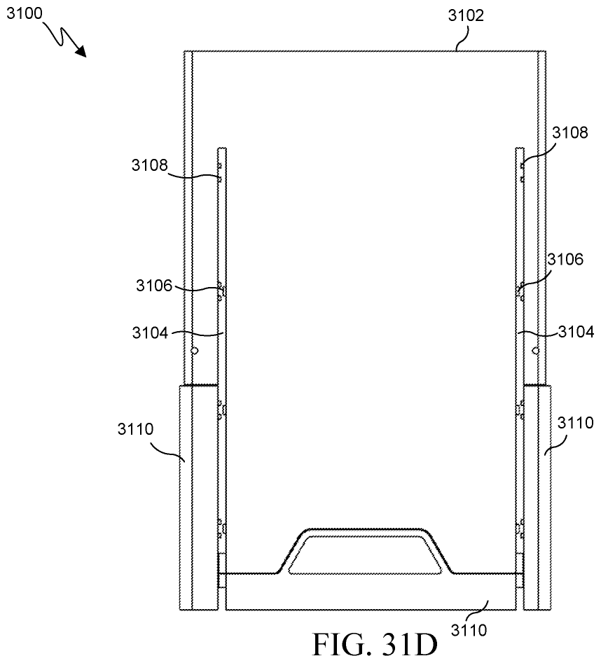

FIGS. 31A-31D illustrate an example recycling module 3100 in a closed configuration according to various embodiments of this disclosure. FIG. 31A illustrates a perspective view of the recycling module 3100 in the closed configuration, FIG. 31B illustrates a front view of the recycling module 3100 in the closed configuration, FIG. 31C illustrates a side view of the recycling module 3100 in the closed configuration, and FIG. 31D illustrates a top view of the recycling module 3100 in the closed configuration. The recycling module can come in a wide variety of configurations, and FIGS. 31A-31D do not limit the scope of this disclosure to any particular implementation of a recycling module. In some embodiments, the recycling module 3100 can be included in the banknote recycler 100 or the banknote recycler 200, such as being installed on a support surface 304 of the spine module 112.

While in the closed configuration, the recycling module 3100 can be installed onto the spine module 112 and operated in conjunction with the banknote recycler to receive and dispense banknotes. The recycling module 3100 includes a body 3102 having an interior portion. The interior portion includes banknote transport components to move banknotes through a banknote transport path 3104 such as a plurality of active rollers 3106 and passive rails 3108. The active rollers 3106 are driven by at least an actuator. One or more passive rails 3108 can be placed opposite an active roller 3106 in the recycling module 3100. The active rollers 3106 are operable to transport banknotes along the banknote transport path 3104 within the recycling module 3100. The active rollers 3106 drive banknotes inside the banknote transport path 3104, where banknotes are directly or indirectly pressed between the active rollers 3106 and the passive rails 3108. The recycling module 3100 also includes one or more openable panels 3110 that allow for an operator to inspect inside portions of the recycling module 3100, such as in the event of a banknote jam. For example, the recycling module 3100 can include a first openable panel 3110 on a front portion of the recycling module that can be hingedly connected such that the operator can view inside the recycling module 3100 and reach into the recycling module 3100 if needed to correct issues within the recycling module 3100.

The recycling module 3100 can also include one or more openable panels 3110 on a side exterior surface. Each openable side panel 3110 can be hingedly coupled to a side of the recycling module 3100 such that the side panel 3110 opens away from the side of the recycling module 3100 and extends in a direction perpendicular to the banknote transport path 3104 when fully opened. Opening the one or more side panels 3110 grants access to at least some of the active rollers 3106 and passive rails 3108, such that, if a banknote is jammed at one of the active rollers 3106 and/or passive rails 3108, the jam can be corrected. In some embodiments, the recycling module 3100 can include slits or transparent windows 3103. In some embodiments, the windows 3103 can be open air portions in the body 3102 or the openable panels 3110. In some embodiments, the windows 3103 can include a transparent material, such as transparent glass or plastic portions. The windows 3103 allow an operator or user to view banknotes either traveling through the banknote transport path 3104, or jammed banknotes. For example, if one of the side openable panels 3110 includes a window 3103, and a banknote becomes jammed in the area behind the openable panel 3110, an operator or user would be able to see the location of the jam, open the side panel 3110, and correct the jam. In some embodiments, an operator can push the note through the window 3103 to correct the jam.

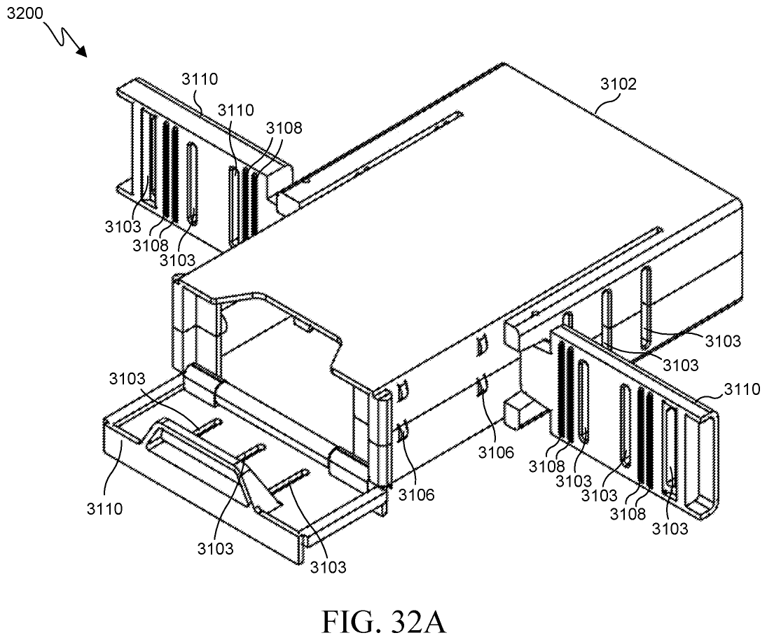

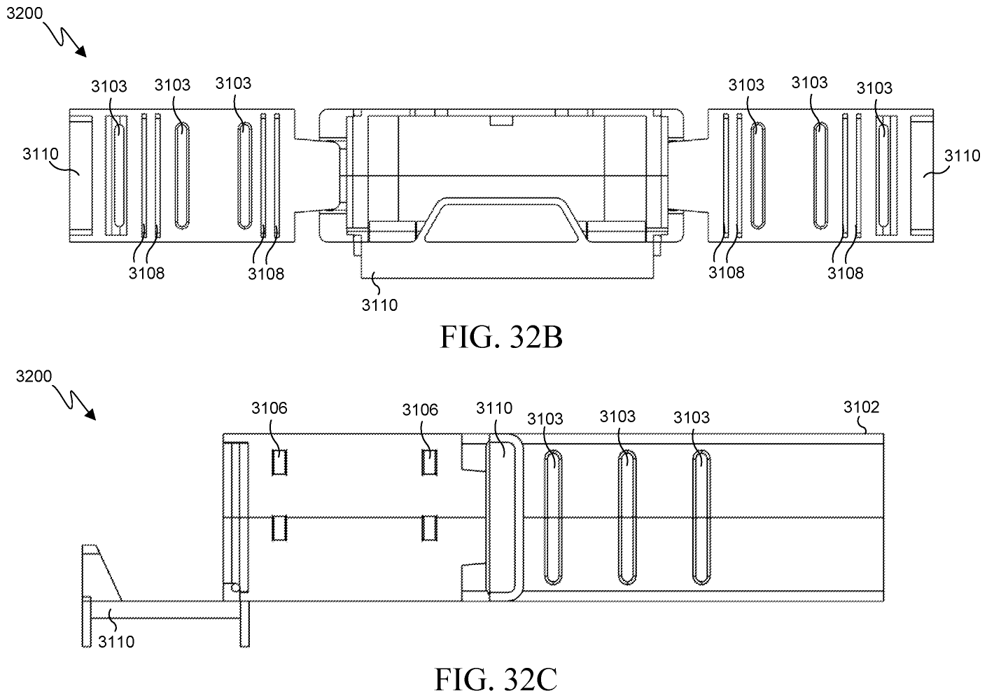

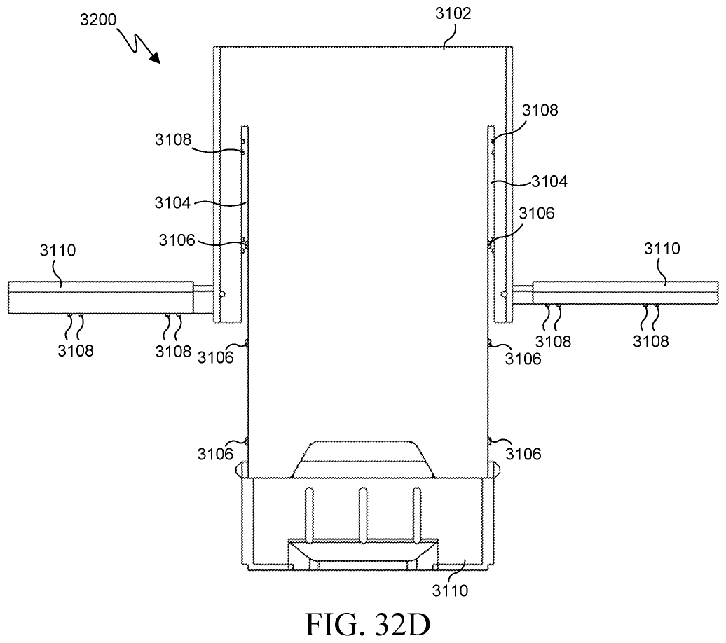

FIGS. 32A-32D illustrate an example recycling module 3100 in an open configuration according to various embodiments of this disclosure. FIG. 32A illustrates a perspective view of the recycling module 3100 in the open configuration, FIG. 32B illustrates a front view of the recycling module 3100 in the open configuration, FIG. 32C illustrates a side view of the recycling module 3100 in the open configuration, and FIG. 32D illustrates a top view of the recycling module 3100 in the open configuration. The recycling module can come in a wide variety of configurations, and FIGS. 32A-32D do not limit the scope of this disclosure to any particular implementation of a recycling module.

While in the open configuration, interior portions including the banknote transport path 3104, the active rollers 3106, the passive rails 3108, and other components of the recycling module 3100 can be inspected. The recycling module 3100 can include an openable panel 3110 on a front portion of the recycling module 3100 that can be hingedly connected such that the operator can view inside the recycling module 3100 and reach into the recycling module 3100 if needed to correct issues within the recycling module 3100.

The recycling module 3100 can also include one or more openable panels 3110 on a side exterior surface. Each openable side panel 3110 can be hingedly coupled to a side of the recycling module such that the side panel 3110 opens away from the side of the recycling module 3100 and extends in a direction perpendicular to the banknote transport path 3104 when fully opened. Opening the one or more side panels 3110 grants access to at least some of the active rollers 3106 and passive rails 3108, such that, if a banknote is jammed at one of the active rollers 3106 and/or passive rails 3108, the jam can be corrected. As described with respect to FIGS. 31A-31D, the recycling module 3100 can include windows 3103, such as open air windows or transparent glass or plastic windows, that are disposed at one or more of the openable panels 3110, or elsewhere on various surfaces of the recycling module 3100, to allow an operator or user to view banknotes either traveling through the banknote transport path 3104, or jammed banknotes.

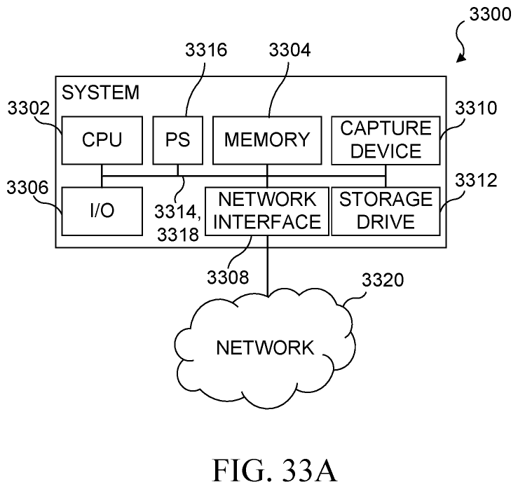

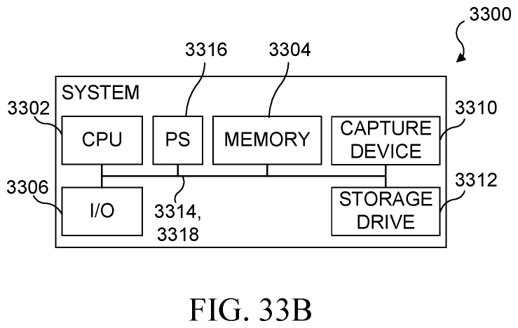

FIGS. 33A and 33B illustrate example electronic devices 3300 in accordance with various embodiments of this disclosure. The device 3300 can be one example of a portion of a document recycler or storage apparatus, such as the document acceptor 1700 or the acceptor-dispenser system 1705, or the banknote recyclers 100, 200, 1600, or other apparatuses of this disclosure. The electronic device 3300 can also be used in performing the various processes described herein, such as with respect to FIGS. 15 and 26. The device 3300 includes a controller (e.g., a processor/central processing unit (“CPU”)) 3302, a memory unit 3304, and an input/output (“I/O”) device 3306. The device 3300 also can include at least one network interface 3308, or network interface controllers (NICs), as shown in FIG. 33A. In some embodiments, the device 3300 does not include a network interface 3308, as shown in FIG. 33B. The device 3300 further includes at least one capture device 3310 for capturing media or inputs to the system through an I/O device. In some embodiments, the capture device 3310 is not included. The device 3300 also includes a storage drive 3312 used for storing content document characteristics. The components 3302, 3304, 3306, 3308, 3310, and 3312 are interconnected by a data transport system (e.g., a bus) 3314. A power supply unit (PSU) 3316 provides power to components of the device 3300 via a power transport system 3318 (shown with data transport system 3314, although the power and data transport systems may be separate).

It is understood that the device 3300 may be differently configured and that each of the listed components may actually represent several different components. For example, the CPU 3302 may actually represent a multi-processor or a distributed processing system; the memory unit 3304 may include different levels of cache memory, and main memory; the I/O device 3306 may include monitors, keyboards, touchscreens, and the like; the at least one network interface 3308 may include one or more network cards providing one or more wired and/or wireless connections to a network 3320; and the storage drive 3312 may include hard disks and remote storage locations. Therefore, a wide range of flexibility is anticipated in the configuration of the device 3300, which may range from a single physical platform configured primarily for a single user or autonomous operation to a distributed multi-user platform such as a cloud computing system.

The device 3300 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the device 3300. The operating system, as well as other instructions (e.g., for telecommunications and/or other functions provided by the device 3300), may be stored in the memory unit 3304 and executed by the processor 3302.

The network 3320 may be a single network or may represent multiple networks, including networks of different types, whether wireless or wired. For example, the device 3300 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 3300 with external devices.

In one example embodiment, a document accepting system comprises an opening to accept a document and a transportation path to transport the document into, inside, and out of an interior of the document accepting system, wherein the transportation path includes an active side including one or more driving members operable to impart a driving force on the document, a passive side including at least one raised surface disposed on a surface of the transportation path, wherein, during transport of the document, the document is between the one or more driving members and the at least one raised surface, and a capacitive sensor, wherein the capacitive sensor includes at least one capacitive plate on the active side of the transportation path, wherein the at least one capacitive plate includes a transmitter electrode and a receiver electrode, wherein, when a document is present, the capacitive sensor detects a change in capacitance as the presence of the document displaces air in the transportation path.

In another example embodiment, a document accepting system comprises an opening to accept a document and a transportation path to transport the document into, inside, and out of an interior of the document accepting system, wherein the transportation path includes an active side including one or more driving members operable to impart a driving force on the document, a passive side including at least one raised surface disposed on a surface of the transportation path, wherein, during transport of the document, the document is between the one or more driving members and the at least one raised surface, and an indicator light configured to indicate an issue in the transportation path.

In another example embodiment, a document acceptor comprises a document path to transport documents between two points, the document path comprising, a first document path member on one side of the document transport path, a second document path member on other side of the document transport path, the first document path member comprising rollers to impart driving force on document, the second document path member comprising raised portion of surface, said raised portion of surface permits document to be pressed between the said rollers and the raised portion of the surface, as the roller of the first document path member rotates it moves document pressed between the said rollers and the raised portion of the surface.

In one or more of the above examples, the rollers do not contact the raised portion of the surface in absence of a document in document path.

In one or more of the above examples, the document deforms between the roller and the raised portion of the surface.

In one or more of the above examples, the raised portion of the surface permits the document to slide over as it is moved by one or more rollers.

In one or more of the above examples, the raised portion of surface recedes between spaces between two rollers.

In another example embodiment, a document acceptor comprises a document path to transport documents between two points, the document path further comprising, a first document path member on one side of the document transport path, a second document path member on other side of the document transport path, the first document path member comprising belt to impart driving force on document, the second document path comprising raised portion of surface, said raised portion of surface member permits document to be pressed between the said belt and the raised portion of the surface, as the belt of the first document path member rotates it moves document pressed between the said belt and the raised portion of the surface.

In one or more of the above examples, the belt does not contact the raised portion of the surface in absence of a document in document path.

In one or more of the above examples, the document deforms between the belt and the raised portion of the surface.

In one or more of the above examples, the raised portion of the surface permits documents to slide over as it is moved by one or more belt.

In another example embodiment, a method of transporting document in a document acceptor comprises transporting a document inside a document transport path where the document transport path comprises driving roller and a raised surface configured to avoid physical contact between the said driving roller and the raised surface, holding a document between driving roller and raised surface deforming the document, transporting the document in desired direction by rotating the driving rollers in predetermined direction, moving a document by driving roller in predetermined direction by deforming the document between the driving roller and the raised surface.

In another example embodiment, a method of transporting a document in document acceptor comprises transporting a document inside a document transport path where the document transport path comprises driving belt and a raised surface configured to avoid physical contact between the said driving belt and the raised surface, holding a document between driving belt and raised surface, deforming the document transporting the document in desired direction by rotating the driving belt in predetermined direction, moving a document by driving belt in predetermined direction by deforming the document between the driving belt and the raised surface.

In another example embodiment, a document acceptor comprises a document path to transport documents between two points, the document path further comprising, a first document path member on one side of the document transport path, a second document path member on other side of the document transport path, the first document path member comprising rollers to impart a driving force on the document, the second document path member comprising raised portion of the surface, said raised portion of surface permits document to be pressed between the said rollers and the raised portion of the surface, as the roller of the first document path member rotates it moves document pressed between the said rollers and the raised portion of the surface.

In one or more of the above examples, the rollers do not contact the raised portion of the surface in absence of a document in document path.

In one or more of the above examples, the document deforms between the roller and the raised portion of the surface.

In one or more of the above examples, the raised portion of surface permits document to slide over as it is moved by one or more rollers.

In one or more of the above examples, the raised portion of surface recedes between spaces between two rollers.

In another example embodiment, a document acceptor comprises a document path to transport documents between two points, the document path further comprising, a first document path member on one side of the document transport path, a second document path member on other side of the document transport path, the first document path member comprising a belt to impart a driving force on the document, the second document path comprising a raised portion of a surface, said raised portion of the surface member permits document to be pressed between the said belt and the raised portion of the surface, as the belt of the first document path member rotates it moves document pressed between the said belt and the raised portion of the surface.

In one or more of the above examples, the belt does not contact the raised portion of the surface in absence of a document in document path.

In one or more of the above examples, the document deforms between the belt and the raised portion of the surface.

In one or more of the above examples, the raised portion of the surface permits document to slide over as it is moved by one or more belt.

In another example embodiment, a method of transporting a document in a document acceptor comprises transporting a document inside a document transport path where the document transport path comprises a driving roller and a raised surface configured to avoid physical contact between the said driving roller and the raised surface, holding a document between the driving roller and raised surface deforming the document, transporting the document in the desired direction by rotating the driving rollers in a predetermined direction, moving a document by driving roller in a predetermined direction by deforming the document between the driving roller and the raised surface.

In another example embodiment, a method of transporting a document in a document acceptor comprises transporting a document inside a document transport path where the document transport path comprises a driving belt and a raised surface configured to avoid physical contact between the said driving belt and the raised surface, holding a document between the driving belt and raised surface, deforming the document, transporting the document in the desired direction by rotating the driving belt in a predetermined direction, moving a document by driving belt in a predetermined direction by deforming the document between the driving belt and the raised surface.

In another example embodiment, a document accepting system comprises an opening to accept a document and a transportation path to transport the document into, inside, and out of an interior of the document accepting system, wherein the transportation path includes an active side including one or more driving members operable to impart a driving force on the document, and a passive side including at least one raised surface disposed on a surface of the transportation path, wherein, during transport of the document, the document is between the one or more driving members and the at least one raised surface.

In one or more of the above examples, the one or more driving members includes at least one of one or more rotating elements, and one or more belts, and wherein the at least one raised surface includes at least one rail, or one or more passive rotating elements.

In one or more of the above examples, the one or more driving members do not contact the at least one raised surface in an absence of a document in the transportation path.

In one or more of the above examples, when the document is pressed between the one or more driving members and the at least one raised surface, the document is deformed between the one or more driving members and the at least one raised surface.

In one or more of the above examples, as the one or more driving members move the document through the transportation path, the document slides along the at least one raised surface.

In one or more of the above examples, at least a portion of the transportation path is disposed within one or more removable modules, wherein the one or more removable modules are operable to be installed in, and removed from, the document accepting system.

In one or more of the above examples, the document accepting system further comprises a spine module operable to support and couple with the one or more removable modules.

In one or more of the above examples, at least one of the one or more removable modules includes at least one openable panel providing access a portion of the transportation path.

In one or more of the above examples, the at least one openable panel includes a first openable panel and a second openable panel, wherein the first openable panel opens to the active side of the transportation path, and wherein the second openable panel opens to the passive side of the transportation path.

In one or more of the above examples, the at least one openable panel is made of a transparent material.

In one or more of the above examples, the at least one openable panel comprises one or more windows.

In one or more of the above examples, the at least one openable panel includes an indicator light configured to indicate an issue in the at least one of the one or more removable modules.

In one or more of the above examples, the active side includes an indicator light configured to indicate an issue in the at least one of the one or more removable modules, and wherein the at least one openable panel includes a light guide or path visible to an operator.

In one or more of the above examples, the one or more removable modules include at least one of an accepting module operable to receive and transport documents through a portion of the document accepting system, a sensing module operable to recognize documents received in the document accepting system, a recycling module operable to receive documents from, and dispense documents to, one or more other modules in the document accepting system, and a cashbox module operable to store documents received from one or more other modules in the document accepting system.

In one or more of the above examples, the document accepting system further comprises a capacitive sensor, wherein the capacitive sensor includes an active or receiving electrode and a passive electrode.

In one or more of the above examples, the document accepting system further comprises a capacitive sensor.

In one or more of the above examples, the capacitive sensor includes at least one capacitive plate on the active side of the transportation path, wherein the at least one capacitive plate includes a inducing or passive electrode and an active or a receiving electrode, wherein, when a document is present, the capacitive sensor detects a change in a capacitance as the presence of the document displaces air in the transportation path.

In one or more of the above examples, the capacitive sensor includes at least one capacitive plate on the active side of the transportation path, wherein the at least one capacitive plate includes a transmitter electrode and a receiver electrode, wherein, when a document is present, the capacitive sensor detects a change in a capacitance as the presence of the document displaces air in the transportation path.

In one or more of the above examples, the capacitive sensor includes at least one capacitive plate on the active side of the transportation path, wherein the at least one capacitive plate includes a inducing electrode and an active electrode, and wherein, when a document is present, the capacitive sensor detects a change in a capacitance as the presence of the document displaces air in the transportation path capacitance.

In one or more of the above examples, at least one active or receiving electrode of the capacitive sensor is disposed on the active side of the transportation path, and wherein at least one passive or inducing electrode of the capacitive sensor is disposed on the passive side of the transportation path.

In one or more of the above examples, at least one active or receiving electrode of the capacitive sensor is disposed on the active side of the transportation path, and wherein at least one passive or inducing electrode is the document transported in the transportation path.

In one or more of the above examples, at least one active or receiving electrode of the capacitive sensor is disposed on the active side of the transportation path, and wherein at least one passive or inducing electrode is excluded.

In one or more of the above examples, the document accepting system further comprises a processor configured to receive measurements using the capacitive sensor, determine, based on the measurements, a location of a document jam in the document accepting system, and output a signal indicating the document jam.

In another example embodiment, a method of transporting a document in a document accepting system comprises accepting a document in an opening of the document accepting system, transporting the document in a transportation path, wherein the transportation path includes an active side including one or more driving members that impart a driving force on the document, and a passive side including at least one raised surface, and pressing, during transport of the document in the transportation path, the document between the one or more driving members and the at least one raised surface.

In one or more of the above examples, the one or more driving members includes at least one of one or more rotating elements, and one or more belts, and wherein the at least one raised surface includes at least one rail, or one or more passive rotating elements.

In one or more of the above examples, the one or more driving members do not contact the at least one raised surface in an absence of a document in the transportation path.

In one or more of the above examples, the method further comprises deforming, when the document is pressed between the one or more driving members and the at least one raised surface, the document between the one or more driving members and the at least one raised surface.

In one or more of the above examples, as the one or more driving members move the document through the transportation path, the document slides along the at least one raised surface.

In one or more of the above examples, at least a portion of the transportation path is disposed within one or more removable modules.

In one or more of the above examples, at least one of the one or more removable modules includes at least one openable panel providing access a portion of the transportation path.

In one or more of the above examples, the method further comprises receiving measurements by a processor using a capacitive sensor, determining, by the processor based on the measurements, a location of a transport issue in the document accepting system, and outputting, by the processor, a signal indicating the transport issue.

In one or more of the above examples, the method further comprises activating, based on the signal indicating the transport issue, an indicator light visible via the at least one openable panel, determining, by the processor based on the measurements, that transport issue is corrected, and outputting, by the processor, a signal indicating the transport issue is corrected.

In one or more of the above examples, the method further comprises receiving one or more documents by an accepting module of the one or more removable modules, recognizing the one or more documents by a sensing module of the one or more removable modules, receiving the one or more documents from and dispensing to one or more other modules by a recycling module of the one or more removable modules, and storing the one or more documents in a cashbox module of the one or more removable modules.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A document accepting system, comprising:
an opening to accept a document; and
a transportation path to transport the document into, inside, and out of an interior of the document accepting system,
wherein the transportation path includes:
an active side including one or more driving members operable to impart a driving force on the document, and
a passive side including at least one raised surface disposed on a surface of the transportation path,
wherein, during the transport of the document, the document is between the one or more driving members and the at least one raised surface.

2. The document accepting system of claim 1, wherein the one or more driving members includes at least one of:
one or more rotating elements, and
one or more belts; and
wherein the at least one raised surface includes:
at least one rail, or
one or more passive rotating elements.

3-5. (canceled)

6. The document accepting system of claim 1, wherein at least a portion of the transportation path is disposed within one or more removable modules, wherein the one or more removable modules are operable to be installed in, and removed from, the document accepting system.

7. (canceled)

8. The document accepting system of claim 6, wherein at least one of the one or more removable modules includes at least one openable panel providing access a portion of the transportation path.

9. The document accepting system of claim 8, wherein the at least one openable panel includes a first openable panel and a second openable panel, wherein the first openable panel opens to the active side of the transportation path, and wherein the second openable panel opens to the passive side of the transportation path.

10. (canceled)

11. (canceled)

12. The document accepting system of claim 8, wherein the at least one openable panel includes an indicator light configured to indicate an issue in the at least one of the one or more removable modules.

13. The document accepting system of claim 8, wherein the active side includes an indicator light configured to indicate an issue in the at least one of the one or more removable modules, and wherein the at least one openable panel includes a light guide or path visible to an operator.

14. The document accepting system of claim 6, wherein the one or more removable modules include at least one of:
an accepting module operable to receive and transport documents through a portion of the document accepting system;
a sensing module operable to recognize documents received in the document accepting system;
a recycling module operable to receive documents from, and dispense documents to, one or more other modules in the document accepting system; and
a cashbox module operable to store documents received from one or more other modules in the document accepting system.

15. (canceled)

16. The document accepting system of claim 1, further comprising a capacitive sensor.

17. The document accepting system of claim 16, wherein the capacitive sensor includes at least one capacitive plate on the active side of the transportation path, wherein the at least one capacitive plate includes a transmitter electrode and a receiver electrode, and wherein, when a document is present, the capacitive sensor detects a change in a capacitance as a presence of the document displaces air in a transportation path capacitance.

18. The document accepting system of claim 16, wherein at least one active electrode of the capacitive sensor is disposed on the active side of the transportation path, and wherein at least one passive electrode of the capacitive sensor is disposed on the passive side of the transportation path.

19. The document accepting system of claim 16, wherein at least one active electrode of the capacitive sensor is disposed on the active side of the transportation path, and wherein at least one passive electrode is the document transported in the transportation path.

20. The document accepting system of claim 16, further comprising a processor configured to:
receive measurements using the capacitive sensor;
determine, based on the measurements, a location of a document jam in the document accepting system; and
output a signal indicating the document jam.

21. A method of transporting a document in a document accepting system, the method comprising:
accepting a document in an opening of the document accepting system;
transporting the document in a transportation path, wherein the transportation path includes:
an active side including one or more driving members that impart a driving force on the document, and
a passive side including at least one raised surface; and
pressing, during the transport of the document in the transportation path, the document between the one or more driving members and the at least one raised surface.

22. The method of claim 21, wherein the one or more driving members includes at least one of:
one or more rotating elements, and
one or more belts; and
wherein the at least one raised surface includes:
at least one rail, or
one or more passive rotating elements.

23-25. (canceled)

26. The method of claim 21, wherein at least a portion of the transportation path is disposed within one or more removable modules.

27. The method of claim 26, wherein at least one of the one or more removable modules includes at least one openable panel providing access a portion of the transportation path.

28. The method of claim 27, further comprising:
receiving measurements by a processor using a capacitive sensor;
determining, by the processor based on the measurements, a location of a transport issue in the document accepting system; and
outputting, by the processor, a signal indicating the transport issue.

29. The method of claim 28, further comprising:
activating, based on the signal indicating the transport issue, an indicator light visible via the at least one openable panel;
determining, by the processor based on the measurements, that the transport issue is corrected; and
outputting, by the processor, a signal indicating the transport issue is corrected.

30. The method of claim 26, further comprising:
receiving one or more documents by an accepting module of the one or more removable modules;
recognizing the one or more documents by a sensing module of the one or more removable modules;
receiving the one or more documents from and dispensing to one or more other modules by a recycling module of the one or more removable modules; and
storing the one or more documents in a cashbox module of the one or more removable modules.

31. (canceled)

32. (canceled)
